(19) United States
(12) Patent Application Publication
(10) Pub. No.: US 2024/0260128 A1
(43) Pub. Date: Aug. 1, 2024

(54) Discontinuous Reception (DRX) Operation

(71) Applicant: Ofinno, LLC, Reston, VA (US)

(72) Inventors: Mohammad Ghadir Khoshkholgh Dashtaki, Reston, VA (US); Ali Cagatay Cirik, Chantilly, VA (US); Esmael Hejazi Dinan, McLean, VA (US); Hyoungsuk Jeon, Centreville, VA (US); Hua Zhou, Vienna, VA (US); Gautham Prasad, Herndon, VA (US)

(73) Assignee: Ofinno, LLC, Reston, VA (US)

(21) Appl. No.: 18/407,864

(22) Filed: Jan. 9, 2024

Related U.S. Application Data
(60) Provisional application No. 63/440,277, filed on Jan. 20, 2023.

(51) Int. Cl. H04W 76/28; H04B 7/06; H04L 1/1812; H04W 72/1273

(52) U.S. Cl. CPC H04W 76/28; H04B 7/0626; H04L 1/1812; H04W 72/1273

(57) ABSTRACT

A method can include receiving, by a wireless device, one or more radio resource control (RRC) configuration parameters. The parameters can indicate a discontinuous reception (DRX) on-duration timer and at least one occasion for transmission of a report. The report can be at least one of a channel state information (CSI) report or a sounding reference signal (SRS) report. The method can also include starting the DRX on-duration timer and receiving, while the DRX on-duration timer is running, a packet data unit (PDU) set comprising a plurality of PDUs. The method can further include, based on the receiving the PDU set before an offset prior to a first occasion of the at least one occasion, dropping transmission of the report via the first occasion.

### CROSS-REFERENCE TO RELATED APPLICATIONS

This application claims the benefit of U.S. Provisional Application No. 63/440,277, filed Jan. 20, 2023, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 shows several DCI formats.

FIG. 18 shows an example embodiment of a DRX operation in wireless communications systems per an aspect of the present disclosure.

FIG. 19 shows an example embodiment of a DRX operation in wireless communications systems per an aspect of the present disclosure.

FIG. 20 shows a flowchart of a method/procedure for PDCCH monitoring in wireless communication systems.

FIG. 21 shows a flowchart of a method/procedure for DRX operation in wireless communication systems.

FIG. 22 shows an example embodiment of a DRX operation in wireless communication systems per an aspect of the present disclosure.

FIG. 23 shows a flowchart of a method/procedure for DRX operation in wireless communication systems.

FIG. 24 shows an example embodiment of a DRX operation in wireless communication systems per an aspect of the present disclosure.

FIG. 25 shows a flowchart of a radio link monitoring/recovery method/procedure during a DRX operation in wireless communication systems per an aspect of the present disclosure.

FIG. 26 shows a flowchart of a radio link monitoring/recovery method/procedure during a DRX operation in wireless communication systems per an aspect of the present disclosure.

FIG. 27 shows a flowchart of a radio link monitoring/recovery method/procedure during a DRX operation in wireless communication systems per an aspect of the present disclosure.

FIG. 28 shows an example embodiment of a DRX operation in wireless communication systems per an aspect of the present disclosure.

FIG. 29 shows an example embodiment of a DRX operation in wireless communication systems per an aspect of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or non-operational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

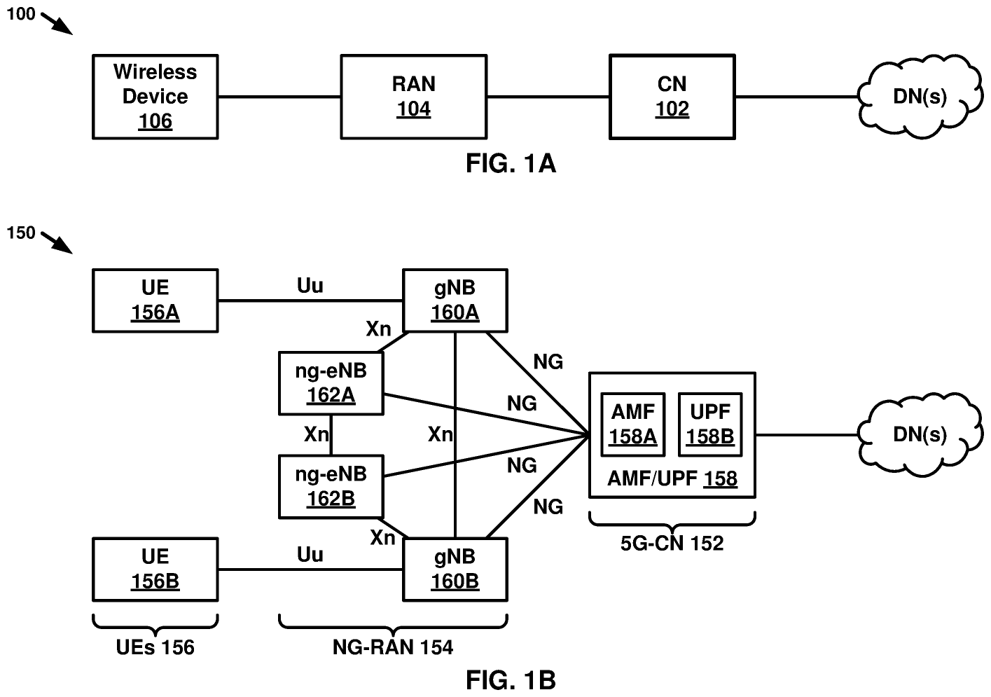

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (CNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for case of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QOS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

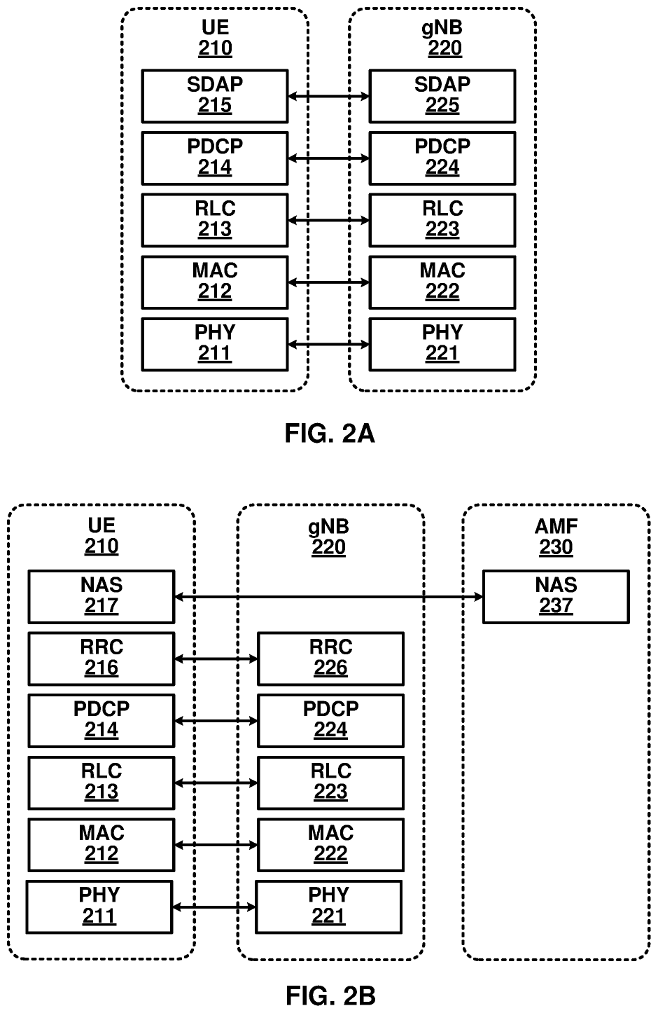

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

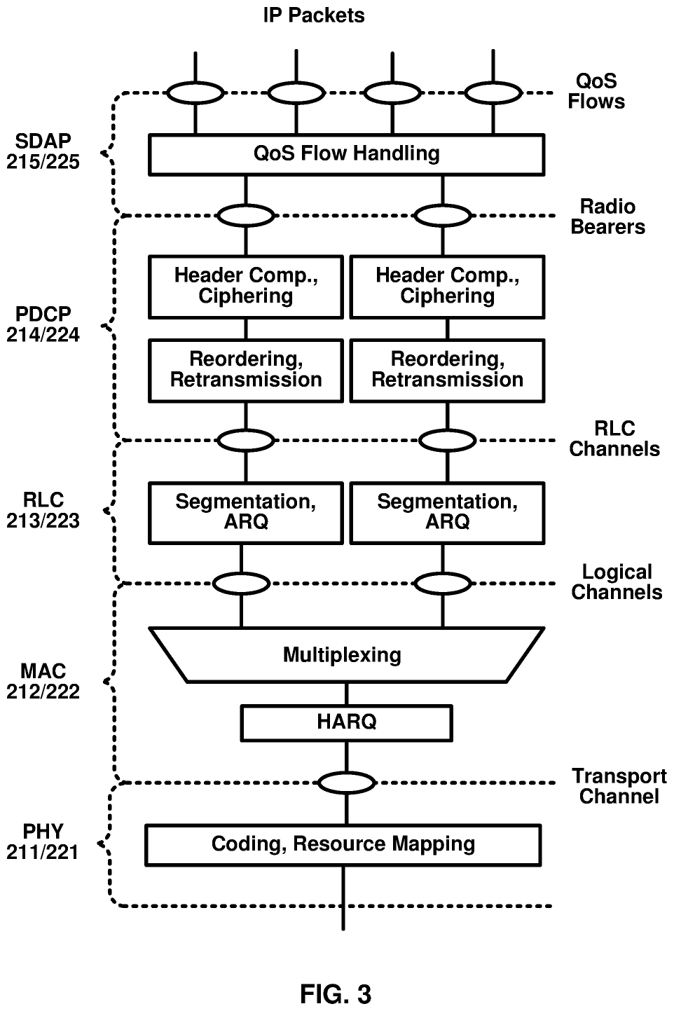

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

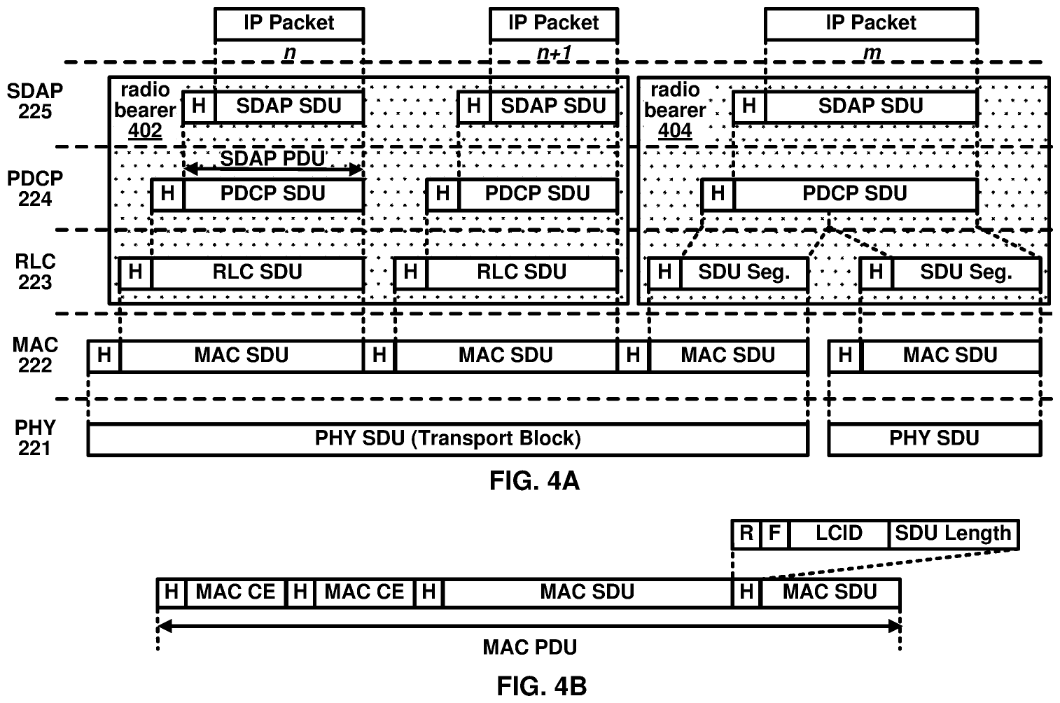

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

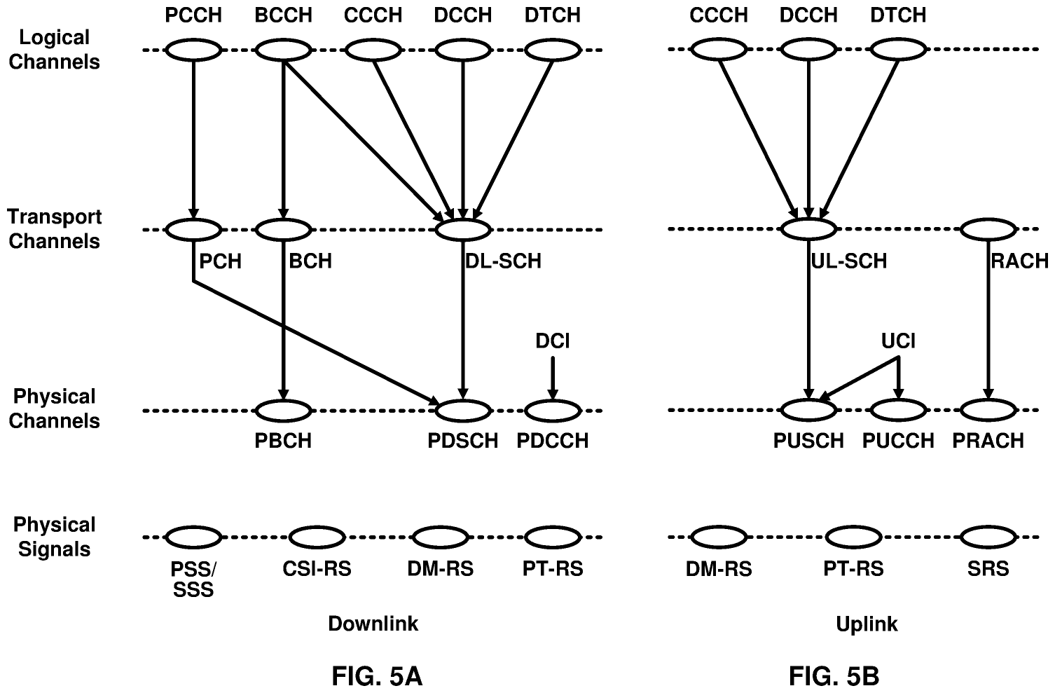

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), where the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

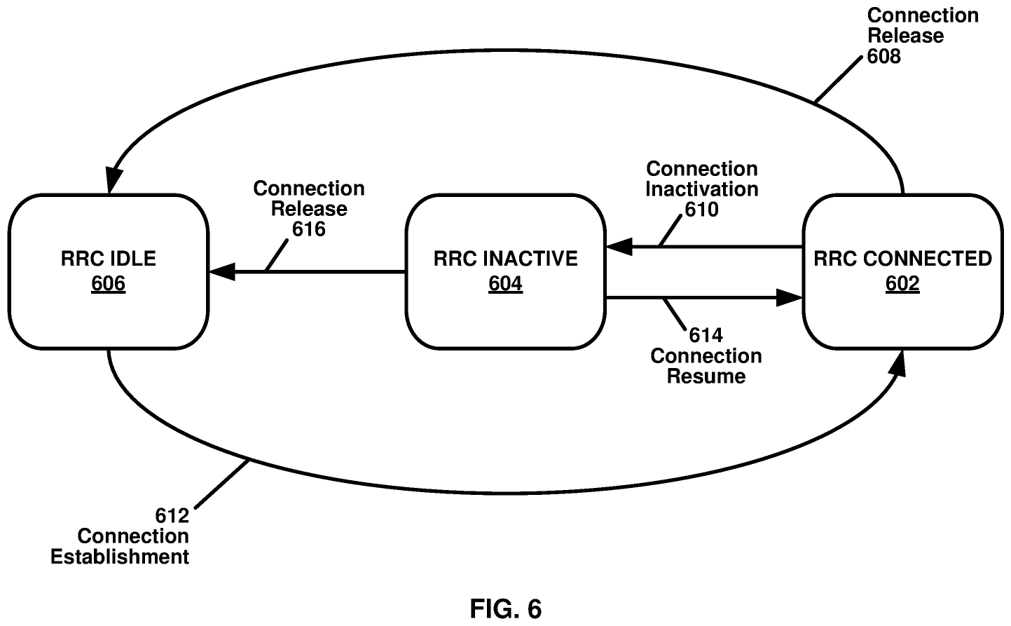

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an FI interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

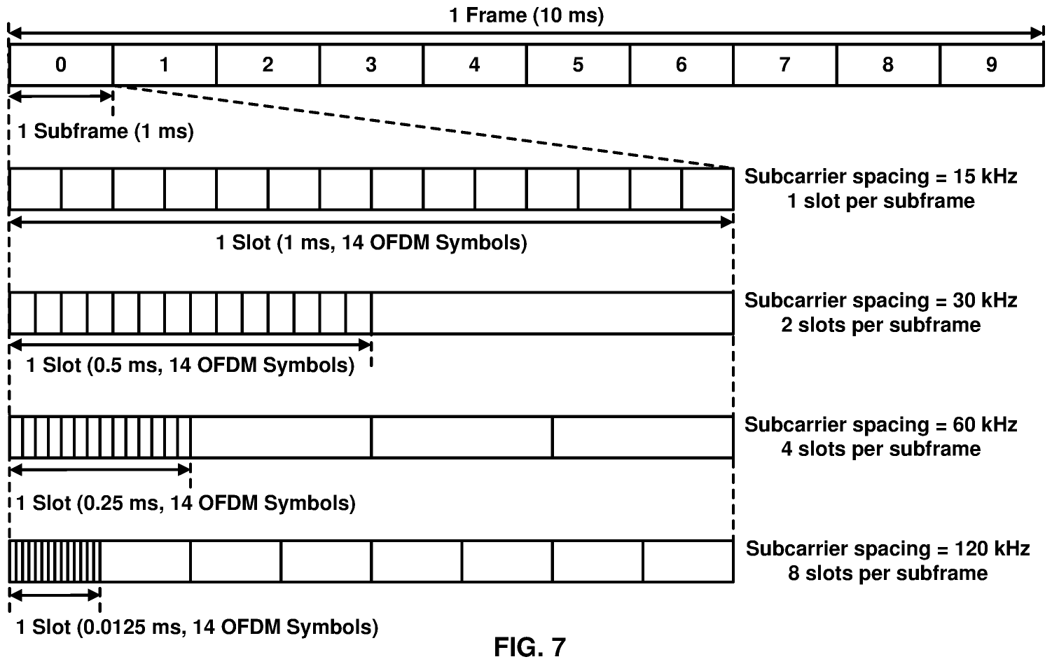

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for case of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

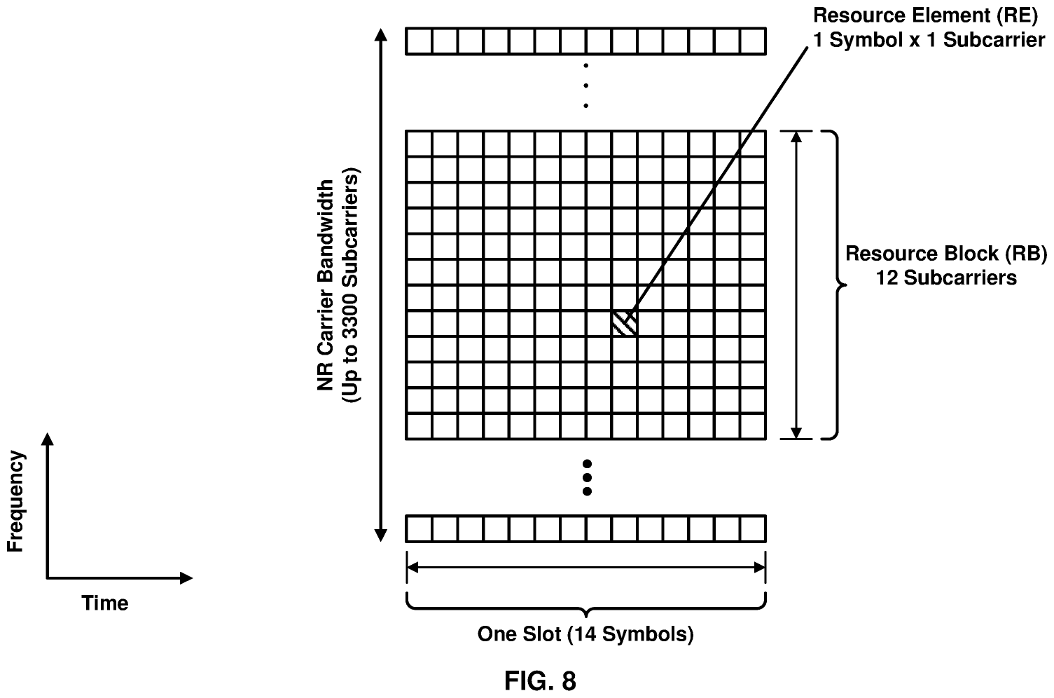

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

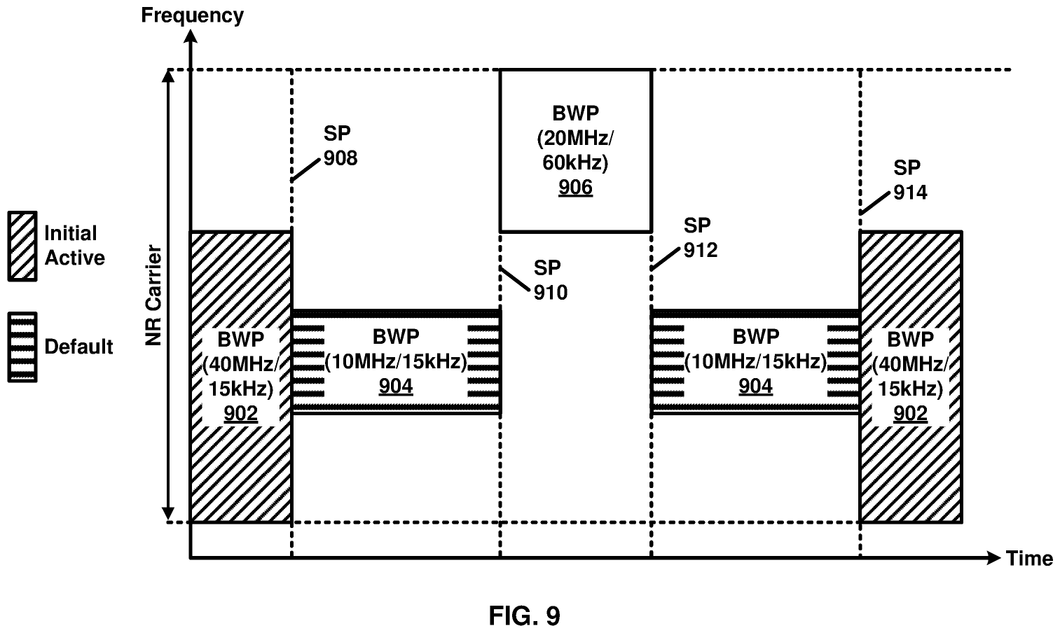

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

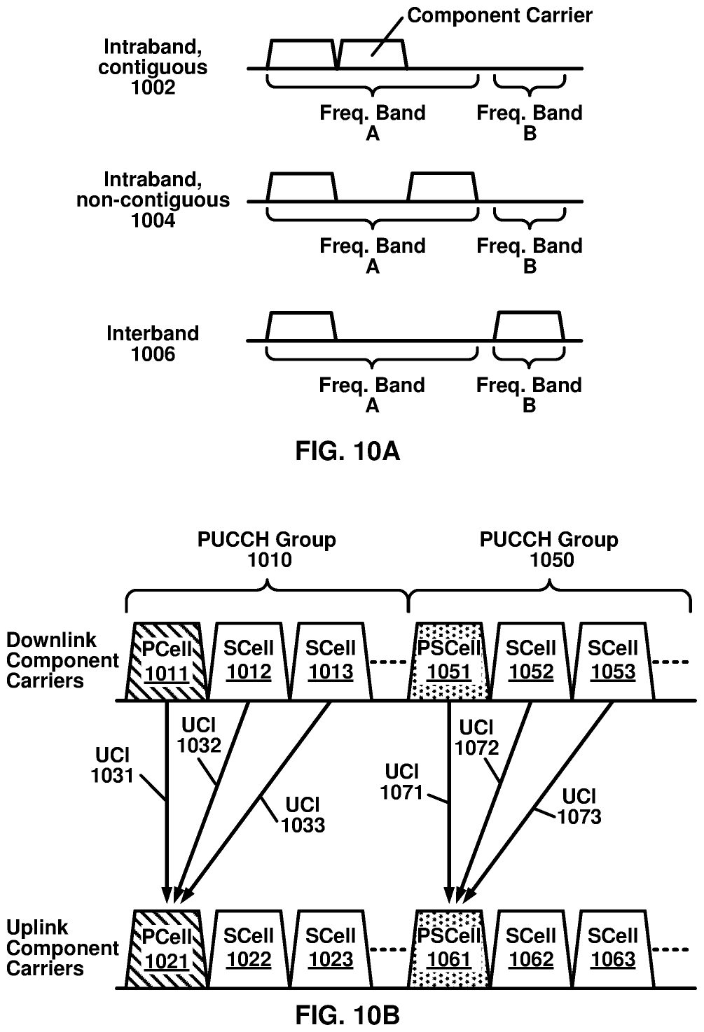

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

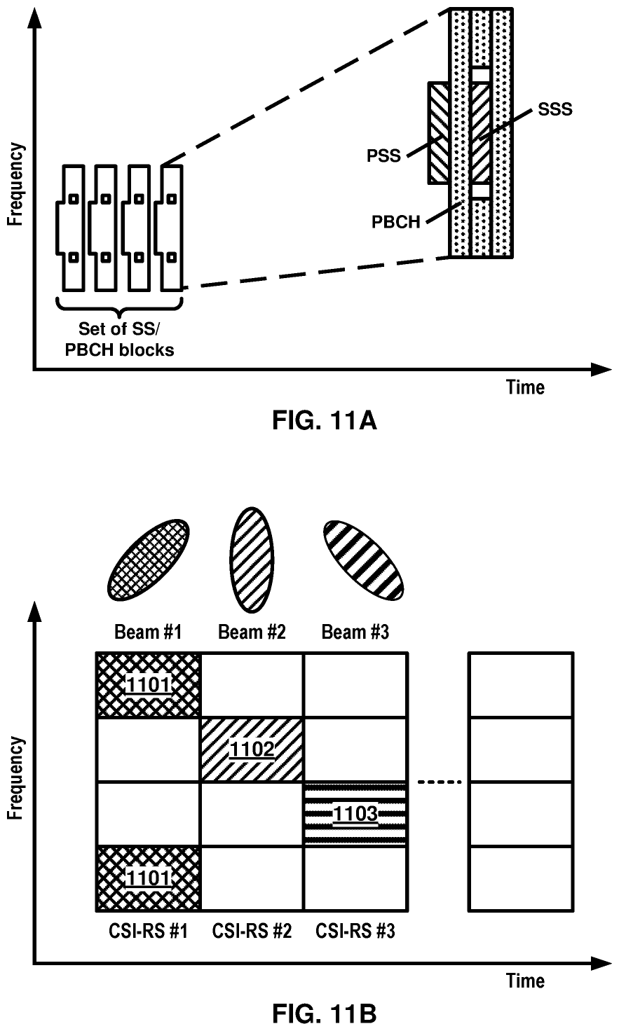

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, where a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, where a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, where a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, where the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

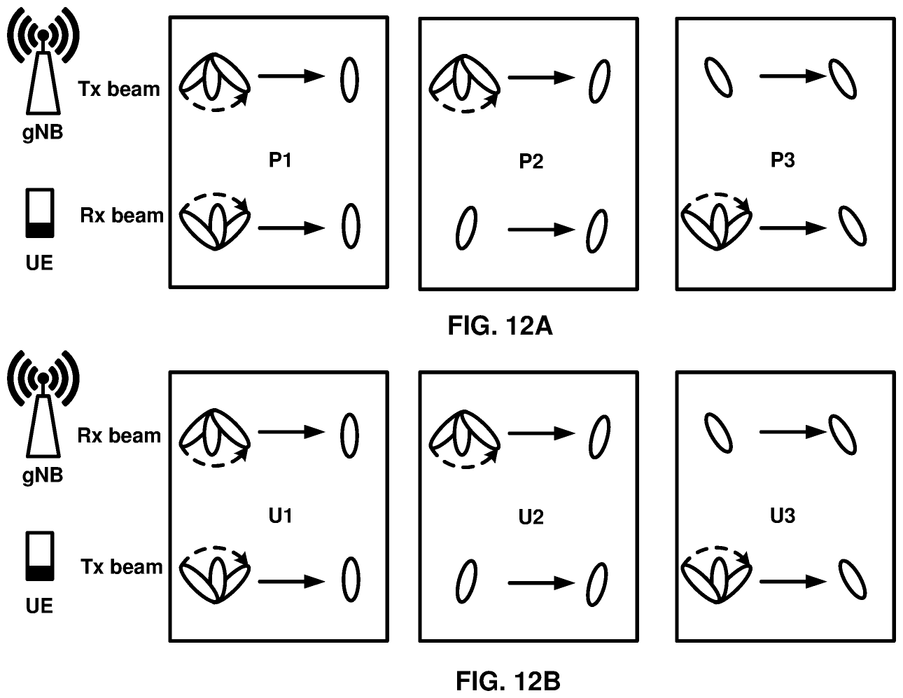

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

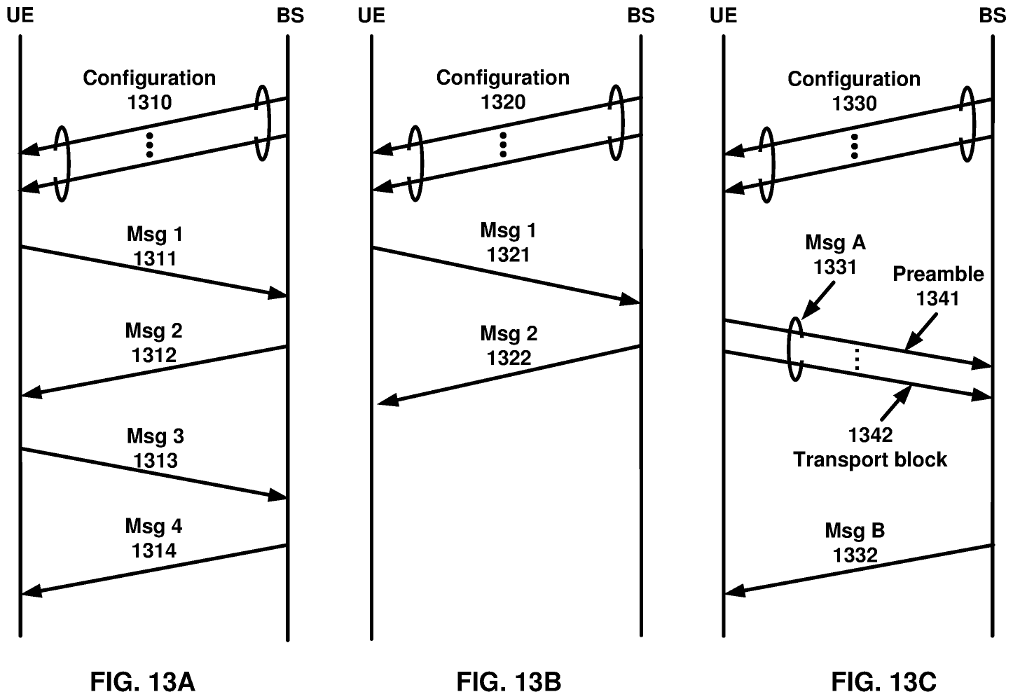

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may usc one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-Response Window) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may usc random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows: RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-Response Window) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

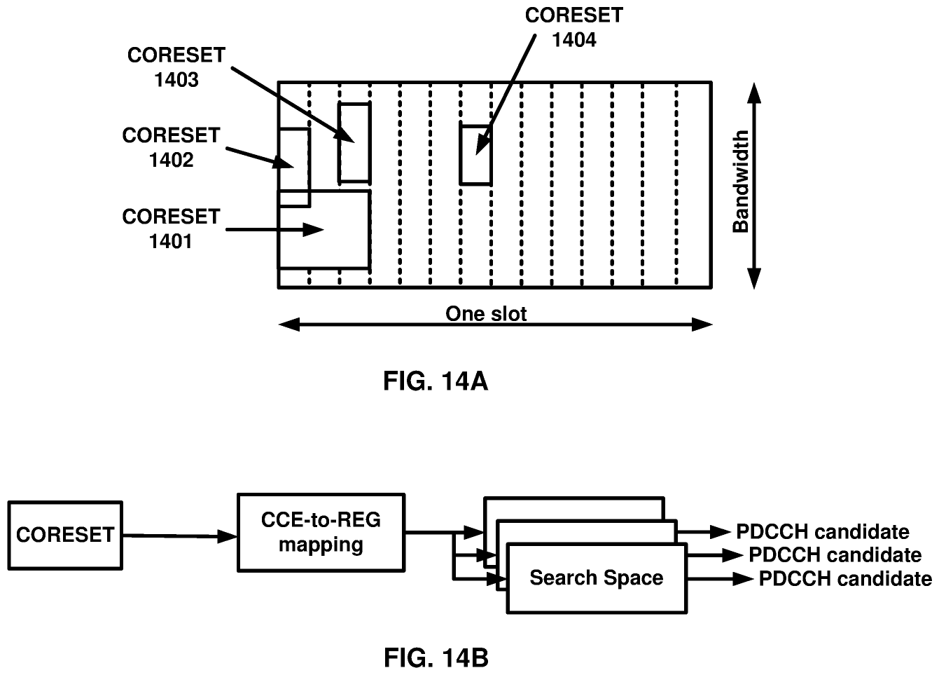

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

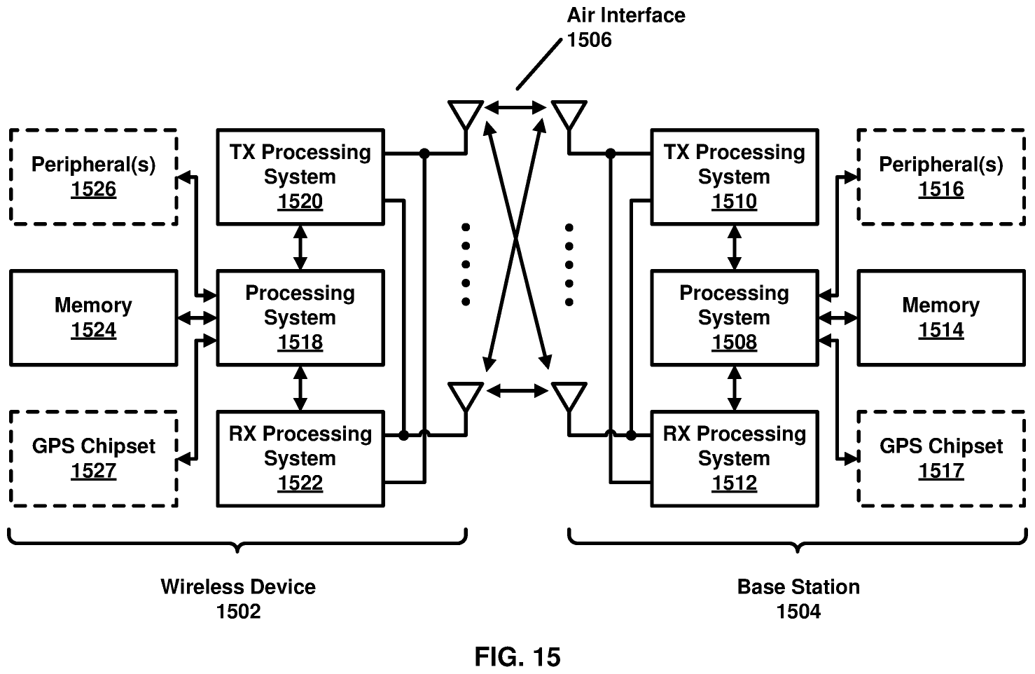

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

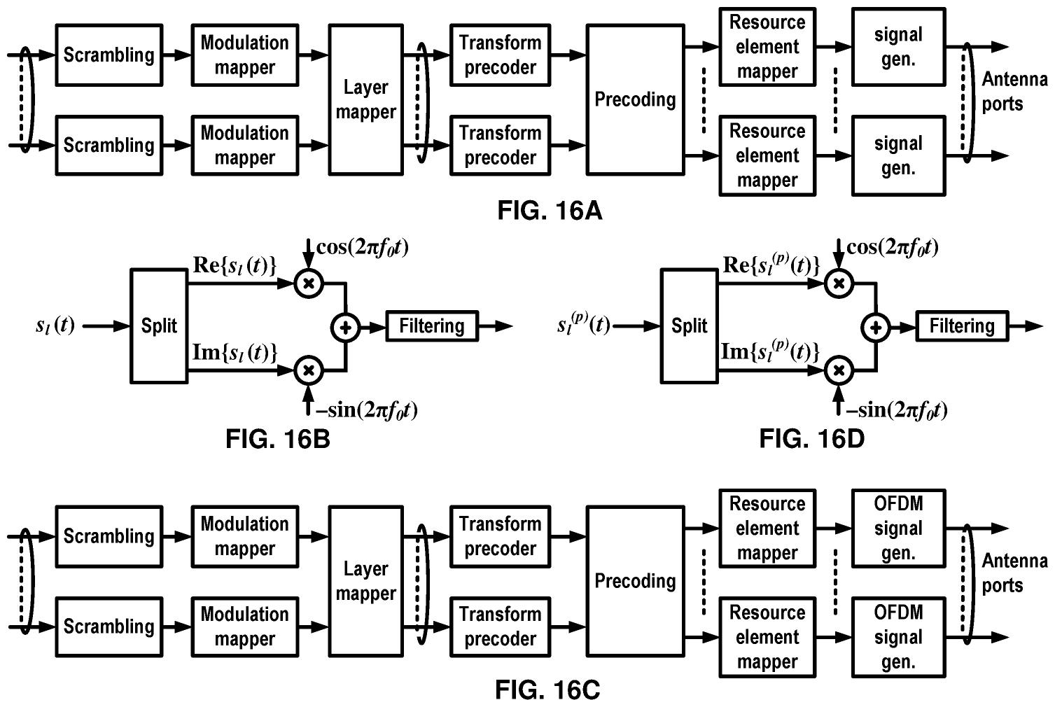

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

A base station may transmit one or more MAC PDUs to a wireless device. In an example, a MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. In an example, the bit order of a parameter field within a MAC PDU is represented with the first and most significant bit in the leftmost bit and the last and least significant bit in the rightmost bit.

In an example, a MAC SDU may be a bit string that is byte aligned (e.g., aligned to a multiple of eight bits) in length. In an example, a MAC SDU may be included in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. In an example, a MAC subheader may be placed immediately in front of a corresponding MAC SDU, MAC CE, or padding. A MAC entity may ignore a value of reserved bits in a DL MAC PDU.

In an example, a MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

In an example, when a MAC subheader corresponds to a MAC SDU, a variable-sized MAC CE, or padding, the MAC subheader may comprise: a Reserve field (R field) with a one bit length; an Format filed (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

In an example, a MAC entity of the base station may transmit one or more MAC CEs (e.g., MAC CE commands) to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for UE-specific PDCCH MAC CE, a TCI State Indication for UE-specific PDSCH MAC CE, an Aperiodic CSI Trigger State Subselection MAC CE, a SP CSI-RS/CSI-IM Resource Set Activation/Deactivation MAC CE, a UE contention resolution identity MAC CE, a timing advance command MAC CE, a DRX command MAC CE, a Long DRX command MAC CE, an SCell activation/deactivation MAC CE (1 Octet), an SCell activation/deactivation MAC CE (4 Octet), and/or a duplication activation/deactivation MAC CE. In an example, a MAC CE, such as a MAC CE transmitted by a MAC entity of the base station to a MAC entity of the wireless device, may have an LCID in the MAC subheader corresponding to the MAC CE. In an example, a first MAC CE may have a first LCID in the MAC subheader that may be different than the second LCID in the MAC subheader of a second MAC CE. For example, an LCID given by 111011 in a MAC subheader may indicate that the MAC CE associated with the MAC subheader is a Long DRX command MAC CE.

In an example, the MAC entity of the wireless device may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a Short truncated BSR, and/or a Long truncated BSR. In an example, a MAC CE may have an LCID in the MAC subheader corresponding to the MAC CE. In an example, a first MAC CE may have a first LCID in the MAC subheader that may be different than the second LCID in the MAC subheader of a second MAC CE. For example, an LCID given by 111011 in a MAC subheader may indicate that a MAC CE associated with the MAC subheader is a short-truncated command MAC CE.

In carrier aggregation (CA), two or more component carriers (CCs) may be aggregated. The wireless device may, using the technique of CA, simultaneously receive or transmit on one or more CCs, depending on capabilities of the wireless device. In an example, the wireless device may support CA for contiguous CCs and/or for non-contiguous CCs. CCs may be organized into cells. For example, CCs may be organized into one primary cell (PCell) and one or more secondary cells (SCells).

When configured with CA, the wireless device may have one RRC connection with a network. During an RRC connection establishment/re-establishment/handover, a cell providing NAS mobility information may be a serving cell. During an RRC connection re-establishment/handover procedure, a cell providing a security input may be the serving cell. In an example, the serving cell may be a PCell.

In an example, the base station may transmit, to the wireless device, one or more messages. The one or more messages may comprise one or more RRC messages. For example, the one or more RRC messages may comprise one or more configuration parameters (e.g., one or more RRC configuration parameters).

In an example, the one or more RRC configuration parameters may comprise configuration parameters of a plurality of one or more SCells, depending on capabilities of the wireless device. When configured with CA, the base station and/or the wireless device may employ an activation/deactivation mechanism of an SCell to improve battery or power consumption of the wireless device. When the wireless device is configured with one or more SCells, the base station may activate or deactivate at least one of the one or more SCells. Upon configuration of an SCell, the SCell may be deactivated unless the SCell state associated with the SCell is set to “activated” or “dormant.” The wireless device may activate/deactivate the SCell in response to receiving an SCell Activation/Deactivation MAC CE.

For example, the base station may configure (e.g., via the one or more RRC messages/configuration parameters) the wireless device with uplink (UL) bandwidth parts (BWPs) and downlink (DL) BWPs to enable bandwidth adaptation (BA) on a PCell. If carrier aggregation (CA) is configured, the base station may further configure the wireless device with at least one DL BWP (i.e., there may be no UL BWP in the UL) to enable BA on an SCell. For the PCell, an initial active BWP may be a first BWP used for initial access. In paired spectrum (e.g., FDD), the base station and/or the wireless device may independently switch a DL BWP and an UL BWP. In unpaired spectrum (e.g., TDD), the base station and/or the wireless device may simultaneously switch the DL BWP and the UL BWP.

In an example, the base station and/or the wireless device may switch a BWP between configured BWPs by means of a DCI or a BWP invalidity timer. When the BWP invalidity timer is configured for the serving cell, the base station and/or the wireless device may switch the active BWP to a default BWP in response to the expiry of the BWP invalidity timer associated with the serving cell. The default BWP may be configured by the network. In an example, for FDD systems, when configured with BA, one UL BWP for each uplink carrier and one DL BWP may be active at a time in the active serving cell. In an example, for TDD systems, one DL/UL BWP pair may be active at a time in the active serving cell. Operating on one UL BWP and one DL BWP (or one DL/UL pair) may improve the wireless device battery consumption. One or more BWPs other than the active UL BWP and the active DL BWP, which the wireless device may work on, may be deactivated. On the deactivated one or more BWPs, the wireless device may: not monitor PDCCH; and/or not transmit on PUCCH, PRACH, and UL-SCH. In an example, the MAC entity of the wireless device may apply normal operations on the active BWP for an activated serving cell configured with a BWP comprising: transmitting on UL-SCH; transmitting on RACH; monitoring a PDCCH; transmitting PUCCH; receiving DL-SCH; and/or (re-)initializing any suspended configured uplink grants of configured grant Type 1 according to a stored configuration, if any. In an example, on the inactive BWP for each activated serving cell configured with a BWP, the MAC entity of the wireless device may: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

In an example, a DCI addressed to an RNTI may comprise a CRC of the DCI being scrambled with the RNTI. The wireless device may monitor PDCCH addressed to (or for) the RNTI for detecting the DCI. For example, the PDCCH may carry (or be with) the DCI. In an example, the PDCCH may not carry the DCI.

In an example, a set of PDCCH candidates for the wireless device to monitor is defined in terms of one or more search space sets. A search space set may comprise a common search space (CSS) set, or a UE-specific search space (USS) set. The wireless device may monitor one or more PDCCH candidates in one or more of the following search space sets: a Type0-PDCCH CSS set configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG, a Type0A-PDCCH CSS set configured by searchSpaceOtherSystemInformation in PDCCH-ConfigCommon for a DCI format with CRC scrambled by the SI-RNTI on the primary cell of the MCG, a Type1-PDCCH CSS set configured by ra-SearchSpace in PDCCH-ConfigCommon for a DCI format with CRC scrambled by a RA-RNTI, a MSGB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with searchSpaceType=common for DCI formats with CRC scrambled by a INT-RNTI, a SFI-RNTI, a TPC-PUSCH-RNTI, a TPC-PUCCH-RNTI, a TPC-SRS-RNTI, a CI-RNTI, or a power saving RNTI (PS-RNTI) and, only for the primary cell, a C-RNTI, a MCS-C-RNTI, or a CS-RNTI(s), and the USS set configured by SearchSpace in PDCCH-Config with searchSpaceType=ue-Specific for DCI formats with CRC scrambled by the C-RNTI, the MCS-C-RNTI, a SP-CSI-RNTI, the CS-RNTI(s), a SL-RNTI, a SL-CS-RNTI, or a SL-L-CS-RNTI.

In an example, the wireless device may monitor PDCCH (e.g., monitor the one or more PDCCH candidates) according to one or more configuration parameters of the search space set. For example, the search space set may comprise a plurality of search spaces (SSs). The wireless device may monitor the one or more PDCCH candidates in one or more CORESETs for detecting one or more DCIs. Monitoring the one or more PDCCH candidates may comprise decoding at least one PDCCH candidate of the one or more PDCCH candidates according to the monitored DCI formats. For example, monitoring the one or more PDCCH candidates may comprise decoding (e.g., blind decoding) a DCI content of the at least one PDCCH candidate via possible (or configured) PDCCH location(s), possible (or configured) PDCCH format(s), e.g., number of CCEs, number of PDCCH candidates in CSS set(s), and/or number of PDCCH candidates in the USS(s), and/or possible (or configured) DCI format(s).

In an example, the wireless device may receive the C-RNTI (e.g., via one or more previous transmissions) from the base station. For example, the one or more previous transmissions may comprise a Msg2 1312, Msg4 1314, or a MsgB 1332. If the wireless device is not provided the Type3-PDCCH CSS set or the USS set and if provided the Type1-PDCCH CSS set, the wireless device may monitor the one or more PDCCH candidates for DCI format 0_0 and DCI format 1_0 with CRC scrambled by the C-RNTI in the Type1-PDCCH CSS set.

For example, the one or more search space sets may correspond to one or more of searchSpaceZero, searchSpaceSIB1, searchSpaceOtherSystemInformation, pagingSearchSpace, ra-SearchSpace, and the C-RNTI, the MCS-C-RNTI, or the CS-RNTI. The wireless device may monitor the one or more PDCCH candidates for the DCI format 0_0 and the DCI format 1_0 with CRC scrambled by the C-RNTI, the MCS-C-RNTI, or the CS-RNTI in the one or more search space sets in a slot where the wireless device monitors the one or more PDCCH candidates for at least the DCI format 0_0 or the DCI format 1_0 with CRC scrambled by the SI-RNTI, the RA-RNTI, the MSGB-RNTI, or the P-RNTI.

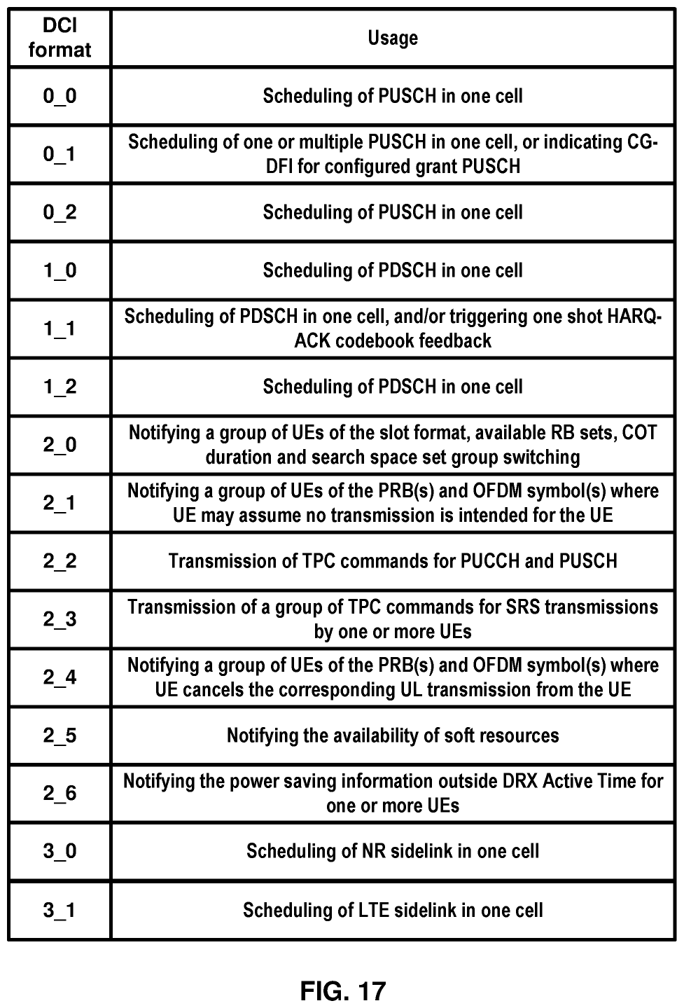

FIG. 17 shows several DCI formats. For example, the base station may use the DCI formats to transmit downlink control information to the wireless device. In an example, the wireless device may use the DCI formats for PDCCH monitoring. Different DCI formats may comprise different DCI fields and/or have different DCI payload sizes. Different DCI formats may have different signaling purposes. As shown in FIG. 17, DCI format 0_0 may be used to schedule PUSCH in one cell. In an example, DCI format 0_1 may be used to schedule one or multiple PUSCH in one cell or indicate CG-DFI (configured grant-Downlink Feedback Information) for configured grant PUSCH, etc.

For example, the one or more configuration parameters may comprise one or more PDCCH configuration parameters (e.g., a pdcch-Config IE). The one or more PDCCH configuration parameters may comprise parameters of one or more control resource sets (CORESETs) which can be used in common search spaces and/or UE-specific search spaces, e.g., for the downlink BWP of the serving cell (or serving cells). The one or more PDCCH configuration parameters may indicate a plurality of search spaces for the DL BWP, each search space being associated with a search space ID.

A CORESET of the one or more control resource sets may be associated with a CORESET index (e.g., ControlResourceSetId). The CORESET index with a value of 0 may identify a common CORESET configured in MIB and in ServingCellConfigCommon (controlResourceSetZero) and may not be used in the ControlResourceSet IE. The CORESET index with other values may identify CORESETs configured by dedicated signaling or in SIB1. The controlResourceSetId is unique among the BWPs of the serving cell. A CORESET of the one or more control resource sets may be associated with coresetPoolIndex indicating an index of a CORESET pool for the CORESET. A CORESET of the one or more control resource sets may be associated with a time duration parameter (e.g., duration) indicating contiguous time duration of the CORESET in number of symbols.

In an example, the one or more PDCCH configuration parameters may comprise parameters for one or more search space (SS) configuration parameters. The one or more SS configuration parameters may comprise at least one of: a search space ID (searchSpaceId), a control resource set ID (controlResourceSetId), a monitoring slot periodicity and offset parameter (monitoringSlotPeriodicityAndOffset), a search space time duration value (duration), a monitoring symbol indication (monitoringSymbolsWithinSlot), a number of PDCCH candidates (e.g., for an aggregation level, e.g., nrofCandidates), a PDCCH pattern (e.g., monitoringSlotsWithinSlotGroup) indicating a bitmap that applies per group of slots and provides a PDCCH monitoring pattern indicating slots in a group of slots for PDCCH monitoring, and/or a SS type indicating a common SS type or a UE-specific SS type (searchSpaceType). The monitoring slot periodicity and offset parameter may indicate slots (e.g., in a radio frame) and slot offset (e.g., related to a starting of a radio frame) for PDCCH monitoring. The monitoring symbol indication may indicate on which symbol(s) of a slot a wireless device may monitor PDCCH on the SS. The control resource set ID may identify a control resource set on which a SS may be located.

The one or more PDCCH configuration parameters (and/or the one or more SS configuration parameters) may comprise one or more search space set (SSS) switching configuration parameters. For example, the one or more SSS switching configuration parameters may comprise/indicate at least one of the following: one or more cell groups for search space switching (e.g., via cellGroupsForSwitchList IE and/or searchSpaceSwitchConfig-r16/17 IE), a timer value (e.g., an integer in units of symbol/slot/subframes, or in units of ms) for a search space (SS) switch timer (e.g., searchSpaceSwitchTimer IE), one or more group indexes (e.g., a search space group list, e.g., searchSpaceGroupIdList), and/or a search space (SS) switching delay (e.g., searchSpaceSwitchDelay). The search space switch timer and the time value may be used for a search space switching operation. A group index of the one or more group indexes may correspond to a Type3-PDCCH CSS set or USS set, e.g., for PDCCH monitoring on a serving cell and/or a DL BWP with accordance to one or more SSSs (e.g., a Type3-PDCCH CSS set, a USS set, or any other type of search space set) with the group index. For example, the SS switching delay (in a number of symbols) indicate SS switching delay Pswitch based on UE processing capability (e.g., UE processing capability 1, UE processing capability 2, etc.) and SCS configuration u. In an example, Pswitch=25 for UE capability 1 and u=0, Pswitch=25 for UE capability 1 and u=1, Pswitch=25 for UE capability 1 and u=2, Pswitch=10 for UE capability 2 and u=0, Pswitch=12 for UE capability 2 and u=1, and Pswitch=22 for UE capability 2 and μ=2, etc.

In an example, when the one or more group indexes is not indicated/configured (e.g., a searchSpaceGroupIdList is not provided for a search space set), the wireless device may monitor the PDCCH (or the search space set) on a DL BWP and/or a serving cell (of cellGroupsForSwitchList), without switching away from the search space set.

In an example, when searchSpaceGroupIdList is configured/indicated, the wireless device may reset PDCCH monitoring according to search space sets with the group index 0, if provided by searchSpaceGroupIdList.

The wireless device may decrement value of the search space switch timer by one after each slot based on a reference SCS configuration that is a smallest SCS configuration u among all configured DL BWPs in the serving cell, or in the set of serving cells. The wireless device may maintain the reference SCS configuration during the timer decrement procedure. In an example, searchSpaceSwitchTimer may be defined as a value in unit of slots for monitoring PDCCH in the active DL BWP of the serving cell before moving to a default search space group (e.g., search space group 0). For 15 kHz SCS, a valid timer value may be one of {1, . . . , 20}. For 30 kHz SCS, a valid timer value may be one of {1, . . . , 40}. For 60 kHz SCS, a valid timer value may be one of {1, . . . , 80}. In an example, the base station may configure a same timer value for all serving cells in the same CellGroupForSwitch.

Semi-persistent scheduling (SPS) may be supported in the downlink, where the wireless device may be configured with a periodicity of the data transmission using the one or more configuration parameters (e.g., SPS-Config). Activation of semi-persistent scheduling may be done using PDCCH with CS-RNTI (e.g., receiving the PDCCH transmission addressed to/by the CS-RNTI). The PDCCH may carry necessary information in terms of time-frequency resources and other parameters. A HARQ process number/ID may be derived from a time, for example, when the downlink data transmission starts. Upon activation of semi-persistent scheduling, the wireless device may receive downlink transmission periodically according to the periodicity of the data transmission using one or more transmission parameters indicated in the PDCCH activating the semi-persistent scheduling.

In the uplink, two schemes for transmission without a dynamic grant may be supported. The two schemes may differ in the way they are activated: 1) type 1 of the configured grant (or configured grant Type 1), where an uplink grant is provided by the one or more configuration parameters (e.g., ConfiguredGrantConfig), including activation of the grant, 2) configured grant Type 2 (or type 2 of the configured grant), where the transmission periodicity is provided by the one or more configuration parameters (e.g., ConfiguredGrantConfig) and L1/L2 control signaling is used to activate/deactivate the transmission in a similar way as in the SPS. The two schemes may reduce control signaling overhead, and the latency before uplink data transmission, as no scheduling request-grant cycle is needed prior to data transmission. In an example of the configured grant Type 2, the one or more configuration parameters may indicate/configure the preconfigured periodicity and PDCCH activation may provide transmission parameters. Upon receiving the activation command, the wireless device may transmit according to the preconfigured periodicity, if, for example, there are data in the buffer. If there are no data to transmit, the wireless device may, similarly to the configured grant Type 1, not transmit anything. The wireless device may acknowledge the activation/deactivation of configured grant Type 2 by sending a MAC control element in the uplink. In both schemes, it is possible to configure multiple wireless devices with overlapping time-frequency resources in the uplink. In this case, the network may differentiate between transmissions from different wireless devices. In an example, PUSCH resource allocation may be semi-statically configured by the one or more configuration parameters (e.g., ConfiguredGrantConfig).

In an example, the wireless device may support a baseline processing time/capability. For example, the wireless device may support additional aggressive/faster processing time/capability. In an example, the wireless device may report to the base station a processing capability, e.g., per sub-carrier spacing. In an example, a PDSCH processing time may be considered to determine, by a wireless device, a first uplink symbol of a PUCCH (e.g., determined at least based on a HARQ-ACK timing K1 and one or more PUCCH resources to be used and including the effect of the timing advance) comprising the HARQ-ACK information of the PDSCH scheduled by a DCI. In an example, the first uplink symbol of the PUCCH may not start earlier than a time gap (e.g., T_{proc,1}) after a last symbol of the PDSCH reception associated with the HARQ-ACK information. In an example, the first uplink symbol of the PUCCH which carries the HARQ-ACK information may start no earlier than at symbol L1, where L1 is defined as the next uplink symbol with its Cyclic Prefix (CP) starting after the time gap T_{proc,1} after the end of the last symbol of the PDSCH.

In an example, a PUSCH preparation/processing time may be considered for determining the transmission time of an UL data. For example, if the first uplink symbol in the PUSCH allocation for a transport block (including DM-RS) is no earlier than at symbol L2, the wireless device may perform transmitting the PUSCH. In an example, the symbol L2 may be determined, by a wireless device, at least based on a slot offset (e.g., K2), SLIV of the PUSCH allocation indicated by time domain resource assignment of a scheduling DCI. In an example, the symbol L2 may be specified as the next uplink symbol with its CP starting after a time gap with length T_{proc,2} after the end of the reception of the last symbol of the PDCCH carrying the DCI scheduling the PUSCH.

A Scheduling Request (SR) may be used, by the wireless device, for requesting UL-SCH resources (e.g., from the base station) for new transmission (e.g., a new UL transmission). In an example, the MAC entity of the wireless device may be configured with zero, one or more SR configurations (e.g., via the one or more configuration parameters). For example, an SR configuration may consist of a one or more PUCCH resources for SR across different BWPs and cells. For a logical channel (LCH) or for SCell beam failure recovery and for consistent LBT failure recovery, at most one PUCCH resource for SR may be configured per BWP. For example, a SR configuration may comprise a SR prohibit timer (e.g., sr_ProhibitTimer) and a maximum number of SR transmission (e.g., sr_TransMax). In an example, the SR prohibit timer may be a duration during which the wireless device may be not allowed to transmit the SR. In an example, the wireless device may stay active while sr_ProhibitTimer is running and may monitor PDCCH for detecting DCI indicating uplink scheduling grant(s). In an example, the maximum number of SR transmission (e.g., sr_TransMax) may be a transmission number for which the wireless device may be allowed to transmit the SR at most.

In an example, each SR configuration may correspond to one or more logical channels and/or to SCell beam failure recovery and/or to consistent LBT failure recovery. Each logical channel, SCell beam failure recovery, and consistent LBT failure recovery may be mapped to zero or one SR configuration (configured by the one or more RRC configuration). The SR configuration of the logical channel that triggered a BSR or the SCell beam failure recovery or the consistent LBT failure recovery (if such a configuration exists) may be considered as corresponding SR configuration for the triggered SR. In an example, any SR configuration may be used for an SR triggered by Pre-emptive BSR. In an example, a first SR configuration in the plurality of SR configurations may correspond to one or more LCHs of the plurality of LCHs. For example, each SR configuration may correspond to one or more logical channels. Each logical channel may be mapped to zero or one SR configuration configured by the at least one message.

In an example, the wireless device may trigger a SR in response to a triggered BSR (e.g., SR for BSR or SR-BSR procedure). For example, the wireless device may trigger the SR based on at least one BSR having been triggered and not cancelled, a regular BSR of the at least one BSR having been triggered and a logicalChannelSR-DelayTimer associated with a LCH for the regular BSR is not running, and no UL-SCH resource(s) being available for a new transmission (or the MAC entity being configured with configured uplink grant(s) and the regular BSR being triggered for a LCH for which logicalChannelSR-Mask is set to false, or the UL-SCH resources available for a new transmission not meeting the LCP mapping restrictions configured for the LCH that triggered the BSR.

In an example, the wireless device may determine that UL-SCH resource(s) are available if a MAC entity of the wireless device has an active configuration for either type (type 0 or type 1) of configured uplink grants, or if the MAC entity has received a dynamic uplink grant, or if both these conditions are met. In an example, the wireless device may determine that one or more UL-SCH resources are available if the MAC entity has been configured with, receives, or determines an uplink grant. If the MAC entity has determined at a given point in time that the one or more UL-SCH resource(s) are available, the one or more UL-SCH resource(s) may become unavailable for use.

In an example, the wireless device may consider a SR configuration of the LCH that triggered the BSR as a corresponding SR configuration for the triggered SR. In an example, when the SR is triggered, a wireless device may consider the SR pending until it is cancelled. In an example, when one or more UL grants accommodate one or more pending data (e.g., all pending data) available for transmission, one or more pending SRs (e.g., all pending SRs), including the triggered SR, may be cancelled.

The wireless device may determine whether there is at least one valid PUCCH resource for the triggered SR (or pending SR) at the time of the SR transmission occasion. In an example, based on determining that there is no valid PUCCH resource for the pending SR, the wireless device may initiate/trigger a random access procedure on a PCell, or a PSCell. The wireless device may cancel the pending SR based on initiating the RA procedure in. In an example, based on determining that there is at least one valid PUCCH resource for the pending SR (e.g., by determining that the PUCCH resource for the SR transmission occasion does not overlap with a measurement gap), the wireless device may instruct the physical layer to signal the SR on the at least one valid PUCCH resource for SR. In an example, for transmitting the SR, a PUCCH resource may be a PUCCH format 0 or PUCCH format 1.

In an example, based on determining that the SR prohibit timer is running, the wireless device may wait for another SR transmission occasion after the SR prohibit timer being expired/stopped. In an example, the wireless device may maintain a SR transmission counter (e.g., SR_COUNTER) associated with the SR configuration for counting the number of times that the SR being transmitted/retransmitted. For example, based on the SR being triggered and there are no other SRs pending corresponding to the SR configuration corresponding to the triggered SR, the wireless device may set/initialize the SR_COUNTER of the SR configuration to a first value (e.g., 0).

In an example, based on the SR prohibit timer being expired and the SR_COUNTER being less than the maximum number of SR transmission, the wireless device may retransmit the SR, increment the SR_COUNTER (e.g., by one), and start the SR prohibit timer. The wireless device may start monitoring PDCCH for detecting a DCI indicating one or more uplink grants when the SR prohibit timer is running. In an example, based on the one or more uplink grants being received, the wireless device may cancel the pending SR, and/or stop the SR prohibit timer if the one or more UL grants accommodate pending data (e.g., all pending data). In an example, the wireless device may cancel all pending SR(s) (including the SR) for BSR triggered before a MAC PDU assembly and/or stop each respective SR prohibit timer (including the SR prohibit timer) in response to the MAC PDU being transmitted and the MAC PDU being comprised a Long or Short BSR MAC CE which may contain buffer status up to (and including) the last event that triggered the BSR prior to the MAC PDU assembly. In an example, the wireless device may cancel all pending SR(s) (including the SR) for BSR triggered according to the BSR procedure and stop each respective SR prohibit timer (including the SR prohibit timer) by determining that the one or more UL grants may accommodate all pending data available for transmission.

In an example, based on the one or more uplink grants, which may accommodate all pending data available for transmission, not being received until the expiry of the SR prohibit timer, the wireless device may perform at least one of the following: determining the at least one valid PUCCH resource for the transmission of the SR being available; determining whether the SR prohibit timer is not running; determining the SR_COUNTER is smaller than the maximum number of the SR transmission. For example, in response to the SR_COUNTER being smaller than the maximum number of the SR transmission and the SR prohibit timer is not running, the wireless device may retransmit the SR, increment the SR_COUNTER, start the SR prohibit timer; and monitor the PDCCH. In an example, based on the SR_COUNTER being equal to or greater than the maximum number of the SR transmission, the wireless device may release PUCCH resource(s) for one or more serving cells (including the serving cell), and/or release SRS for the one or more serving cells (including the serving cell), and/or clear one or more configured downlink assignments and uplink grants, and/or initiate/trigger a random access procedure on a PCell, and/or cancel the pending SR.

In an example, the wireless device may initiate/trigger a random access (RA) procedure based on determining that a pending SR, triggered by a BSR, has no valid PUCCH resource. For example, the wireless device may stop the RA procedure due to the pending SR in response to transmitting a MAC PDU via a first UL grant other than a second UL grant provided by a RAR (or a MsgA payload) of the RA procedure; and the MAC PDU comprising a BSR MAC CE which contains buffer status up to (and comprising) a last event that triggered the BSR prior to the MAC PDU assembly. In an example, the wireless device may stop the RA procedure due to the pending SR if the first UL grant can accommodate all pending data available for transmission.

In an example, the wireless device may initiate/trigger a random access (RA) procedure based on determining that a pending SR, triggered by a beam failure recovery on a SCell, has no valid PUCCH resource. For example, the wireless device may stop the RA procedure due to the pending SR in response to transmitting a MAC PDU via a first UL grant other than a second UL grant provided by a RAR (or a MsgA payload) of the RA procedure; and the MAC PDU comprising a BFR MAC CE or Truncated BFR MAC CE which contains the beam failure recovery information on the SCell.

In an example, the wireless device may initiate/trigger a random access (RA) procedure based on determining that a pending SR, triggered for a consistent LBT recovery on a SCell, has no valid PUCCH resource. For example, the wireless device may stop the RA procedure due to the pending SR in response to transmitting a MAC PDU via a first UL grant other than a second UL grant provided by a RAR (or a MsgA payload) of the RA procedure; and the MAC PDU comprising a LBT failure MAC CE that indicates consistent LBT failure for all the SCells that triggered consistent LBT failure.

In an example, the wireless device may trigger a SR by Pre-emptive BSR procedure prior to a MAC PDU assembly. Based on the MAC PDU containing the relevant Pre-emptive BSR MAC CE being transmitted, the wireless device may cancel the pending SR and stop the corresponding SR prohibit timer, if running.

For example, the wireless device may trigger a SR by beam failure recovery of an SCell. Based on a MAC PDU being transmitted, and a BFR MAC CE or a Truncated BFR MAC CE (containing beam failure recovery information for the SCell) being included in the MAC PDU, the wireless device may cancel the pending SR and stop the corresponding SR prohibit timer, if running. In another example, based on the SCell being deactivated, the wireless device may cancel the pending SR and stop the corresponding SR prohibit timer, if running.

For example, the wireless device may trigger a SR by consistent LBT failure recovery of an SCell. Based on a MAC PDU (comprising an LBT failure MAC CE that indicates consistent LBT failure for this SCell) being transmitted, the wireless device may cancel the pending SR and stop the corresponding SR prohibit timer if running. In an example, if the triggered consistent LBT failure for the SCell being cancelled, the wireless device may cancel the pending SR and stop the corresponding SR prohibit timer if running.

In an example, the one or more configuration parameters may configure one or more SRS configuration parameters. For example, the one or more SRS configuration parameters may semi-statically configure the wireless device with the one or more SRS resource sets (e.g., SRS-ResourceSet and/or SRS-PosResourceSet). For example, the one or more SRS configuration parameters may comprise at least one of: an SRS resource configuration identifier; number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource.

In an example, the one or more SRS configuration parameters may configure the wireless device with periodic SRS transmission/reporting, e.g., by setting resource Type in SRS-Resource or SRS-PosResource is set to ‘periodic’. For example, based on the one or more SRS configurations, the wireless device may transmit an SRS resource with the spatial domain transmission filter used for the reception of one of the following: a spatial domain transmission filter used for the reception of the reference SS/PBCH block, a spatial domain transmission filter used for the reception of the reference periodic CSI-RS or of the reference semi-persistent CSI-RS, or a spatial domain transmission filter used for the transmission of the reference periodic SRS.

In an example, the one or more SRS configuration parameters may configure the wireless device with semi-persistent SRS transmission/reporting (e.g., the resourceType in SRS-Resource or SRS-PosResource is set to ‘semi-persistent’). For example, the wireless device may receive an activation command (e.g., SP SRS MAC CE Activation MAC CE or SR positioning SRS MAC CE Activation MAC CE) for an SRS resource. The activation command for the SRS resource may comprise one or more spatial relation assumptions indicated (or provided) by a list of references to reference signal IDs, one per element of the activated SRS resource set. If the activated resource set is configured with spatialRelationInfo or spatialRelationInfoPos, the wireless device may assume that the ID of the reference signal in the activation command (e.g., the SP SRS MAC CE Activation MAC CE or the SR positioning SRS MAC CE Activation MAC CE) for the SRS resource overrides the one configured in spatialRelationInfo or spatialRelationInfoPos.

For example, when the one or more SRS configuration parameters indicate/configure SRS-ResourceSet, each ID in the list may refer to a reference SS/PBCH block, NZP CSI-RS resource configured on a first serving cell indicated by Resource Serving Cell ID field in the activation command for the SRS resource if present, the first serving cell as the SRS resource set otherwise, or SRS resource configured on a second serving cell and uplink bandwidth part indicated by Resource Serving Cell ID field and Resource BWP ID field in the activation command for the SRS resource if present, the second serving cell and bandwidth part as the SRS resource set otherwise.

In an example, when the one or more SRS configuration parameters indicate/configure SRS-PosResourceSet, each ID in the list of reference signal IDs may refer to a reference SS/PBCH block on a third serving or a first non-serving cell indicated by PCI field in the activation command for the SRS resource, NZP CSI-RS resource configured on the third serving cell indicated by Resource Serving Cell ID field in the activation command for the SRS resource if present, the third serving cell as the SRS resource set otherwise, SRS resource configured on a fourth serving cell and uplink bandwidth part indicated by Resource Serving Cell ID field and Resource BWP ID field in the activation command in the SRS resource if present, the fourth serving cell and bandwidth part as the SRS resource set otherwise, or DL PRS resource of a fifth serving or a second non-serving cell associated with a dl-PRS-ID indicated by DL-PRS ID field in the activation command for the SRS resource.

In an example, the wireless device may receive a deactivation command (e.g., SP SRS MAC CE Deactivation MAC CE or SP positioning SRS MAC CE Deactivation MAC CE) for the activated SRS resource set. In an example, if the wireless device has an active semi-persistent SRS resource configuration and has not received the deactivation command, the semi-persistent SRS configuration may be considered active in the UL BWP that is active, otherwise it may be considered suspended.

In an example, the one or more configuration parameters may comprise one or more CSI configuration parameters comprising at least: one or more CSI-RS resource settings; one or more CSI reporting settings, and at least one CSI measurement setting.

In an example, a CSI-RS resource setting may comprise one or more CSI-RS resource sets. In an example, there may be one CSI-RS resource set for periodic CSI-RS, or semi-persistent (SP) CSI-RS. For example, the CSI-RS resource set may comprise at least one of: one CSI-RS type (e.g., periodic, aperiodic, or semi-persistent); one or more CSI-RS resources. For example, a time domain behavior of the CSI-RS resources within the CSI-RS resource setting may be indicated/configured (e.g., by resourceType) as aperiodic, periodic, or semi-persistent. For example, the one or more CSI-RS resources may comprise at least one of: CSI-RS resource configuration identity (or index); number of CSI-RS ports; CSI-RS configuration (symbol and RE locations in a subframe); CSI-RS subframe configuration (subframe location, offset, and/or periodicity in radio frame); CSI-RS power parameter; CSI-RS sequence parameter; CDM type parameter; frequency density; transmission comb; and/or QCL parameters.

For example, the CSI resource setting may indicate a semi-persistent resource type (e.g., the resource Type being set with ‘semiPersistent’). In an example, the wireless device may receive a SP CSI-RS/CSI-IM Resource Set Activation MAC CE command for one or more CSI-RS resource sets for channel measurement and/or one or more CSI-IM/NZP CSI-RS resource sets for interference measurement associated with the CSI resource setting. For example, the wireless device may receive a SP CSI-RS/CSI-IM Resource Set Deactivation MAC CE command for the (activated) one or more CSI-RS resource sets and/or the (activated) one or more CSI-IM resource sets.

In an example, the one or more CSI-RS resources may be transmitted (by the base station) periodically (e.g., when the resource Type is set to periodic), using aperiodic transmission (e.g., when the resourceType is set to aperiodic), and/or using a semi-persistent transmission (e.g., when the resourceType is set to semi-persistent). In the periodic transmission, the configured CSI-RS resource may be transmitted (by the base station) using a configured periodicity in time domain. In the aperiodic transmission, the configured CSI-RS resource may be transmitted (by the base station) in a dedicated time slot or subframe. In a multi-shot or the semi-persistent transmission, the configured CSI-RS resource may be transmitted (by the base station) within a configured period. The base station may stop transmission of the one or more SP CSI-RSs if the CSI-RS is configured with a transmission duration. The base station may stop transmission of the one or SP CSI-RSs in response to transmitting a MAC CE or DCI for deactivating (or stopping the transmission of) the one or more SP CSI-RSs.

In an example, a CSI reporting setting may comprise at least one of: one report configuration identifier; one report type; one or more reported CSI parameters; one or more CSI type (e.g., type I or type II); one or more codebook configuration parameters; one or more parameters indicating time-domain behavior; frequency granularity for CQI and PMI; and/or measurement restriction configurations. The CSI reporting setting may further comprise at least one of: one periodicity parameter (e.g., indicating a periodicity of a CSI report); one duration parameter (e.g., indicating a duration of the CSI report transmission); and/or one slot offset (e.g., indicating a value of timing offset of the CSI report), if the report type is a periodic CSI or a semi-persistent CSI report. For example, the one periodicity parameter and/or the one slot offset may apply in the numerology of an UL BWP in which the CSI report is configured to be transmitted on.

In an example, the report type may indicate a time domain behavior of the CSI report. For example, the time domain behavior may be indicated by a reportConfigType and may be set to ‘aperiodic’ (e.g., aperiodic CSI report using/on PUSCH), ‘semiPersistentOnPUCCH’ (e.g., semi-persistent CSI report using/on PUCCH), ‘semiPersistentOnPUSCH’ (e.g., semi-persistent CSI report using/on PUSCH that is activated by a DCI), or ‘periodic’ (e.g., periodic CSI report using/on PUCCH). The higher layer parameter reportQuantity indicates the CSI-related, L1-RSRP-related, or L1-SINR-related quantities to report via the CSI report. For example, for the periodic CSI report on PUCCH or the semi-persistent CSI report on PUCCH, a periodicity (measured in slots) and a slot offset may be configured (e.g., by reportSlotConfig). For example, for the semi-persistent CSI report on PUSCH, a periodicity measured in slots may be configured (e.g., by the reportSlotConfig). In an example, for the semi-persistent or the aperiodic CSI report on PUSCH, the allowed slot offsets may be configured based on at least whether the CSI report (semi-persistent or aperiodic) is activated/triggered by a DCI format 2_0 or a DCI format 1_0.

In an example, if the wireless device is configured with the semi-persistent CSI reporting (on/using PUSCH or PUCCH), the wireless device may report CSI when both CSI-IM and NZP CSI-RS resources are configured as periodic or semi-persistent. If the wireless device is configured with the aperiodic CSI reporting (on PUSCH), the wireless device may report CSI when both CSI-IM and NZP CSI-RS resources are configured as periodic, semi-persistent or aperiodic. For example, the CSI report may comprise Channel Quality Indicator (CQI), precoding matrix indicator (PMI), CSI-RS resource indicator (CRI), SS/PBCH Block Resource indicator (SSBRI), layer indicator (L1), rank indicator (RI), Layer 1 reference signal received power (L1-RSRP) or Layer 1 signal-to-interference-plus-noise ratio (L1-SINR).

In an example, for CQI, PMI, CRI, SSBRI, L1, RI, L1-RSRP, L1-SINR, the one or more CSI reporting settings may comprise one or more CSI-ReportConfig reporting settings, one or more CSI-ResourceConfig resource settings, and one or two lists of trigger states (e.g., given by CSI-AperiodicTriggerStateList and CSI-SemiPersistentOnPUSCH-TriggerStateList). For example, each trigger state in the CSI-SemiPersistentOnPUSCH-TriggerStateList may contain one associated CSI-ReportConfig.

In an example, the at least one CSI measurement setting may comprise one or more links comprising one or more link parameters. The link parameter may comprise at least one of: one CSI reporting setting indication, CSI-RS resource setting indication, and one or more measurement parameters.

In an example, in the time domain, a CSI reference resource for a CSI reporting (e.g., a periodic CSI report) in uplink slot n may be defined by a single downlink slot m-n_{CSI}. Parameter m may be determined based on

$$m = ⌊ n \frac{{μ}_{D L}}{{μ}_{U L}} ⌋ + Δ$$

where μ_{UL} in the SCS of the UL configuration, μ_{DL} is the SCS of the DL configuration, and A may depend on CA configuration. In an example, n_{CSI} may depend on at least one of: the type of the CSI reporting (e.g., periodic, aperiodic, or semi-persistent CSI reporting), whether a single CSI-RS/SSB resource or multiple CSI-RS/SSB resources are configured for channel measurement, and/or channel and interference measurements. In an example, when there is no valid downlink slot for the CSI reference resource corresponding to the CSI report setting in a serving cell, the CSI reporting may be omitted for the serving cell in the uplink slot n.

In an example, the base station may trigger a CSI reporting by transmitting an RRC message, or a MAC CE, or a DCI. In an example, the wireless device may perform periodic CSI reporting based on an RRC message and one or more periodic CSI-RSs. In an example, the wireless device may not be allowed (or required) to perform the periodic CSI reporting based on the one or more aperiodic CSI-RSs and/or the one or more SP CSI-RSs.

In an example, a CSI reporting may comprise transmitting a CSI report. For example, the wireless device may perform the CSI reporting by transmitting the CSI report.

The wireless device may perform a semi-persistent CSI reporting on a PUSCH in response to the semi-persistent CSI reporting being activated (or triggered). For example, the wireless device may perform the semi-persistent CSI reporting on the PUSCH upon (or in response to) successful decoding of a DCI format 0_1 or a DCI format 0_2 which activates a semi-persistent CSI trigger state. The DCI format 0_1 and the DCI format 0_2 may contain a CSI request field which may indicate the semi-persistent CSI trigger state to activate or deactivate.

In an example, a CSI reporting on PUSCH (e.g., the semi-persistent CSI reporting on PUSCH) may be multiplexed with uplink data (from the wireless device) on PUSCH. For example, when the semi-persistent CSI reporting on PUSCH, activated by a DCI format, is not expected to be multiplexed with the uplink data on the PUSCH, the wireless device may not multiplex the semi-persistent CSI reporting with the uplink data. In an example, the CSI reporting on PUSCH may be performed without any multiplexing with the uplink data on the PUSCH.

For example, the wireless device may perform the semi-persistent CSI reporting (e.g., report the semi-persistent CSI) based on a MAC CE activation command, and/or a DCI, and based on the one or more periodic CSI-RSs or the one or more SP CSI-RSs. For example, for semi-persistent reporting on PUSCH, a set of trigger states may be configured (e.g., by CSI-SemiPersistentOnPUSCH-TriggerStateList), where the CSI request field in the DCI scrambled with SP-CSI-RNTI activates one of the trigger states. In an example, the wireless device may not be allowed (or required) to perform the semi-persistent CSI reporting based on one or more aperiodic CSI-RSs. In an example, the wireless device may perform aperiodic CSI reporting (e.g., report aperiodic CSI) based on a DCI and based on the one or more periodic CSI-RSs, the one or more SP CSI-RSs, or the one or more aperiodic CSI-RSs.

The one or more CSI configuration parameters may semi-statistically configure the wireless device to perform periodic CSI reporting on PUCCH. For example, the one or more CSI configuration parameters may configure multiple periodic CSI reports corresponding to one or more CSI reporting settings. For example, the PUCCH formats 2, 3, 4 may support Type I CSI with wideband granularity.

In an example, the wireless device may perform the semi-persistent CSI reporting on PUCCH in response to the semi-persistent CSI reporting being activated (or triggered) by a MAC CE (e.g., SP CSI reporting on PUCCH activation MAC CE). For semi-persistent reporting on PUCCH, the PUCCH resource used for transmitting a CSI report may be configured by reportConfigType. The wireless device may perform the semi-persistent CSI reporting on PUCCH applied starting from the first slot after transmitting a HARQ-ACK information corresponding to a PDSCH carrying the SP CSI reporting on PUCCH activation MAC CE command. For example, the semi-persistent CSI reporting on PUCCH may support Type I CSI. In an example, the semi-persistent CSI reporting on PUCCH format 2 may support Type I CSI with wideband frequency granularity. In an example, the semi-persistent CSI reporting on PUCCH formats 3 or 4 may support Type I CSI with wideband and sub-band frequency granularities and Type II CSI Part 1.

In an example, the one or more configuration parameters may comprise one or more DRX configuration parameters (e.g., DRX-Config). The one or more DRX configuration parameters may configure the wireless device with DRX operation. In an example, the one or more DRX configuration parameters may indicate monitoring the PDCCH for the DRX operation. For example, when in an RRC_CONNECTED state, if the DRX operation is configured (e.g., the DRX is configured or a DRX cycle is configured), for all the activated Serving Cells (e.g., the serving cell), the MAC entity of the wireless device may monitor the PDCCH discontinuously using the DRX operation. Otherwise, the MAC entity may monitor the PDCCH continuously.

For example, the wireless device may, based on the DRX operation being configured, use the DRX operation while communicating with the base station in the serving cell. For example, a MAC entity (or the MAC layer) of the wireless device, based on the DRX operation being configured, may control the PDCCH monitoring activity of the MAC entity. When the DRX operation is configured, the wireless device may monitor the PDCCH for at least one RNTI. The at least one RNTI may comprise one or more of the following: C-RNTI, cancelation indication RNTI (CI-RNTI), configured scheduling RNTI (CS-RNTI), interruption RNTI (INT-RNTI), slot format indication RNTI (SFI-RNTI), semi-persistent channel state information RNTI (SP-CSI-RNTI), transmit power control physical uplink control channel RNTI (TPC-PUCCH-RNTI), transmit power control physical shared channel RNTI (TPC-PUSCH-RNTI), transmit power control sounding reference signal RNTI (TPC-SRS-RNTI), or availability indicator RNTI (AI-RNTI).

In an example, the one or more DRX configuration parameters may comprise: DRX on duration timer/period/window (e.g., drx-onDurationTimer) indicating a duration at the beginning of a DRX cycle, drx-SlotOffset indicating a delay before starting the DRX on duration timer, DRX inactivity timer/period/window (e.g., drx-InactivityTimer) indicating a duration after a PDCCH occasion in which the PDCCH indicates a new UL or DL transmission for the MAC entity, DRX retransmission timer of DL (e.g., drx-RetransmissionTimerDL), per DL HARQ process except for the broadcast process, indicating a maximum duration until a DL retransmission is received, DRX retransmission timer of UL (e.g., drx-RetransmissionTimerUL), per UL HARQ process, indicating a maximum duration until a grant for UL retransmission is received, drx-LongCycleStartOffset indicating a Long DRX cycle and drx-StartOffset which defines a subframe where a Long and Short DRX cycle starts, drx-ShortCycle for a Short DRX cycle, drx-ShortCycle Timer indicating a duration the wireless device may follow the Short DRX cycle, drx-HARQ-RTT-TimerDL (per DL HARQ process except for the broadcast process) indicating a minimum duration before a DL assignment for HARQ retransmission is expected by the MAC entity, drx-HARQ-RTT-TimerUL (per UL HARQ process) indicating a minimum duration before an UL HARQ retransmission grant is expected by the MAC entity.

In an example, the one or more DRX configuration parameters may configure the Serving Cells (e.g., the serving cell) two DRX groups with separate DRX parameters. When a secondary DRX group is not configured, there may be only one DRX group (e.g., a DRX group) and the Serving Cells (e.g., the serving cell) may belong to the DRX group. When the two DRX groups are configured (e.g., the DRX group and a second DRX group), each Serving Cell (e.g., the serving cell) is uniquely assigned (or belong) to either of the DRX group or the second DRX group. The DRX configuration parameters that are separately configured for each DRX group are: the DRX on duration timer (e.g., the drx-onDurationTimer) and/or the DRX inactivity timer (e.g., the drx-InactivityTimer). The one or more DRX configuration parameters that are common to the two DRX groups are: drx-SlotOffset, drx-RetransmissionTimerDL, drx-Retransmission TimerUL, drx-LongCycleStartOffset, drx-ShortCycle (optional), drx-ShortCycle Timer (optional), drx-HARQ-RTT-TimerDL, and drx-HARQ-RTT-TimerUL.

For example, when the DRX operation is configured, the wireless device may be in an on duration of the DRX operation (e.g., a DRX on duration) or an off duration of the DRX operation (e.g., a DRX off duration). For example, the DRX on duration may start based on starting the DRX on duration timer/period. For example, when the wireless device is not in the DRX on duration, the wireless device may be in the DRX off duration (e.g., outside of the DRX on duration). For example, the DRX off duration may stop based on starting the DRX on duration timer. For example, the wireless device may switch/transit from the DRX on duration to the DRX off duration based on stopping the DRX on duration timer. For example, the wireless device may switch/transit from the DRX off duration to the DRX on duration based on starting the DRX on duration.

In an example, when the DRX operation is configured, the wireless device may determine whether the wireless device is in an active time (or a DRX active state or Active Time) of the DRX operation. For example, the active time of the DRX operation may specify the active time for the serving cell (or the Serving Cells) in the DRX group. For example, the wireless device may determine that the active time of the DRX operation (e.g., the active time for the serving cell in the DRX group) comprises the DRX on duration.

For example, the wireless device may determine that the active time for the serving cell in the DRX group comprises the time while: the DRX on duration timer (e.g., drx-onDurationTimer) or the DRX inactivity timer (e.g., drx-InactivityTimer) configured for the DRX group is running, or the DRX retransmission timer of DL (e.g., drx-RetransmissionTimerDL) or the DRX retransmission timer of the UL (e.g., drx-RetransmissionTimerUL) is running on any of the Serving Cells (e.g., the serving cell) in the DRX group, or a contention resolution timer (e.g., ra-ContentionResolutionTimer) or a message B (MsgB) response window (e.g., msgB-ResponseWindow) is running, or a scheduling request (SR) is sent/transmitted on PUCCH and is pending, or a PDCCH indicating a new transmission addressed to the C-RNTI not being received after successful reception of a random access response (RAR) for a Random Access Preamble (or a preamble 1311/1321/1341) that is not selected by the MAC entity among the contention-based Random Access Preamble(s).

For example, when the wireless device is outside the active time for the serving cell in the DRX group, the wireless device may be in a DRX inactive state (or a DRX non-active time or a DRX non-active state). For example, when the wireless device is in the active time for the serving cell in the DRX group, the wireless device may be in a DRX active state.

For example, the wireless device may evaluate one or more DRX active time conditions (or one or more DRX Active Time conditions) to determine whether the wireless device is in the active time of the DRX group (for the serving cell in the DRX group) or not. For example, based on evaluating the one or more DRX active time conditions, the wireless device may determine that the wireless device is in active time of the DRX group based on the one or more DRX active time conditions being satisfied.

For example, the one or more DRX active time conditions may be satisfied based on the DRX on duration timer (e.g., drx-onDurationTimer) configured for the DRX group is running, or the DRX inactivity timer (e.g., drx-InactivityTimer) configured for the DRX group is running, or the DRX retransmission timer for DL (e.g., drx-RetransmissionTimerDL), on any of the Serving Cells (including the serving cell) in the DRX group, is running, or the DRX retransmission timer for UL (e.g., drx-RetransmissionTimerUL), on any of the Serving Cells (including the serving cell) in the DRX group, is running, or the contention resolution timer (e.g., ra-ContentionResolutionTimer) is running, or the MsgB response window (e.g., msgB-Response Window) is running, or the PDCCH indicating the new transmission addressed to the C-RNTI (after successful reception of RAR for preamble that is not selected by the MAC entity among the contention-based preamble(s)) has been received, or the SR being sent/transmitted on PUCCH, where in the SR is pending.

For example, the wireless device may, by evaluating the one or more DRX active time conditions, determine whether a current symbol is in active time of the DRX operation or not. For example, to evaluate the one or more DRX active time conditions the wireless device may consider at least one of the following: whether an UL grant (or UL grants) is received until a predefined gap prior to the current symbol, whether a DL assignment (or DL assignments) is received until the predefined gap milliseconds prior to the current symbol, or whether a (Long) DRX command MAC CE is received until the predefined gap prior to the current symbol, or whether the SR sent/transmitted until the predefined gap prior to the current symbol. For example, the UL grant may be an UL grant indicated/scheduled based on detecting a DCI format. For example, the assignment may be a DL assignment indicated/scheduled based on detecting a DCI format. For example, the predefined gap may be 4 milliseconds in NR. For example, the predefined gap may be 5 milliseconds in LTE.

In an example, when the DRX operation is configured, if a MAC PDU is received in a configured downlink assignment, the MAC entity of the wireless device may start the drx-HARQ-RTT-TimerDL for a corresponding HARQ process in a first symbol after the end of a corresponding transmission carrying a DL HARQ feedback and/or stop the drx-Retransmission TimerDL for the corresponding HARQ process.

In an example, when the DRX operation is configured, if a MAC PDU is transmitted in a configured uplink grant and listen before talk (LBT) failure indication is not received from lower layers (e.g., the physical layer) of the wireless device, the MAC entity of the wireless device may start the drx-HARQ-RTT-TimerUL for the corresponding HARQ process in the first symbol after the end of the first transmission (e.g., within a bundle) of the corresponding PUSCH transmission and/or stop the drx-RetransmissionTimerUL for the corresponding HARQ process at the first transmission (within a bundle) of the corresponding PUSCH transmission.

In an example, when the DRX operation is configured, if the drx-HARQ-RTT-TimerDL expires and if the data of the corresponding HARQ process was not successfully decoded, the MAC entity of the wireless device may start the drx-RetransmissionTimerDL for the corresponding HARQ process in the first symbol after the expiry of drx-HARQ-RTT-TimerDL.

In an example, when the DRX operation is configured, if the drx-HARQ-RTT-TimerUL expires, the MAC entity of the wireless device may start the drx-Retransmission TimerUL for the corresponding HARQ process in the first symbol after the expiry of drx-HARQ-RTT-TimerUL.

In an example, when the DRX operation is configured, if a DRX Command MAC CE or a Long DRX Command MAC CE is received, the MAC entity of the wireless device may stop the drx-onDurationTimer for each DRX group (e.g., the DRX group) and/or stop the DRX inactivity timer (e.g., drx-InactivityTimer) for each DRX group (e.g., the DRX group).

In an example, when the DRX operation is configured, if the drx-InactivityTimer for the DRX group expires, the MAC entity of the wireless device may start or restart the drx-ShortCycleTimer for the DRX group in the first symbol after the expiry of the drx-InactivityTimer and/or use the Short DRX cycle for the DRX group, if the Short DRX cycle is configured. If the drx-InactivityTimer for the DRX group expires, the MAC entity of the wireless device may use the Long DRX cycle for the DRX group, if the Short DRX cycle is not configured.

In an example, when the DRX operation is configured, if a DRX Command MAC CE is received, the MAC entity of the wireless device may start or restart the drx-ShortCycleTimer for each DRX group (including the DRX group) in the first symbol after the end of the DRX Command MAC CE reception and/or use the Short DRX cycle for each DRX group (including the DRX group), if the Short DRX cycle is configured. If the DRX Command MAC CE is received, the MAC entity of the wireless device may use the Long DRX cycle for the DRX group, if the Short DRX cycle is not configured.

In an example, when the DRX operation is configured, if the drx-ShortCycleTimer for the DRX group expires, the MAC entity of the wireless device may use the Long DRX cycle for the DRX group. If the Long DRX Command MAC CE is received, the MAC entity of the wireless device may stop the drx-ShortCycleTimer for each DRX group (e.g., including the DRX group) and/or use the Long DRX cycle for each DRX group (e.g., including the DRX group).

In an example, when the DRX operation is configured, if the DRX group is in the active time (or the DRX active state), the MAC entity of the wireless device may monitor PDCCH for the at least one RNTI on the Serving Cells (e.g., the serving cell) in the DRX group. If the PDCCH indicates a DL transmission, the MAC entity of the wireless device may start the drx-HARQ-RTT-TimerDL for the corresponding HARQ process in the first symbol after the end of the corresponding transmission carrying the DL HARQ feedback and/or stop the drx-RetransmissionTimerDL for the corresponding HARQ process. The MAC entity may start the drx-RetransmissionTimerDL in the first symbol after the PDSCH transmission for the corresponding HARQ process if the PDSCH-to-HARQ_feedback timing indicates a non-numerical kl value. When HARQ feedback is postponed by PDSCH-to-HARQ_feedback timing indicating a non-numerical kl value, the corresponding transmission opportunity to send the DL HARQ feedback is indicated in a later PDCCH requesting the HARQ-ACK feedback.

In an example, if the PDCCH indicates a UL transmission, the MAC entity may start the drx-HARQ-RTT-TimerUL for the corresponding HARQ process in the first symbol after the end of the first transmission (within a bundle) of the corresponding PUSCH transmission and/or stop the drx-RetransmissionTimerUL for the corresponding HARQ process.

In an example, if the PDCCH indicates a new transmission (DL or UL) on the serving cell in the DRX group, the MAC entity may start or restart the DRX inactivity timer (e.g., drx-InactivityTimer) for the DRX group in the first symbol after the end of the PDCCH reception. If a HARQ process receives downlink feedback information and acknowledgement is indicated, the MAC entity may stop the drx-RetransmissionTimerUL for the corresponding HARQ process.

In an example, when DRX operation is configured, if the Short DRX cycle is used for the DRX group, and [(SFN×10)+subframe number] modulo (drx-ShortCycle)=(drx-StartOffset) modulo (drx-ShortCycle), the MAC entity of the wireless device may start drx-onDurationTimer for the DRX group after drx-SlotOffset from the beginning of the subframe.

In an example, the one or more configuration parameters may comprise one or more power saving configuration parameters (e.g., DCP-Config-r16). For example, the one or more power saving configuration parameters may configure a wakeup duration/occasion (or at least one power saving occasion). For example, the one or more power saving configuration parameters may configure the wireless device for monitoring PDCCH addressed to the PS-RNTI corresponding to the at least power saving occasion. For example, the one or more power saving configuration parameters may indicate to the wireless device the PS-RNTI (e.g., ps-RNTI) for detecting a DCI format 2_6. The DCI format 2_6 may be with/having CRC scrambled by the PS-RNTI (DCP). For example, the one or more power saving configuration parameters may configure the wireless device to monitor at least one DCP occasion in the active DL BWP, e.g., to monitor the at least one power saving occasion. The one or more configuration parameters may indicate/configure a number of search space sets (e.g., by dci-Format2-6 in SearchSpace) for monitoring the PDCCH addressed to the PS-RNTI. When the DCP monitoring is configured in the active DL BWP, the wireless device may monitor the PDCCH for detection of the DCI format 2_6 on the active DL BWP according to a common search space (CSS) in the at least one DCP occasion. For example, the DCP-Config-r16 may indicate a location in DCI format 2_6 of a wake-up indication bit by ps-PositionDCI-2-6. For example, the wake-up indication bit may correspond to the wireless device.

The at least one DCP occasion may be located at a number of slots (or symbols) before the DRX on duration of a DRX cycle. For example, the one or more power saving occasion may indicate an offset (e.g., by ps-Offset) that indicates a time, where the wireless device may start monitoring the PDCCH for detection of DCI format 2_6 according to the number of search space sets, prior to a slot where the DRX on duration timer (e.g., drx-onDurationTimer) is expected to start on the PCell or on the SpCell. The number of slots (or symbols), referred to as a DCP gap between the at least one DCP occasion (e.g., a wakeup duration/occasion) and the DRX on duration, may be configured in the one or more power saving configuration parameters or predefined as a fixed value. The DCP gap may be used for at least one of: synchronization with the base station; measuring reference signals; and/or retuning RF parameters. The DCP gap may be determined based on a capability of the wireless device and/or the base station.

For example, based on a DCI format 2_6 being detected, the physical layer of the wireless device may report the value of the wake-up indication bit (a first value or a second value) for the wireless device to the higher layers (e.g., the MAC layer) for the next Long DRX cycle. For example, if the wireless device does not detect the DCI format 2_6, the physical layer of the wireless device may not report the value of the wake-up indication bit to the higher layers for the next Long DRX cycle.

When the wireless device is provided search space sets (e.g., by dci-Format2-6) to monitor the PDCCH for detection of the DCI format 2_6 in the active DL BWP, the physical layer of the wireless device may report a value of ‘1’ (or the first value) for the wake-up indication bit to the higher layers (e.g., the MAC layer) of the wireless device for the next Long DRX cycle. For example, in response to the wireless device not being required to monitor PDCCH for detection of the DCI format 2_6 for all corresponding PDCCH monitoring occasions outside the active time prior to a next Long DRX cycle, the physical layer of the wireless device may report the first value. In an example, based on the at least one DCP occasion not being outside the active time of the next long DRX cycle (e.g., the wireless device not having any PDCCH monitoring occasions for detection of the DCI format 2_6 outside the active time of the next long DRX cycle), the physical layer of the wireless device may report the first value.

In an example, the wireless device may not monitor the at least one DCP occasion (e.g., the PDCCH for detecting the DCI format 2_6) during the active time of the DRX operation (e.g., the active time for the serving cell in the DRX group). On PDCCH monitoring occasions associated with a same Long DRX cycle, the wireless device may not expect to detect more than one DCI format 2_6 with different values of the wake-up indication bit for the wireless device.

When the DCP monitoring is configured for the active DL BWP, the wireless device may monitor the wake-up signal during the wake-up duration/occasion, e.g., monitoring the at least one DCP occasion. In an example, when the DCP monitoring is configured for the active DL BWP, the lower layers (e.g., the physical layer) of the wireless device may send/report/transmit a DCP indication that indicates starting the DRX on duration timer for the next Long DRX cycle (e.g., staring the DRX on duration). In an example, the DCP indication may comprise/indicate the wake-up indication bit being set to the first value.

In an example, the first value for the wake-up indication bit, when reported to the higher layers of the wireless device, may indicate to start the DRX on duration timer (e.g., drx-onDuration Timer) for the next Long DRX cycle. When the wireless device receives the DCP indication that indicates starting the DRX on duration timer for the next Long DRX cycle (e.g., the wake-up indication bit indicating the first value), the wireless device may start the DRX on duration timer (e.g., switching to the DRX on duration) associated with the DRX operation after the drx-SlotOffset from the beginning of the subframe. In an example, if ps-Wakeup is configured with value true and the DCP indication associated with the current DRX cycle has not been received from lower layers (e.g., the physical layer), the wireless device may start the DRX on duration timer (e.g., switching to the DRX on duration) associated with the DRX operation after the drx-SlotOffset from the beginning of the subframe. For example, in response to receiving the DCP indication indicating starting the DRX on duration timer for the next Long DRX cycle, the wireless device may monitor the PDCCH for the at least one RNTI while/during the DRX on duration timer is running. When the DRX on duration timer expires (or the DRX switching to an off duration of the DRX operation), the wireless device may stop monitoring the PDCCH for the at least one RNTI.

In an example, the second value for the wake-up indication bit (e.g., ‘0’), when reported from the physical layer to the higher layers (e.g., the MAC layer) of the wireless device, may indicate to not start the DRX on duration timer (e.g., drx-onDurationTimer) for the next Long DRX cycle. For example, based on receiving the second value for the wake-up indication bit from the lower layers (e.g., the physical layer) of the wireless device, the wireless device may not start the DRX on duration timer for the next Long DRX cycle. For example, based on not receiving the DCP indication indicating starting the DRX on duration timer for the next Long DRX cycle at the MAC layer from the lower layers (e.g., the physical layer) of the wireless device, the wireless device may not start the DRX on duration timer for the next Long DRX cycle.

In an example, when the DRX operation is configured and [(SFN×10)+subframe number] modulo (drx-LongCycle)=drx-StartOffset, the Long DRX cycle may be used for the DRX group. In response to the DCP monitoring not being configured for the active DL BWP, the MAC entity of the wireless device may start the DRX on duration timer (e.g., drx-onDurationTimer) after the drx-SlotOffset from the beginning of the subframe. For example, in response to the DCP monitoring being configured for the active DL BWP and the DCP indication (associated with the current DRX cycle) indicating to start the drx-onDurationTimer (e.g., the first value of the wake-up indication bit) being received from the lower layers (e.g., the physical layer) of the wireless device, the MAC entity of the wireless device may start the DRX on duration timer after the drx-SlotOffset from the beginning of the subframe. For example, the MAC entity of the wireless device may start the drx-onDurationTimer after the drx-SlotOffset from the beginning of the subframe in response to the DCP monitoring being configured for the active DL BWP, the DCP monitoring being configured for the active DL BWP, the DCP indication to start the drx-onDurationTimer (e.g., the first value of the wake-up indication bit) associated with the current DRX cycle not being received from the lower layers (e.g., the physical layers) of the wireless device, and the ps-Wakeup being configured with value true.

In an example, when the DRX operation is configured, [(SFN×10)+subframe number] modulo (drx-LongCycle)=drx-StartOffset, and the DCP monitoring is configured for the active DL BWP, the Long DRX cycle may be used for the DRX group. For example, all DCP occasions in time domain (e.g., the at least one DCP occasion) in the current DRX cycle may occur in the active time considering grants/assignments/DRX Command MAC CE/Long DRX Command MAC CE received and the SR sent/transmitted until the predefined gap prior to the start of the last DCP occasion (e.g., from the at least one DCP occasion). In response to the all DCP occasions in time domain in the current DRX cycle being occurred in the active time, the MAC entity of the wireless device may start the DRX on duration timer (e.g., drx-onDurationTimer) after the drx-SlotOffset from the beginning of the subframe.

In an example, when the DRX operation is configured, [(SFN×10)+subframe number] modulo (drx-LongCycle)=drx-StartOffset, and the DCP monitoring is configured for the active DL BWP, the Long DRX cycle may be used for the DRX group. For example, all DCP occasions in time domain (e.g., the at least one DCP occasion) in the current DRX cycle may occur during a measurement gap. The MAC entity of the wireless device may start the drx-onDurationTimer after the drx-SlotOffset from the beginning of the subframe.

In an example, when the DRX operation is configured, [(SFN×10)+subframe number] modulo (drx-LongCycle)=drx-StartOffset, and the DCP monitoring is configured for the active DL BWP, the Long DRX cycle may be used for the DRX group. For example, all DCP occasions in time domain (e.g., the at least one DCP occasion) in the current DRX cycle may occur when the MAC entity monitors for a PDCCH transmission on the search space indicated by recoverySearchSpaceId of the SpCell identified by the C-RNTI while a ra-Response Window is running. According to an example, the MAC entity of the wireless device may start the drx-on Duration Timer after the drx-SlotOffset from the beginning of the subframe.

In an example, the wireless device may be configured (e.g., by the one or more RRC configuration parameters) to transmit at least one report in a current symbol n. For example, the at least one report may comprise the periodic CSI reporting on/using PUCCH and/or the semi-persistent CSI reporting on/using PUSCH. For example, the at least one report may comprise the periodic SRS and/or the semi-persistent SRS.

For example, when the DRX operation is configured and the DCP monitoring for the active DL BWP not being configured, the wireless device may determine whether to transmit the at least one report or not. In an example, the wireless device may not transmit the at least one report based on the current symbol n not being in the active time of the DRX group considering grants/assignments/DRX Command MAC CE/Long DRX Command MAC CE received or the SR sent/transmitted until the predefined gap prior to the current symbol n when the wireless device evaluates the one or more DRX active time conditions. For example, based on the current symbol n not being in the active time of the DRX group, the wireless device may not transmit the periodic SRS and/or the semi-persistent SRS. In an example, based on the current symbol n not being in the active time of the DRX group, the wireless device may not transmit the periodic CSI reporting on/using PUCCH and/or the semi-persistent CSI reporting on/using PUSCH.

For example, the current symbol n may occur within the DRX on duration timer. In an example, when the DRX operation is configured and the DCP monitoring for the active DL BWP not being configured, the wireless device may determine whether to transmit the periodic CSI reporting on/using PUCCH or not. For example, a CSI masking (e.g., csi-Mask) may be set up by the higher layers (e.g., the RRC layer). Before the DRX on duration timer starts, the wireless device may evaluate whether the DRX on duration timer is running or not at the current symbol n. In an example, the wireless device may not transmit the periodic CSI reporting on/using PUCCH in the DRX group based on the DRX on duration timer is not running considering grants/assignments/DRX Command MAC CE/Long DRX Command MAC CE received until the predefined gap prior to the current symbol n when the wireless device evaluates the one or more DRX active time conditions.

In an example, when the DRX operation is configured and the DCP monitoring for the active DL BWP being configured, the wireless device may determine whether to transmit a periodic CSI (e.g., that is L1-RSRP or that is not L1-RSRP) on PUCCH or not. For example, the current symbol n may occur during the DRX on duration timer. In an example, the wireless device may determine (prior to the start of the DRX on duration timer) to not transmit the periodic CSI that is L1-RSRP on PUCCH in response to determining: the one or more power saving configuration parameters configuring ps-TransmitPeriodicL1-RSRP with value true, the DRX on duration timer associated with the current DRX cycle not being started, the MAC entity of the wireless device not being in the active time of the DRX operation considering grants/assignments/DRX Command MAC CE/Long DRX Command MAC CE received and the SR sent/transmitted until the predefined gap prior to the symbol n when evaluating the one or more DRX active time conditions. In an example, the wireless device may determine (prior to the start of the DRX on duration timer) to not transmit the periodic CSI that is not L1-RSRP on PUCCH in response to determining: the one or more power saving configuration parameters not configuring ps-TransmitOtherPeriodicCSI with value true, the DRX on duration timer associated with the current DRX cycle not being started, the MAC entity of the wireless device not being in the active time of the DRX operation considering grants/assignments/DRX Command MAC CE/Long DRX Command MAC CE received and the SR sent/transmitted until the predefined gap prior to the symbol n when evaluating the one or more DRX active time conditions.

In an example, regardless of whether the MAC entity is monitoring PDCCH for the at least one RNTI or not on the Serving Cells (e.g., the serving cell) in the DRX group, the MAC entity may transmit HARQ feedback, aperiodic CSI on PUSCH, and aperiodic SRS on the Serving Cells (e.g., the serving cell) in the DRX group when such is expected. The MAC entity may not monitor the PDCCH for the at least one RNTI if it is not a complete PDCCH occasion (e.g. the active time starts or ends in the middle of a PDCCH occasion).

In an example, the wireless device may multiplex a CSI configured on PUCCH with other overlapping UCI(s). Based on the wireless device implementation, the CSI (multiplexed with other UCI(s)) may be reported on a PUCCH resource outside the DRX active time of the DRX group in which the PUCCH is configured. According to an example, if a CSI masking (e.g., csi-Mask) is setup by the higher layers (e.g., the RRC layer) of the wireless device, it is up to wireless device implementation whether to report the CSI outside the DRX on duration timer (e.g., drx-OnDurationTimer) of the DRX group in which the PUCCH is configured.

Extended reality (XR) may be referred to all real-and-virtual combined environments and human-machine interactions generated by computer technology and wearables. XR may be an umbrella term for different types of realities, e.g., Virtual reality (VR), Augmented reality (AR), Mixed reality (MR), and/or Cloud Gaming, and the like. XR application(s) may provide a sense of being surrounded by the virtual environment (e.g., Immersion) and/or a feeling of being physically and spatially located in the virtual environment (e.g., Presence). In some examples, the acronym XR may refer to equipment(s), application(s) and function(s) used for VR, AR, Cloud Gaming, and/or MR, e.g., to HMDs for VR, optical see-through glasses and camera sec-through HMDs for AR and MR and mobile devices with positional tracking and camera. An XR device may be a wireless device that run/use/perform one or more XR functions/applications/use cases (e.g., AR). For example, an XR device may be a wireless device that has XR equipment's to perform one or more XR services.

Some XR uses cases (e.g., Cloud Gaming and/or VR) may be characterized by quasi-periodic traffic, e.g., 45/60/90/120 frames per second (FPS), with possible jitter and/or a non-integer periodicity. For example, the frame rate for XR video varies from 30 frames per second up to 90 or even 120 frames per second, with a typical minimum of 60 for VR. In some other cases, a jitter may be up to couple of milliseconds (e.g., 4 ms, 8 ms, 10 ms, or higher, depending on application, network delay, and/or video coding standards). XR use cases may require high data rate in DL (e.g., for transmission of video steam and/or audio data) combined with the frequent UL data (i.e., pose/control update or pose Information) and/or UL video stream. Both DL and UL traffic are also characterized by relatively strict packet delay budget (PDB). For example, PDB of pose/control update may be around 4 ms. In some applications, PDB of DL/UL video steam may be 10 ms or 20 ms or 30 ms. For example, the latency of action of the angular or rotational vestibulo-ocular reflex is known to be of the order of 10 ms or in a range from 7-15 milliseconds. In another example, a motion-to-photon latency of less than 10-20 milliseconds may be required (e.g., the PDB of less than 10-20 ms).

The bit rates of XR use cases (or applications) may be between 10 and 200 Mbps, e.g., depending on frame rate, resolution and codec efficiency. In some applications, volume of DL/UL data (or bit rate) across traffic periods (or burst of data or data burst or PDU set) may change. For example, in a first traffic period (or burst of data) the volume of DL video stream may be a first value (e.g., 100 Mbyte) and in a second traffic period (or burst of data) the volume of DL video stream may be a second value (e.g., 50 Mbyte). Data burst may comprise a set of multiple PDUs (PDCP/RLC/MAC PDU) generated and sent by the application in a short period of time (e.g., within a traffic period). In some examples, a data burst may comprise one or multiple PDU Sets and/or one or more data packets (e.g., IP packets) and/or one or more bundles of PUSCHs/PDSCHs. The PDU Set (or PDU-Set or PDU set/bundle/collection) may comprise one or more PDUs carrying the payload of one unit of information generated at the application level (e.g., a frame or video slice for XRM Services). A PDU Set information (e.g., corresponding to a PDU) may indicate/comprise at least one of the following: a PDU Set Identifier; and/or a Start (or earliest/starting/initial) PDU and an End (or latest/final/ending) PDU of the PDU Set; and/or a PDU serial number (SN) of a PDU within the PDU Set; and/or a PDU Set size; and/or a PDU Set importance; and/or an End of Data Burst indication (e.g., indicating an end of the data burst).

In practice, the network (e.g., base station) and/or the wireless device may not be aware of (or accurately measure) instantaneous jitter value/range in advance and/or volume of UL/DL traffic (e.g., within each traffic period). In some implementations, the network (e.g., base station) and/or the wireless device may determine/measure via statistical measurements (and/or AI/ML methods) one or more statistics/characteristics (e.g., average, variance, probability density function, and the like) of the jitter and/or the volume of UL/DL data (or bit rate).

For example, a PDU Set related assistance information (e.g., provided via control plane to user plane of the wireless device and/or the base station) may define/indicate one or more assistance information corresponding to a PDU Set. The PDU Set information and/or the PDU Set related assistance information may allow an XR aware operation of RAN (e.g., user plane of the base station and/or the wireless device). In an example, the PDU Set related assistance information may comprise a PDU-Set QoS parameters and/or a burst (or XR data or data burst or PDU Set) periodicity, e.g., a periodicity of a quasi-periodic traffic, e.g., 45/60/90/120 FPS. A PDU-Set QoS parameters (e.g., provided via control plane to user plane of the wireless device and/or the base station) corresponding to a PDU Set may comprise at least one of the following a PDU-Set Delay Budget (PSDB); a PDU-Set Error Rate (PSER); and/or a PDU Set Integrated Indication (PSII). The PDU-Set Delay Budget (PSDB) of a PDU Set may indicate/define/measure delay of the PDU Set (or PDU-Set) between a wireless device and an N6 termination point at the UPF. For a certain 5QI the value of the PSDB is the same in UL and DL. In the case of 3GPP access, the PSDB may be used to support the configuration of scheduling and link layer functions (e.g., the setting of scheduling priority weights and HARQ target operating points). For example, when a PDU-Set is delayed more than the PSDB, the PDU-Set may be considered/determined as lost (e.g., if the corresponding QoS Flow is not exceeding the GFBR and/or for GBR QOS Flows using the Delay-critical resource type). In some implementations, the PSDB of a PDU Set may depend on a PDB of a PDU of the PDU Set (e.g., smallest/largest PDB or the like).

A PDU-Set Error Rate (PSER) of a PDU Set may define/indicate an upper bound for an error rate of the PDU-Set. For example, an upper layer (e.g., the RLC/PDCP/SDAP layer) of a sender (e.g., the base station and/or the wireless device) may process a PDU-Set to determine whether all of the PDUs in the PDU-Set are successfully delivered by the corresponding receiver to the upper layers (e.g., the PDCP/RLC/SDAP layer).

The PDU Set Integrated Indication (PSII) of a PDU Set may define/indicate/measure whether all PDUs of the PDU Set are needed for the usage of PDU Set by application layer. In some implementations all PDUs in a PDU Set are needed by the application layer to use the corresponding unit of information. In other implementations, the application layer can still recover parts all or of the information unit, when some PDUs of the PDU set are missing. For example, a PDU sets may comprise one or more data packets (e.g., IP packets) or may correspond to a higher layer SDU/PDU (e.g., the PDCP/RLC/SDAP/MAC layer).

For example, there may be different methods/procedures/alternatives to map PDU sets onto QoS flows (e.g., in the NAS) and/or to map the QoS flows onto DRBs (e.g., in the AS), e.g., one-to-one mapping between types of PDU sets and QoS flows in the NAS and one-to-one mapping between QoS flows and DRBs in the AS; or one-to-one mapping between types of PDU sets and QoS flows in the NAS and multiplexing of QOS flows in one DRB in the AS; and/or a multiplexing of PDU sets in one QoS flow in the NAS and one-to-one mapping between QoS flows and DRBs in the AS; or N multiplexing of PDU sets in one QoS flow in the NAS and demultiplexing of PDU sets from one QoS flow on multiple DRBs in the AS. In some examples, the wireless device and/or the base station may map one or more PDU Sets in DRBs to logical channels, e.g., 1-to-1 mapping where the PDCP layer maps the one or more PDU Sets to one logical channel or 1-to-many where the PDCP layer maps the one or more PDU Sets to one or more logical channels. Traffic jitter information (e.g., jitter range/value) may be associated with a periodicity of a QoS flow (or a PDU Set).

A base station may configure a wireless device with DRX operation (e.g., via the one or more DRX configuration parameters), e.g., to reduce consumed power of the wireless device for PDCCH monitoring. XR traffic/data, in XR applications (e.g., when the wireless device is an XR device), may be characterized based on at least one of the following: 1) there may be an uncertainty in arrival time of data (e.g., XR packets/PDU-Sets/data bursts, e.g., because of jitter between PDU-Sets/data bursts or across PDUs of a PDU-Set; and/or 2) there may be an uncertainty in a PDU Set size/data burst size (e.g., a size/volume of a first PDU Set/data burst transmitted during a first period may be different than a size/volume of second PDU Set/data burst transmitted during the second period); and/or 3) an XR traffic may comprise multiple streams/QoS flows/logical channels, e.g., with different data burst periodicities and/or delay budgets. For example, in XR applications, the base station may configure the length of a DRX on duration timer (ODT) of a DRX configuration based on (average/estimated/expected) jitter range/value (e.g., 10 ms) and (average/estimated/expected) duration for transmission of a data burst/PDU Set, e.g., the length of the DRX ODT may be larger than the (average/estimated) jitter range/value.

Based on existing technologies, the wireless device may determine a DRX active time (of the DRX operation) based on the DRX ODT of the DRX configuration running. For example, during the DRX active time the wireless device may receive at least one channel state information (CSI) measurement (e.g., CSI channel measurement or CSI interference measurement, e.g., for channel/interference measurement and/or for mobility) and/or transmit/send/report a report (e.g., a CSI report or an SRS report) and/or avoid/skip monitoring the DCP (e.g., power-saving) occasions. The one or more configuration parameters (e.g., the one or more SRS configuration parameters and/or the one or more CSI configuration parameters) may configure (or indicate to) the wireless device to transmit the report at the first symbol (or the first time). In an example, the report may be at least one of: the periodic SRS, the semi-persistent SRS, the periodic CSI reporting on/using PUCCH, or the semi-persistent CSI reporting on/using PUSCH.

In existing technologies, e.g., in XR applications, when the wireless device is configured with a DRX operation (e.g., via the one or more DRX configuration parameters), the wireless device may, for transmitting the report or monitoring DCP occasions at a first symbol, determine whether the first symbol is in/within a DRX active time (of the DRX operation) or not. The wireless device may, based on the first symbol being in the DRX active time, transmit the report (or not monitor the DCP occasions) at the first symbol. For determining whether the first symbol is in the DRX active time or not, the wireless device may evaluate the one or more DRX active time conditions. For example, for evaluating the one or more DRX active time conditions the wireless device may consider at least one of: whether an UL grant (or UL grants) or a DL assignment (or DL assignments) is received until the predefined gap prior to the first symbol, whether a (Long) DRX command MAC CE is received until the predefined gap prior to the first symbol, or whether a scheduling request (SR) on PUCCH is sent/transmitted until the predefined gap prior to the first symbol. In XR applications, when XR packets/PDU-Sets arrive with delay (e.g., no PDU of a PDU Set being received during a DRX ODT is running) and/or there is a jitter between PDUs of a PDU-Set (e.g., one or more PDUs of a PDU Set not being received while the DRX ODT is running) and/or early, e.g., when all PDUs of a PDU Set are received while a DRX ODT is running, there may be misalignment between the wireless device and the base station for transmitting the report (or monitoring the DCP occasions). Based on existing technologies, the wireless device may unnecessarily transmit the report (e.g., increasing consumed power of the wireless device) and/or mistakenly drop the report (e.g., reducing UL/DL beam management and/or power control). Based on existing technologies, the wireless device may unnecessarily monitor the DCP occasions (e.g., unnecessarily waking up, resulting in the wireless device increasing power consumption) and/or mistakenly not monitor the DCP occasions (e.g., not waking up, thereby increasing UL/DL delay). Based on existing technologies, in XR applications, when the (average/estimated) jitter range/value is large (e.g., larger than 4 ms or around 10 ms) and/or periodicity of XR packet is short (e.g., 60/90/120 frames per second (FPS)), the DRX operation may have limited/vanishing impact on reducing the consumed power of the wireless device (e.g., for performing CSI measurements and/or transmitting the report and/or monitoring the DCP occasions).

For XR services/applications, considering improvements in DRX operation (e.g., for CSI measurements and/or transmitting a CSI-RS/SRS report and/or monitoring the DCP occasions) may reduce consumed power of the wireless device and/or reduce UL/DL delay (e.g., improving UL/DL beam management).

According to example embodiments of the present disclosure, the wireless device may determine a first occasion of at least one occasion being outside of a discontinuous reception (DRX) active time, e.g., based on receiving a packet data unit (PDU) Set, comprising a plurality of PDUs, until/at least an offset (e.g., until/at least 4 ms) prior to the first occasion of the at least one occasion. For example, the first occasion may be at least the offset after/from the receiving the PDU Set at the wireless device. The wireless device may determine the first occasion being at least the offset after/from an occasion/time that the PDU Set is received. In some cases, the wireless device may refrain from transmitting the report via the first occasion of the at least one occasion. In some examples, the one or more configuration parameters may indicate the at least one occasion/resource for transmission of the report. The wireless device may determine while the DRX on-duration timer (ODT) is running that the PDU Set is being received (e.g., until the offset prior to the first occasion) based on at least one of: all PDUs of the plurality of PDUs of the PDU Set being received; and/or an End PDU of the PDU Set is received or is being received, where the End PDU of the PDU Set is a last/final PDU of the PDU set; and/or an end of data burst indication being received. In some examples, the wireless device may determine an early stopping condition of the DRX ODT being satisfied, e.g., until/at least the offset (e.g., until/at least 4 ms) prior to the first occasion of the at least one occasion. For example, at least the offset (e.g., at least 4 ms) prior to the first occasion the early stopping condition of the DRX ODT being satisfied. For example, the wireless device may determine the first occasion being at least the offset after/from an occasion/time that the early stopping condition of the DRX ODT is satisfied. In some implementations, in response to the early stopping condition of the DRX on-duration timer being satisfied, the wireless device may stop the DRX ODT.

In an example embodiment, the wireless device may determine the early stopping condition of the DRX ODT of the first DRX configuration being satisfied based on at least one of: (fully/entirely) receiving the PDU Set, e.g., all PDUs of the plurality of PDUs of the PDU Set being (correctly/successfully) received/decoded; and/or receiving the End PDU of the PDU Set; and/or receiving the End of Data Burst indication; and/or a number of received PDUs of the PDU Set being larger than a pre-configured threshold (e.g., configured by the one or more configuration parameters); and/or expiry of a DRX inactivity timer (IAT) of the first DRX configuration.

In an example embodiment, while the DRX ODT is running, the wireless device may skip PDCCH monitoring (e.g., on a DL BWP of a serving cell) in response to the early stopping condition of the DRX ODT being satisfied. The wireless device may drop the report via the first occasion of the at least one occasion when the first occasion of the at least one occasion occurs within a duration of the PDCCH skipping. The wireless device may, for example, transmit the report via the first occasion of the at least one occasion when the first occasion of the at least one occasion does not occur during a duration of the PDCCH skipping.

In an example embodiment, the wireless device may, when the DRX ODT is running, determine to avoid/skip transmitting (or not transmit or refrain from transmitting) the report via/using the first occasion of the at least one occasion. The wireless device may determine the first occasion of the at least one occasion does not occur during or is not within a PDCCH skipping duration. For example, the wireless device may determine the PDCCH skipping condition being satisfied until/at least the offset (e.g., until/at least 4 ms) prior to the first occasion of the at least one occasion (e.g., based on the early stopping condition of the DRX ODT being satisfied until the offset prior to the first occasion of the at least one occasion). At least the offset (e.g., at least 4 ms) before the first occasion the PDCCH skipping condition is satisfied. For example, the wireless device may determine a DCI indicating the PDCCH skipping being received until/at least the offset (e.g., until, up to, at least 4 ms) prior to the first occasion of the at least one occasion.

In an example embodiment, the wireless device may transmit the report via a second occasion of the at least one occasion based on determining the second occasion of the at least one occasion being within the DRX active time. For example, when the DRX ODT is running, the wireless device may determine the PDU Set being partially received until/at least the offset (e.g., until, up to, at least 4 ms) prior to the second occasion of the at least one occasion. For example, the wireless device may determine that (at least) the offset (e.g., at least 4 ms) before the second occasion the PDU Set being partially received. The wireless device may determine the PDU Set being partially received based on at least one of: at least one PDU of the PDU Set not being received; an End PDU of the PDU Set not being received, where the End PDU of the PDU Set is a last/final PDU of the PDU set; or an end of data burst indication not being received. For example, the wireless device may determine at least one PDU of the PDU Set is not received before the offset that occurs prior to a first occasion of the at least one occasion (e.g., received during the offset). In some examples, the wireless device may restart the DRX ODT of the DRX configuration during a DRX cycle. In some examples, the wireless device may extend the DRX active time during the DRX cycle. In some examples, the wireless device may start a second DRX ODT of the DRX configuration during the DRX cycle.

In an example embodiment, the wireless device may transmit the report via a second occasion of the at least one occasion based on determining the second occasion of the at least one occasion being within the DRX active time. For example, when the DRX ODT is running, the wireless device may determine no PDU of the PDU Set being received until the offset prior to the second occasion of the at least one occasion. For example, the wireless device may restart the DRX ODT of the DRX configuration during a DRX cycle. In another example, the wireless device may extend the DRX active time during the DRX cycle. In yet another example, the wireless device may start a second DRX ODT of the DRX configuration during the DRX cycle.

Some example embodiments may improve the DRX operation (e.g., by considering the early stopping of the DRX ODT), e.g., for reducing the PDCCH monitoring power/processing, and/or reducing possibility of unnecessarily transmitting the report (e.g., via the second resource/occasion of the at least one resource/occasion).

In an example embodiment, the one or more configuration parameters may indicate one or more power saving occasions (e.g., DCP monitoring occasions). For example, the wireless device may receive, during a discontinuous reception (DRX) active time, the PDU Set. The wireless device may determine a first occasion of the one or more power saving occasions being outside of the DRX active time based on the PDU Set being received until an offset (e.g., 4 ms) prior to the first occasion of one or more power saving occasions. In an example embodiment, the wireless device may monitor downlink control channels during at least one occasion of the one or more power saving occasions.

In an example embodiment, the wireless device may determine the one or more power saving occasions being in a discontinuous reception (DRX) active time based on partially receiving a packet data unit (PDU) Set until the offset prior to a start/beginning (symbol/slot) of a last/final/ending/latest power saving occasion of the one or more power saving occasions. For example, the wireless device may not monitor (e.g., skip/avoid monitoring) PDCCH during/using at least one occasion (e.g., all occasions) of the one or more power saving occasions.

In an example embodiment, the wireless device may avoid/skip/refuse monitoring the PDCCH during the one or more power saving occasions based on determining a start/beginning of the last/final/ending/latest occasion of the one or more power saving occasions being within/during/in the DRX active time. The wireless device may, for example, determine no PDU of the PDU Set being received until the offset prior to start/beginning of the last/final/ending/latest occasion of the one or more power saving occasions.

Some example embodiments may improve consumed power of the wireless device by reducing PDCCH processing power (e.g., not waking up unnecessarily). Example embodiments may reduce possibility of unnecessarily monitoring the DCP occasions, e.g., when arrival of PDU set is uncertain (due to jitter).

In XR applications (e.g., considering characteristics of the XR traffic), the legacy/existing DRX operation (e.g., a single DRX configuration, e.g., with a single DRX on duration timer (ODT)) may not necessarily reduce consumed power of the wireless device, e.g., for monitoring the PDCCH. For XR applications and to flexibly accommodate XR traffic (e.g., with jitter), the base station may configure (e.g., via the one or more DRX configuration parameters) the wireless device (e.g., when the wireless device is an XR device) with at least two DRX configurations (e.g., each with a corresponding DRX ODT and/or each with a corresponding DRX cycle), e.g., per a DRX group. For example, when the XR traffic/data comprises two streams/QoS flows with different data burst periodicity (e.g., a first stream/QoS flow with a 4 ms periodicity and a second stream/QoS flow with a 16.67 ms periodicity), configuring a wireless device with the at least two DRX configurations may reduce the consumed power of the wireless device for monitoring the PDCCH. In another example, a DRX configuration of a DRX group may comprise two DRX ODTs, e.g., a DRX outer/outside/external/exterior/outermost ODT and a DRX inner/interior/inmost/inside/innermost ODT. When the two DRX ODTs (e.g., the DRX outer ODT and the DRX inner ODT) of the DRX configuration are running, the wireless device may monitor the PDCCH. For example, when (absolute) jitter range/value is large (e.g., absolute value/amount is larger than 4 ms or around 10 ms), configuring the wireless device with a DRX configuration comprising the two DRX ODTs may reduce the consumed power of the wireless device for monitoring the PDCCH.

In existing technologies, when the base station configures a single DRX configuration with a single DRX ODT, the wireless device may determine a DRX active time (of the DRX operation) based on the DRX ODT is running. For example, during the DRX active time the wireless device may receive the at least one channel state information (CSI) measurement and/or transmit/send the report (e.g., the CSI report or the SRS report). Based on existing technologies, when the one or more DRX configuration parameters configures the at least two DRX ODT (per a DRX group or for the DRX operation) and/or when the DRX configuration comprises the two DRX ODTs (per a DRX group or for the DRX operation), there may be a misalignment between the wireless device and the base station regarding performing radio link monitoring and/or measuring/evaluating SSB (e.g., measuring the SS-RSRP and SS-RSRQ level of the serving cell). For example, the wireless device may unnecessarily evaluate/assess quality of DL radio link, e.g., to perform radio link monitoring/recovery procedures. Based on existing technologies, consumed power of the wireless device for performing the CSI/SSB measurements and/or transmitting the report and/or performing radio link monitoring (RLM) and/or performing radio link recovery (RLR) may increase, e.g., when the wireless device unnecessarily/frequently evaluate/asses the quality of the DL radio link for one or more RS (e.g., SSB/CSI-RS) resources, e.g., during a window. Based on existing technologies, performance of RLM/RLR procedures may decline (e.g., latency in performing link recovery procedure may increase) when the wireless device for performing RLM and/or performing RLR miss evaluating/assessing the quality of the DL radio link for one or more RS (e.g., SSB/CSI-RS) resources, e.g., during a window.

For XR services, improvements in DRX operation and/or CSI/SSB measurements (e.g., for mobility procedure, and/or RLM/RLR procedures), and/or transmitting the CSI-RS/SRS report may reduce consumed power of the wireless device, reduce UL/DL delay (e.g., improving UL/DL beam management and/or cell switching), and/or improve performance of radio link monitoring.

According to example embodiments of the present disclosure, the one or more configuration parameters may configure/indicate one or more discontinuous reception (DRX) configuration parameters configuring at least two DRX ODTs per/for a DRX group and/or one or more channel state information (CSI) configuration parameters configuring one or more CSI measurement/transmission occasions. For example, the wireless device may, based on a first CSI measurement/transmission occasion being within a DRX active time, receive the first CSI measurement/transmission occasion of the one or more CSI measurement/transmission occasions. In an example embodiment, the DRX active time is when at least one DRX ODT of the at least two DRX ODTs is running. For example, based on the first CSI measurement occasion of the one or more CSI measurement occasions being within the DRX active time, the wireless device may transmit the report (e.g., a CSI report of the first CSI measurement occasion). The wireless device may determine the first CSI measurement occasion is a most recent CSI measurement of the one or more CSI measurement occasions. The wireless device may, for example, determine the first CSI measurement occasion being no later than a CSI reference resource. In an example, in response to the first CSI measurement occasion being later than the CSI reference resource, the wireless device may drop (e.g., not transmit or skip transmitting) the report.

In one example, corresponding to a DRX configuration, a first DRX ODT of the at least two DRX ODTs may correspond to the DRX outer ODT of the DRX configuration and a second DRX ODT of the at least two DRX ODTs may correspond to the DRX inner ODT of the DRX configuration. In an example embodiment, the DRX active time is when both the first DRX ODT of the at least two DRX ODTs is running and the second DRX ODT of the at least two DRX ODTs is running. In an example embodiment, the DRX active time is when the first DRX ODT of the at least two DRX ODTs is running (e.g., the second DRX ODT of the at least two DRX ODTs may not be running). For example, the wireless device may determine the DRX active time by considering at least one of the following: a length of the first DRX ODT of the at least two DRX ODTs; and/or a length of the second DRX ODT of the at least two DRX ODTs; and/or a first DRX cycle of the DRX configuration, where the first DRX cycle corresponds to an outer DRX cycle and the first DRX ODT starts at a beginning of the first DRX cycle; and/or a second DRX cycle of the DRX configuration, where the second DRX cycle corresponds to an inner DRX cycle and the second DRX ODT starts at a beginning of the second DRX cycle.

In another example, the one or more DRX configuration parameters may configure at least two DRX configurations per the DRX group. For example, each DRX ODT of the at least two DRX ODTs may correspond to each DRX configuration of the at least two DRX configurations. In an example embodiment, the DRX active time is when a DRX ODT at least of a DRX configuration is running, where the DRX configuration is determined based on at least one of the following: the DRX configuration corresponding to a minimum DRX ODT length; and/or the DRX configuration corresponding to a maximum DRX ODT length; and/or the DRX configuration corresponding to a minimum DRX cycle length; and/or the DRX configuration corresponding to a maximum DRX cycle length. In an example embodiment, the DRX configuration may be an activated DRX configuration (e.g., based on receiving inactivation command from the base station). In an example embodiment, the one or more configuration parameters configures the DRX configuration of the at least two DRX configurations for CSI measurement.

Some example embodiments may allow balancing consumed power of the wireless device for CSI channel/interference measurement and/or UL/DL spectral efficiency (and/or UL/DL beam management and/or mobility). Some example embodiments may allow balancing consumed power of the wireless device for reporting the SRS/CSI-RS report and/or UL/DL spectral efficiency (and/or UL/DL beam management and/or mobility).

In an example embodiment, the wireless device may determine an evaluation period (e.g., TEvaluate_out_SSB and/or TEvaluate_out_SSB_Relax and/or TEvaluate_out_CSI-RS and/or TEvaluate_out_CSI-RS_Relax and/or TEvaluate_out_SSB,CCA and/or TEvaluate_out_SSB, RedCap and/or TEvaluate_out_CSI-RS, RedCap and/or TEvaluate_in_SSB and/or TEvaluate_in_SSB_Relax and/or TEvaluate_in_CSI-RS and/or TEvaluate_in_CSI-RS_Relax and/or TEvaluate_in_SSB,CCA and/or TEvaluate_in_SSB,RedCap and/or TEvaluate_in_CSI-RS,RedCap or the like) based on at least one DRX cycle of the at least two DRX configurations. For example, the wireless device may monitor, within/during the determined evaluation period, downlink radio link quality using at least one RS of one or more RS resources to determine whether the downlink radio link quality being worse than a first threshold (e.g., Qout and/or Qout,LR and/or Qout_SSB and/or Qout_CSI-RS and/or Qout, RedCap and/or Qout,CCA and/or Qout_SSB,CCA or the like) or better than a second threshold (e.g., Qin and/or Qin,LR and/or Qin_SSB and/or Qin_CSI-RS and/or Qin,CCA and/or Qin_SSB,CCA and/or Qin, RedCap or the like). The one or more configuration parameters may comprise/indicate the one or more reference signal (RS) resources for monitoring downlink radio link quality for performing a radio link monitoring procedure and/or a radio link recovery procedure. For example, the evaluation period may be based on a minimum/smallest DRX cycle length of the at least two DRX configurations. In an example, the evaluation period may be based on a maximum/largest DRX cycle length of the at least two DRX configurations. In another example, the evaluation period is based on a DRX cycle length of a default/designated/activated DRX configuration of the at least two DRX configuration.

In an example embodiment, the wireless device may determine an indication interval (e.g., TIndication_interval and/or TIndication_interval_BFD and/or TIndication_interval,CCA and/or TIndication_interval, RedCap) based on the at least one DRX cycle of the at least two DRX configurations. For example, the wireless device may determine the downlink radio link quality being worse than the first threshold. In one example, the wireless device may send a first out-of-sync indication to a higher layer (e.g., RRC/MAC layer) of the wireless device and send a second out-of-sync indication, at least the indication interval after sending the first out-of-sync indication to the higher layer of the wireless device, to the higher layer of the wireless device. In another example, the wireless device may send a first beam failure indication to a higher layer (e.g., RRC/MAC layer) of the wireless device and send a second beam failure instance indication, at least the indication interval after sending the first beam failure instance indication to the higher layer of the wireless device, to the higher layer of the wireless device. For example, the wireless device may determine the downlink radio link quality being better than the second threshold. The wireless device may send a first in-sync indication to a higher layer (e.g., RRC/MAC layer) of the wireless device and send a second in-sync indication, at least the indication interval after sending the first in-sync indication to the higher layer of the wireless device, to the higher layer of the wireless device.

In an example embodiment, the wireless device may activate a first DRX configuration of the at least two DRX configurations and monitor, within/during a first evaluation period, downlink radio link quality using at least one RS of one or more RS resources. For example, the wireless device may determine the first evaluation period based on a first DRX cycle of the first DRX configuration. In response to receiving an activation command indicating a second DRX configuration of the at least two DRX configurations, the wireless device may determine a second evaluation period based on a second DRX cycle of the second DRX configuration and a third evaluation period based on a minimum of the first evaluation period and the second evaluation period. In an example embodiment, in response to activating the second DRX configuration, the wireless device may monitor the downlink radio link quality during a duration equal to the third evaluation period. For example, after the third duration from activating the second DRX configuration, wireless device may monitor the downlink radio link quality during the second evaluation period.

Example embodiments may allow the wireless device to properly determine the evaluation period and/or the indication interval, e.g., based on the determined DRX cycle length, for RLM/RLR procedures. Example embodiments may balance consumed power of the wireless device with respect to a performance of the RLM/RLR procedures.

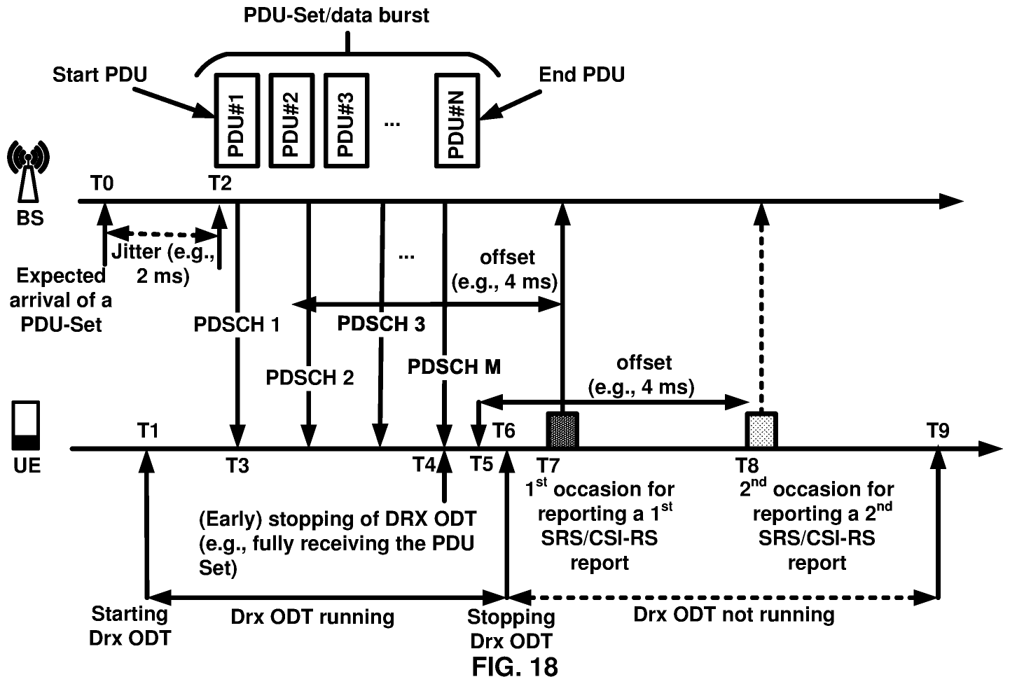

FIG. 18 shows an example embodiment of a DRX operation in wireless communications systems per an aspect of the present disclosure. For example, FIG. 18 may show example implementations of the method/procedure for transmitting a report (e.g., a CSI/SRS report) at the wireless device (e.g., an XR device) and/or receiving the report at the base station. In some scenarios, FIG. 18 may show example embodiments for determining whether the wireless device being in a DRX active time of a DRX operation or not (e.g., considering one or more characteristics of XR data/traffic, e.g., a PDU Set assistance information). In some scenarios, FIG. 18 may show example embodiments for determining whether to transmit the report or not (e.g., considering one or more characteristics of XR data/traffic, e.g., a PDU Set assistance information). In some other scenarios, FIG. 18 may show a procedure for early stopping of a DRX ODT of a DRX configuration (e.g., based on a PDU Set assistance information). For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

The wireless device may, from the base station, receive the one or more configuration parameters (e.g., the one or more RRC configuration parameters). The one or more configuration parameters may, for example, comprise one or more serving cell (e.g., the one or more Serving Cells or the one or more cells) configuration parameters (e.g., ServingCellConfigCommon, ServingCellConfigCommonSIB, and/or ServingCellConfig) for configuring one or more cells (e.g., one or more serving cells, e.g., the one or more Serving Cells). For example, the one or more cells may comprise a master (or primary) cell group (MSG) and/or a secondary cell group (SCG). In some cases, a cell of the one or more cells may be a primary secondary cell (PSCell), or a primary cell (PCell), or a secondary cell (SCell), or a special cell (SpCell). In some other cases, a cell of the one or more cells may belong to a first cell group corresponding to a primary TAG (pTAG) or a second cell group corresponding to a secondary TAG (sTAG). For example, the one or more configuration parameters may configure the wireless device for multi-cell communication and/or carrier aggregation (CA).

The one or more configuration parameters (e.g., the one or more RRC configuration parameters) may comprise one or more BWP configuration parameters (e.g., BWP-DownlinkDedicated IE), e.g., of a downlink (DL) BWP (e.g., initial downlink BWP) of a serving cell and/or of an UL BWP of the serving cell. The one or more WBP configuration parameters (e.g., of the downlink BWP) may comprise: one or more PDCCH configuration parameters (e.g., for PDCCH of the downlink BWP, e.g., in pdcch-Config IE and/or PDCCH-ServingCellConfig 1E applicable for all downlink BWPs of the serving cell).

The one or more configuration parameters (e.g., received from the base station) may comprise the one or more DRX configuration parameters. For example, the one or more DRX configuration parameters may configure at least one DRX configuration (e.g., multiple DRX configurations), e.g., per a DRX group. For example, the at least one DRX configuration may comprise a first DRX configuration.

In an example, the one or more configuration parameters may indicate/comprise configurations for transmitting/sending a report. The one or more configuration parameters may, for example, indicate at least one occasion/resource for transmission of the report. The configurations to transmit the report may comprise at least the one or more SRS configuration parameters and/or the one or more CSI configuration parameters. The report may be at least one of the following: the periodic CSI reporting on/using an uplink channel (e.g., PUCCH, PUSCH), the semi-persistent CSI reporting on/using an uplink channel (e.g., PUCCH, PUSCH), the periodic SRS, or the semi-persistent SRS.

As shown in FIG. 18, a resource/occasion of the at least one resource/occasion may correspond to a symbol or a set of symbols (e.g., of/at/on DL frame/configuration of the wireless device), e.g., the configurations to transmit the report may configure the wireless device to transmit the report at/on/during/via the symbol. In an example, the wireless device may determine the symbol based on the one or more SRS configuration parameters and/or the one or more CSI configuration parameters. The one or more SRS configuration parameters and/or the one or more CSI configuration parameters may indicate, for example, a time slot, a slot offset, a symbol duration, etc. The symbol may correspond to a time and/or a resource and/or a duration/occasion of the resource/occasion of the at least one resource/occasion. For example, a first occasion/resource of the at least one resource/occasion may correspond to a first (time) duration/symbol/slot (e.g., time T7 in FIG. 18). For example, a second occasion/resource of the at least one resource/occasion may correspond to a second (time) duration/symbol/slot (e.g., time T8 in FIG. 18).

The wireless device may determine whether to transmit the report via/using a resource/occasion of the at least one resource/occasion (e.g., the first resource/occasion of the at least one resource/occasion and/or the second resource/occasion of the at least one resource/occasion) or not. As shown in FIG. 18, the wireless device may determine to transmit the report via/using the first resource/occasion of the at least one resource/occasion. The wireless device may determine to avoid/skip transmitting (or not transmit or refrain from transmitting) the report via/using the second resource/occasion of the at least one resource/occasion.

The wireless device may, to determine whether to transmit the report via/using a resource/occasion of the at least one resource/occasion, determine whether the occasion/resource of the at least one occasion/resource being outside of a DRX active time (e.g., corresponding to the first DRX configuration or of a DRX operation) or being within/in the DRX active time. The wireless device may determine whether the one or more DRX active time conditions being satisfied or not. In an example of FIG. 18, the wireless device may determine the first occasion/resource of the at least one occasion/resource being inside of (or within/in) the DRX active time (e.g., based on the one or more DRX active time conditions being satisfied). The wireless device may determine the second occasion/resource of the at least one occasion/resource being outside of (or not being inside of) the DRX active time (e.g., based on the one or more DRX active time conditions not being satisfied).

For example, the wireless device may, an offset (e.g., a predefined gap, e.g., 4 ms) prior to the resource/occasion of the at least one resource/occasion, determine whether the resource/occasion of the at least one resource/occasion being outside of a DRX active time (e.g., corresponding to the first DRX configuration or of a DRX operation) or being within/in the DRX active time. As shown in FIG. 18, the wireless device may determine at time/occasion T5 (e.g., at least the offset prior to the second occasion/resource of the at least one occasion/resource) that the second occasion/resource of the at least one occasion/resource being outside of (or not being inside of) the DRX active time. The wireless device may determine (at least) the offset prior to the first occasion/resource of the at least one occasion/resource that the first occasion/resource of the at least one occasion/resource being in the DRX active time. The offset may be hardcoded for the wireless device. The offset may, for example, be based on MAC layer processing delay and/or physical layer processing delay of the wireless device. The offset may be larger than the pre-defined gap (e.g., 4 ms), e.g., based on higher layer processing times (e.g., RLC layer or PDCP layer).

In an example embodiment, as shown in FIG. 18, based on receiving a packet data unit (PDU) Set (e.g., comprising a plurality of PDUs, e.g., N≥1 PDUs), the wireless device may determine the second occasion of the at least one occasion not being in the DRX active time of the DRX operation. In an example, the wireless device may determine the PDU Set being received until the offset prior to the second occasion of the at least one occasion. In response to the determining the second occasion of the at least one occasion being outside of the DRX active time of the DRX operation, the wireless device may refrain from transmitting (or not transmit or avoid/skip/refuse transmitting) the report via the second occasion of the at least one occasion. The wireless device may, for example, determine the DRX ODT of the first DRX configuration is running. The wireless device may determine the one or more DRX active time conditions not being satisfied.

For example, the wireless device may determine the PDU Set (or data burst) being (fully/entirely) received based on a PDU Set information (e.g., corresponding to the PDU Set), e.g., a PDU Set Identifier; and/or a Start (or earliest/starting/initial/first) PDU and/or an End (or latest/final/ending/last) PDU of the PDU Set; and/or a PDU serial number (SN) of a PDU within the PDU Set; and/or a PDU Set size; and/or a PDU Set importance; and/or an End of Data Burst indication (e.g., indicating an end of the data burst). For example, in FIG. 18, PDU #1 (e.g., with a first PDU SN) may be the Start PDU of the PDU Set. PDU #2 may correspond to a PDU with a second PDU SN, and PDU #3 may correspond to a PDU with a third PDU SN. PDU #N may correspond to an End PDU (e.g., with a last/ending PDU SN) of the PDU Set. For example, the base station may transmit PDUs of the PDU Set in order based on their PDU SNs, e.g., a PDU with a smaller PDU SN is transmitted earlier than a PDU with a larger PDU SN. In some cases, the base station may transmit PDUs of the PDU Set as they arrive (e.g., not in order), e.g., a PDU with a smaller PDU SN is transmitted after a PDU with a larger PDU SN is transmitted. In some examples, the wireless device may receive the plurality of PDUs of the PDU Set not in the order shown in FIG. 18. For example, the PDU #2 may be a first PDU (or a last PDU) that is actually received at the wireless device. As shown in FIG. 18, the wireless device may receive the PDU Set via M PDSCH (M=N or M>N). For example, the wireless device may, to determine the PDU Set (or data burst) being (fully/entirely) received, determine the plurality of PDUs of the PDU Set being correctly received. In another example, the wireless device may, to determine the PDU Set (or data burst) being (fully/entirely) received, determine no HARQ-ACK with a negative acknowledgement, corresponding to M PDSCHs for receiving the PDU Set, being transmitted to the base station. In other examples, the wireless device may, to determine the PDU Set (or data burst) being (fully/entirely) received, determine a (or each) PDU of the PDU Set corresponding to a feedback-disabled HARQ process. The wireless device may, to determine the PDU Set (or data burst) being (fully/entirely) received, determine a retransmission mode of the PDU Set or a HARQ retransmission mode (each) PDU of the PDU Set being disabled (or not being enabled).

In the example of FIG. 18, the PDU Set may correspond to an XR data burst, e.g., corresponding to a period of the XR traffic/data. The XR traffic/data may be arrived periodically/semi-periodically at the base station (or the wireless device), e.g., with a periodicity of 30/45/60/90/120 FPS. The base station may transmit a plurality of PDU Sets (comprising the PDU Set) to the wireless device. The base station may transmit each PDU Set of the plurality of PDU Sets during a period (e.g., based on periodicity of the XR traffic and/or a DRX cycle of the first DRX configuration).

As shown in FIG. 18, arrival of the XR data/traffic (e.g., the PDU Set), e.g., during an XR traffic/data period, at the base station may be uncertain. For example, due to jitter (e.g., 2 ms in FIG. 18) the PDU Set may arrive at the base station late, e.g., at time/occasion T2 instead of T0. Time/occasion T0 in FIG. 18 may correspond to an expected (or estimated) data arrival occasion/time of the PDU Set/data burst (within a period).

In some cases, the PDU Set may arrive at the base station shortly after the expected data arrival time/occasion, e.g., with a small amount/value of jitter (e.g., 0<jitter<2 ms). In some cases, the PDU Set may arrive at time T0 (as expected by the base station).

For example, the PDU Set may receive earlier than the expected data arrival time/occasion, e.g., when jitter is negative (e.g., −2 ms or −4 ms). The base station may wait for a duration to allow the wireless device to wake up (e.g., to start the DRX ODT) for starting to transmit the PDU Set. The base station may, for a DRX cycle, wake up the wireless device, e.g., via a (low-power) wake up signal (WUS). For example, the wireless device may monitor the one or more power saving occasions to determine whether to wake up for the DRX cycle or not.

For example, the wireless device may start the DRX ODT of the first DRX configuration (e.g., of the DRX operation) based on the expected data arrival occasion/time of the PDU Set. For example, the wireless device may start the DRX ODT of the first DRX configuration at time/occasion T1 (e.g., after or in/at/on the expected data arrival occasion/time of the PDU Set). FIG. 18 shows a scenario that jitter is a positive number (e.g., 2 ms or 10 ms), e.g., the PDU Set may arrive after the expected data arrival time/occasion T0. In some other cases (not shown in FIG. 18), when the jitter is a negative number (e.g., −2 ms, −4 ms, or −8 ms), the PDU Set may arrive before the expected data arrival time/occasion T0. In one example, the wireless device may start the DRX ODT of the first DRX configuration at the expected data arrival occasion/time of the PDU Set. In another example, the wireless device may start the DRX ODT of the first DRX configuration after the expected data arrival occasion/time of the PDU Set. In yet another example, the wireless device may start the DRX ODT of the first DRX configuration before the expected data arrival occasion/time of the PDU Set. A starting occasion/time of the DRX ODT of the first DRX configuration (e.g., time/occasion T1) may be a DRX offset of the first DRX configuration from a beginning/starting of a subframe. For example, when a Short DRX cycle being configured by the first DRX configuration, the wireless device may determine whether [(SFN×10)+subframe number] modulo (drx-ShortCycle)=(drx-StartOffset) modulo (drx-ShortCycle), e.g., to start the DRX ODT. In another example, when a Long DRX cycle being configured by the first DRX configuration, the wireless device may determine whether [(SFN×10)+subframe number] modulo (drx-ShortCycle)=(drx-StartOffset) modulo (drx-LongCycle), e.g., to start the DRX ODT.

For example, the first DRX configuration parameter comprise a first value (e.g., 4 ms, 10 ms, 30 ms or the like) for the DRX ODT, e.g., the length of the DRX ODT. The base station may, to account for uncertainty in arrival of the PDU Set, configure/set the first value based on average/estimated/expected value of the jitter (e.g., length of the DRX ODT>2*|jitter|, where |jitter| is an absolute value of an estimate/expected jitter range) and/or an estimate/expected of a data burst size (e.g., number of PDUs in a PDU Set, e.g., N in FIG. 18). The wireless device may set/initialize the DRX ODT based on/using the first value and start the DRX ODT at the determined starting occasion/time (e.g., T1 in FIG. 18). For example, the first value (e.g., configured length of the DRX ODT) may be the difference between time/occasion T9 and T1 in FIG. 18. Initially/potentially, the wireless device may expect to run the DRX ODT of the first DRX configuration up to time/occasion T9 in FIG. 18. In the example shown in FIG. 18, during the DRX ODT is (actually) running (e.g., from time/occasion T1 to T5, the wireless device may receive the plurality of PDUs of the PDU Set. The wireless device may determine that the PDU Set is fully received at time/occasion T4 in FIG. 18. For example, the wireless device may stop the DRX ODT based on receiving the PDU Set fully/entirely. As shown in FIG. 18, a duration in which DRX ODT is running may be smaller than the length of the DRX ODT configured by the first DRX configuration.

As shown in FIG. 18, at time/occasion T4 the wireless device may determine an early stopping condition of the DRX ODT of the first DRX configuration being satisfied. In an example embodiment, the wireless device may determine the early stopping condition of the DRX ODT of the first DRX configuration being satisfied based on at least one of: (fully) receiving the PDU Set, e.g., all PDUs of the plurality of PDUs of the PDU Set being (correctly) received; and/or receiving the End PDU of the PDU Set; and/or receiving the End of Data Burst indication; and/or a number of received PDUs of the PDU Set being larger than a pre-configured threshold (e.g., configured by the one or more configuration parameters); and/or expiry of a DRX inactivity timer (IAT) of the first DRX configuration.

In some examples, for (fully/entirely) receiving the PDU Set, the wireless device may determine all the plurality of the PDUs of the PDU Set being correctly/successfully received, e.g., when the PSII of the PDU Set indicating all PDUs of the PDU Set are needed for the usage of PDU Set by application layer (e.g., a first mode/sate of the PSII). In other examples, for (fully/entirely) receiving the PDU Set, the wireless device may determine a subset of the plurality of the PDUs of the PDU Set being correctly/successfully received, e.g., when the PSII of the PDU Set indicating all PDUs of the PDU Set are not needed for the usage of PDU Set by application layer (e.g., a second mode/sate of the PSII). Based on the first mode of the PSII corresponding to the PDU Set, the wireless device (or the application layer of the wireless device) may correctly or successfully receive all PDUs of the PDU Set. For example, under/based on the second mode of the PSII of the PDU Set, the application layer of the wireless device may recover the PDU Set based on the subset of the plurality of the PDUs of the PDU Set, e.g., when at least one PDU of the PDU Set being missing or not being received or being incorrectly/unsuccessfully received. For example, under/based on the second mode of the PSII of the PDU Set, the wireless device may not receive at least one PDU of the PDU Set and determine the PDU Set being usable/acceptable for the application layer (e.g., the at least one PDU of the PDU Set may not be required by the application layer to use the PDU Set in the application layer of the wireless device). For example, under/based on the second mode of the PSII of the PDU Set, the application layer of the wireless device may be able to recover the at least one PDU of the PDU Set. In an example, the higher layers of the wireless device (e.g., higher than the MAC layer or PHY layer), may send the End of Data Burst indication to the lower layers of the wireless device (e.g., PDCP/RLC/MAC/PHY layer) in response to the application layer retrieving/recovering the PDU Set (e.g., despite not receiving the at least one PDU of the PDU Set or when all PDUs of the PDU Set being successfully received).

In some examples, the wireless device may determine the PDU Set being fully/entirely received based on a PDU Set related assistance information (e.g., the PDU-Set QoS parameters) of the PDU Set. For example, the wireless device may determine the PSDB of the PDU Set being violated (or not being satisfied). In some cases, the wireless device may determine a PDB a first PDU of the at least one PDU of the PDU Set (that is not being received or being received incorrectly or being missing) being violated (or not being satisfied).

For example, the End of Data Burst indication may correspond to the End PDU of the PDU Set. In other examples, the End of Data Burst indication may not correspond to the End PDU of the PDU Set. For example, the End of Data Burst indication may correspond to/based on the PSII of the PDU Set, e.g., when the application layer of the wireless device is able to use the PDU Set based on the received PDUs. In some cases, a higher layer (e.g., PDCP/RLC/MAC layer) of the wireless device sends the End of Data Burst indication to a lower layer (e.g., RLC/MAC/PHY layer) of the wireless device. In some other cases, the wireless device may receive a downlink message comprising/indicating/scheduling the End PDU of the PDU Set. For example, the downlink message may be a downlink control information (DCI) or a MAC control element (CE). The wireless device may determine the End of Data Burst indication based on the downlink message.

In some examples, a downlink message may indicate the End of Data Burst indication. For example, the downlink message may be a DCI comprising a field. The field may be an End of Data Burst indication field. The downlink message may be a MAC CE.

In an example embodiment, the wireless device may evaluate the one or more DRX active time conditions the offset prior to the resource/occasion of the at least one resource/occasion. The wireless device may determine the one or more DRX active time conditions not being satisfied (e.g., the offset prior to the resource/occasion of the at least one resource/occasion), e.g., based on the early stopping condition (e.g., of the DRX ODT of the first DRX configuration) being satisfied.

In an example embodiment, the wireless device may determine the one or more DRX active time conditions being satisfied (e.g., the offset prior to the resource/occasion of the at least one resource/occasion), e.g., based on the early stopping condition (e.g., of the DRX ODT of the first DRX configuration) not being satisfied.

In an example embodiment, the base station may configure the wireless device to stop the DRX ODT of the first DRX configuration, e.g., based on the early stopping condition of the DRX ODT of the first DRX configuration being satisfied. For example, the one or more configuration parameters (e.g., the one or more DRX configuration parameters, or the first DRX configuration) may comprise a first parameter. In response to the first parameters being configured (or enabled), the wireless device may stop the DRX ODT of the first DRX configuration, e.g., based on the early stopping condition of the DRX ODT of the first DRX configuration being satisfied. For example, as shown in FIG. 18, the wireless device may determine, until/at least the offset (e.g., until, up to, at least 4 ms) prior to the second occasion/resource of the at least one occasion/resource, the early stopping condition of the DRX ODT of the first DRX configuration being satisfied. The second occasion/resource of the at least one occasion/resource may be at least the offset (at least 4 ms) after/from an occasion/time that the early stopping condition of the DRX ODT of the first DRX configuration is satisfied. Accordingly, the wireless device may not transmit the report via/using the second occasion/resource of the at least one occasion/resource. For example, as shown in FIG. 18, the wireless device may determine, before the offset that occurs prior to the first occasion/resource of the at least one occasion/resource, the early stopping condition of the DRX ODT of the first DRX configuration being satisfied. In some other cases, the wireless device may determine, until/at least the offset (e.g., until, up to, at least 4 ms) prior to the first occasion/resource of the at least one occasion/resource, the early stopping condition of the DRX ODT of the first DRX configuration being satisfied. The first occasion/resource of the at least one occasion/resource may be at least the offset (e.g., at least 4 m) after/from an occasion/time that the early stopping condition of the DRX ODT of the first DRX configuration is satisfied. The wireless device may transmit the report via/using the first occasion/resource of the at least one occasion/resource.

In an example embodiment, in response to the first parameters not being configured (or not being enabled or being disabled), the wireless device may not stop (or avoid stopping) the DRX ODT of the first DRX configuration, e.g., based on the early stopping condition of the DRX ODT of the first DRX configuration being satisfied. For example, the wireless device may keep running the DRX ODT timer up to time/occasion T9 in FIG. 18 (e.g., based on the first value or the initialized length of the DRX ODT). For example, the wireless device may determine the first occasion/resource of the at least one occasion/resource being inside of (or within/in) the DRX active time, e.g., the wireless device may transmit the report via/using the first occasion/resource of the at least one occasion/resource. The wireless device may determine the second occasion/resource of the at least one occasion/resource being inside of (or within/in) the DRX active time, e.g., the wireless device may transmit the report via/using the second occasion/resource of the at least one occasion/resource.

For example, the periodic CSI report may not be a Layer 1 reference signal received power (L1-RSRP), e.g., the report may not comprise the L1-RSRP. The one or more CSI configuration parameters (e.g., CSI-ReportConfig) may, for example, indicate/configure one or more CSI-related quantities. In an example, the one or more CSI-related quantities may not indicate a L1-RSRP-related quantity for reporting at the first symbol. The base station, e.g., via the one or more CSI configuration parameters, may not set/configure the higher layer parameter reportQuantity to indicate the L1-RSRP-related quantity for reporting at the first symbol/time.

In an example, the periodic CSI report may be the L1-RSRP. For example, the report may comprise the L1-RSRP. According to an example, the one or more CSI-related quantities may comprise the L1-RSRP-related quantity for reporting at the first symbol. In another example, the higher layer parameter reportQuantity may indicate/configure the L1-RSRP-related quantity for reporting at the first symbol/time.

For example, based on a resource/occasion (e.g., the first resource/occasion and/or the second resource occasion) of the at least one resource/occasion not being in the DRX active time (e.g., of a DRX group), the wireless device may not transmit periodic SRS and semi-persistent SRS in the DRX group. For example, the wireless device may not report CSI on PUCCH and semi-persistent CSI configured on PUSCH in the DRX group. For example, the wireless device may determine the resource/occasion of the at least one resource/occasion not being in the DRX active time (e.g., of a DRX group) considering grants/assignments scheduled on Serving Cell(s) in the DRX group and a DRX Command MAC CE/Long DRX Command MAC CE received and Scheduling Request sent until the offset (e.g., 4 ms) prior to the resource/occasion of the at least one resource/occasion (e.g., symbol), when evaluating the one or more (e.g., all) DRX active time conditions. For example, the wireless device may determine the early stopping condition of the DRX ODT of the first DRX configuration (or the DRX group) being satisfied, e.g., until the offset (e.g., 4 ms) prior to the resource/occasion of the at least one resource/occasion (e.g., symbol), when evaluating the one or more (e.g., all) DRX active time conditions. For example, in response to a CSI masking (csi-Mask) being setup by upper layers (e.g., RRC) of the wireless device, the wireless device may not report CSI on PUCCH in the DRX group.

The base station may expect to receive (or may receive) from the wireless device the report via/using the first resource/occasion of the at least one resource/occasion. By transmitting the report via/using the first resource/occasion of the at least one resource/occasion the wireless device may improve the UL/DL channel/interference measurement and/or beam management, e.g., improve UL/DL data latency and/or spectral efficiency.

The base station may not expect to receive (or may not receive) from the wireless device the report via/using the second resource/occasion of the at least one resource/occasion. By not transmitting the report via/using the second resource/occasion of the at least one resource/occasion the wireless device may reduce the consumed power (e.g., prolong the battery power of the wireless device).

Some example embodiments may improve the DRX operation (e.g., by considering the early stopping of the DRX ODT), e.g., for reducing the PDCCH monitoring power/processing, and/or reducing possibility of unnecessarily transmitting the report (e.g., via the second resource/occasion of the at least one resource/occasion).

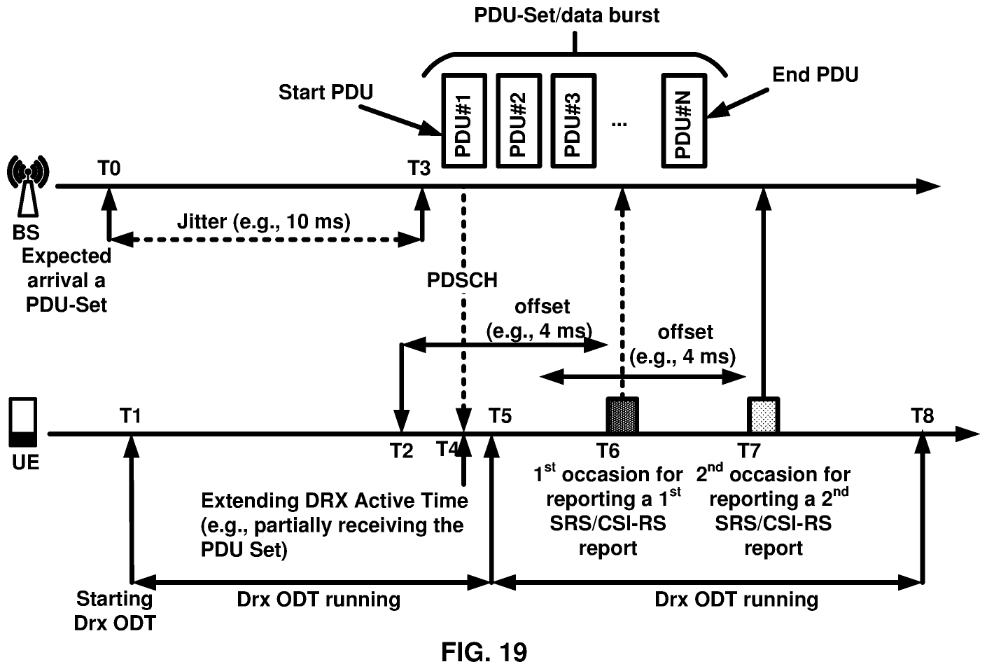

FIG. 19 shows an example embodiment of a DRX operation in wireless communications systems per an aspect of the present disclosure. For example, FIG. 19 may show example implementations of the method/procedure for transmitting a report (e.g., a CSI/SRS report) at the wireless device (e.g., an XR device) and/or receiving the report at the base station. In some scenarios, FIG. 19 may show example embodiments for determining whether the wireless device being in a DRX active time of a DRX operation or not (e.g., considering one or more characteristics of XR data/traffic, e.g., a PDU Set assistance information). In some scenarios, FIG. 19 may show example embodiments for determining whether to transmit the report or not (e.g., considering one or more characteristics of XR data/traffic, e.g., a PDU Set assistance information). In some other scenarios, FIG. 19 may show a procedure for extending DRX active time of a DRX configuration within a DRX cycle (e.g., based on a PDU Set assistance information). For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state). Similar to embodiments of FIG. 18, the wireless device may, from the base station, receive the one or more configuration parameters (e.g., the one or more RRC configuration parameters).

As shown in FIG. 19, a first occasion/resource of the at least one resource/occasion may correspond to a first (time) duration/symbol/slot (e.g., time T6 in FIG. 19). For example, a second occasion/resource of the at least one resource/occasion may correspond to a second (time) duration/symbol/slot (e.g., time T7 in FIG. 19). The wireless device may determine whether to transmit the report via/using a resource/occasion of the at least one resource/occasion (e.g., the first resource/occasion of the at least one resource/occasion and/or the second resource/occasion of the at least one resource/occasion) or not. As shown in FIG. 19, the wireless device may determine to transmit the report via/using the second resource/occasion of the at least one resource/occasion. The wireless device may determine to avoid/skip transmitting (or not transmit or refrain from transmitting) the report via/using the first resource/occasion of the at least one resource/occasion. Following to embodiments of FIG. 18, the wireless device may, to determine whether to transmit the report via/using a (e.g., the first and/or the second) resource/occasion of the at least one resource/occasion, determine whether the occasion/resource of the at least one occasion/resource being outside of a DRX active time (e.g., corresponding to the first DRX configuration or of a DRX operation) or being within/in the DRX active time. The wireless device may determine whether the one or more DRX active time conditions being satisfied or not. In an example of FIG. 19, the wireless device may determine the second occasion/resource of the at least one occasion/resource being inside of (or within/in) the DRX active time (e.g., based on the one or more DRX active time conditions being satisfied). The wireless device may determine the first occasion/resource of the at least one occasion/resource being outside of (or not being inside of) the DRX active time (e.g., based on the one or more DRX active time conditions not being satisfied).

For example, the wireless device may, the offset (e.g., the predefined gap, e.g., 4 ms) prior to the resource/occasion of the at least one resource/occasion, determine whether the resource/occasion of the at least one resource/occasion being outside of a DRX active time (e.g., corresponding to the first DRX configuration or of a DRX operation) or being within/in the DRX active time. As shown in FIG. 19, the wireless device may determine at (or prior to) time/occasion T2 (e.g., at least the offset prior to the first occasion/resource of the at least one occasion/resource) that the first occasion/resource of the at least one occasion/resource being outside of (or not being inside of) the DRX active time. The wireless device may determine (at least) the offset prior to the second occasion/resource of the at least one occasion/resource that the second occasion/resource of the at least one occasion/resource being in the DRX active time.

As shown in FIG. 19, arrival of the XR data/traffic (e.g., the PDU Set), e.g., during a XR traffic/data period or a DRX cycle, at the base station may be late, e.g., due to large jitter (e.g., 10 ms in FIG. 19). For example, the PDU Set may arrive at the base station at time/occasion T3 instead of T0 (e.g., expected data arrival occasion/time of the PDU Set). Similar to embodiments of FIG. 18, the wireless device may start the DRX ODT of the first DRX configuration (e.g., of the DRX operation) based on the expected data arrival occasion/time of the PDU Set. For example, the wireless device may, e.g., at/in/on the starting occasion of the DRX ODT, start the DRX ODT of the first DRX configuration at time/occasion T1 (e.g., after the expected data arrival occasion/time of the PDU Set). The wireless device may set/initialize the DRX ODT based on/using the first value and start the DRX ODT at the determined starting occasion/time (e.g., T1 in FIG. 18). In the example shown in FIG. 19, while the DRX ODT is running (e.g., between time/occasion T1 and the time/occasion T5), the wireless device may partially receive the PDU Set. For example, at time/occasion T4 (e.g., prior to an expiry of the DRX ODT or at the expiry of the DRX ODT), the wireless device may determine that the PDU Set is not fully received (e.g., is partially received).

In an example embodiment, the wireless device may determine the PDU Set being partially received based on determining the PDU Set not being fully/entirely received. For example, the wireless device may determine no PDU of the PDU Set being received during the DRX ODT is running. The wireless device may determine a number of received PDUs of the PDU Set (e.g., during the DRX ODT is running) being smaller than a pre-configured threshold (e.g., configured by the one or more configuration parameters), e.g., expected number of PDUs of the PDU Set. For example, the wireless device may determine the DRX ODT being expired and the PDU Set being partially received (e.g., no PDU of the PDU Set being received). For example, the wireless device may, e.g., upon the expiry of the DRX ODT or a first offset prior to the expiry of the DRX ODT, determine the PDU Set (or data burst) being partially received based on a PDU Set information (e.g., corresponding to the PDU Set), e.g., a PDU Set Identifier; and/or the Start (or earliest/starting/initial/first) PDU and/or the End (or latest/final/ending/last) PDU of the PDU Set; and/or a PDU serial number (SN) of a PDU within the PDU Set; and/or the PDU Set size; and/or a PDU Set importance; and/or the End of Data Burst indication (e.g., indicating an end of the data burst). For example, the wireless device may, to determine the PDU Set being partially received, determine the End PDU of the PDU Set not being received. In another example, the wireless device may, to determine the PDU Set being partially received, determine the End of Data Burst indication not being received. For example, the wireless device may, to determine the PDU Set being partially received, determine at least one HARQ-ACK with negative acknowledgement, corresponding to the M PDSCH for the PDU Set reception, being transmitted to the base station (e.g., at least one PDU of the PDU Set being incorrectly received).

In an example embodiment, as shown in FIG. 19, the wireless device may, corresponding to the DRX cycle, extend the DRX active time of the DRX operation (e.g., of the first DRX configuration), e.g., based on partially receiving the PDU Set. For example, the wireless device may restart the DRX ODT of the DRX operation (e.g., of the first DRX configuration), e.g., within the DRX cycle and/or prior to a next DRX cycle. For example, the wireless device may start a second DRX ODT of the DRX operation (e.g., of the first DRX configuration), e.g., within the DRX cycle and/or prior to a next DRX cycle and/or after (a second offset from) the expiry of the DRX ODT. For example, the one or more configuration parameters may configure the second offset. As shown in FIG. 19, a duration of the DRX active time may be larger than a duration that the DRX ODT is running (e.g., between T1 to T5). For example, the wireless device may extend the DRX active time at time T5 in FIG. 19. As shown the wireless device may restart the DRX ODT of the first DRX configuration at time T5 or start the second DRX ODT of the first DRX configuration.

In an example embodiment, as shown in FIG. 19, when the DRX ODT of the first DRX configuration is running, based on partially receiving the PDU Set, the wireless device may determine the second occasion of the at least one occasion being in the DRX active time of the DRX operation. In an example, the wireless device may determine the PDU Set being partially received until the offset prior to the second occasion of the at least one occasion. In response to the determining the second occasion of the at least one occasion being in the DRX active time of the DRX operation, the wireless device may transmit the report via the first occasion of the at least one occasion. For example, the second occasion of the at least one occasion may be within an extended DRX active time of the DRX operation. As shown in FIG. 19, the wireless device at time/occasion T4 (e.g., at least the offset prior to the first resource/occasion of the at least one occasion/resource) determine the first resource/occasion of the at least one occasion/resource not being in the DRX active time of the DRX operation. The wireless device may avoid/skip transmitting the report via the first occasion of the at least one occasion.

As shown in FIG. 19, at time/occasion T4 the wireless device may determine an extending condition of the DRX active time of the first DRX configuration being satisfied. In an example embodiment, the wireless device may determine the extending condition of the DRX active time of the first DRX configuration being satisfied based on at least one of: partially receiving the PDU Set (e.g., at least one PDUs of the plurality of PDUs of the PDU Set not being received), not receiving the End PDU of the PDU Set, not receiving the End of Data Burst indication, a number of received PDUs of the PDU Set being smaller than the pre-configured threshold (e.g., configured by the one or more configuration parameters), and/or an indication for extending the DRX active time being received.

In an example embodiment, the base station may transmit a DL message (e.g., a DCI/MAC CE) to the wireless device indicating/comprising the indication for extending the DRX active time. For example, the wireless device based on receiving the DL message may extend the DRX active time of the DRX configuration.

In an example embodiment, the wireless device may determine the extending condition of the DRX active time of the first DRX configuration being satisfied prior to an expiry of the DRX ODT (e.g., at time/occasion T4), e.g., the first offset prior to the expiry of the DRX ODT. When the wireless device receives the Start PDU of the PDU Set the first offset prior to the expiry of the DRX ODT of the first DRX configuration, the wireless device may determine the extending condition of the DRX active time of the first DRX configuration being satisfied. For example, the one or more configuration parameters may configure the first offset. The first offset may be different than the offset. In some cases, the offset may be the first offset. In another example, the wireless device may determine the extending condition of the DRX active time of the first DRX configuration being satisfied at the expiry of the DRX ODT (e.g., at time/occasion T5).

In an example embodiment, the wireless device may evaluate the one or more DRX active time conditions the offset prior to the resource/occasion of the at least one resource/occasion. The wireless device may determine the one or more DRX active time conditions being satisfied (e.g., the offset prior to the resource/occasion of the at least one resource/occasion), e.g., based on the extending condition of the DRX active time of the first DRX configuration being satisfied. In an example embodiment, the wireless device may determine the one or more DRX active time conditions not being satisfied (e.g., the offset prior to the resource/occasion of the at least one resource/occasion), e.g., based on extending condition of the DRX active time of the first DRX configuration not being satisfied.

In an example embodiment, the base station may configure the wireless device to extend the DRX active time of the first DRX configuration (or the DRX operation), e.g., based on the extending condition of the DRX active time of the first DRX configuration. For example, the one or more configuration parameters (e.g., the one or more DRX configuration parameters, or the first DRX configuration) may comprise a first parameter. In response to the first parameters being configured (or enabled), the wireless device may extend the DRX active time of the first DRX configuration (or the DRX operation), e.g., based on the extending condition of the DRX active time of the first DRX configuration being satisfied. For example, as shown in FIG. 19, the wireless device may, at least the offset prior to the second occasion/resource of the at least one occasion/resource, determine the extending condition of the DRX active time of the first DRX configuration being satisfied. The wireless device may transmit the report via/using the second occasion/resource of the at least one occasion/resource. For example, as shown in FIG. 19, the wireless device may, at least the offset prior to the first occasion/resource of the at least one occasion/resource, determine the extending condition of the DRX active time of the first DRX configuration not being satisfied. The wireless device may avoid/skip transmitting (or not transmit) the report via/using the first occasion/resource of the at least one occasion/resource.

In an example embodiment, in response to the first parameters not being configured (or not being enabled or being disabled), the wireless device may not extend the DRX active time of the first DRX configuration (or the DRX operation), e.g., based on the extending condition of the DRX active time of the first DRX configuration. For example, the wireless device may, after/in response to the expiry of the DRX ODT of the first DRX configuration and within the DRX cycle, not restart the DRX ODT or not start the second DRX ODT. For example, the wireless device may determine the first occasion/resource of the at least one occasion/resource being outside of the DRX active time, e.g., the wireless device may not transmit the report via/using the first occasion/resource of the at least one occasion/resource. The wireless device may determine the second occasion/resource of the at least one occasion/resource being outside of the DRX active time, e.g., the wireless device may not transmit the report via/using the second occasion/resource of the at least one occasion/resource.

Some example embodiments may improve the DRX operation (e.g., by considering the extending the DRX active time of the DRX operation), e.g., for reducing possibility of unnecessarily dropping the report. Example embodiments may improve UL/DL delay/spectral efficiency (e.g., improve beam management).

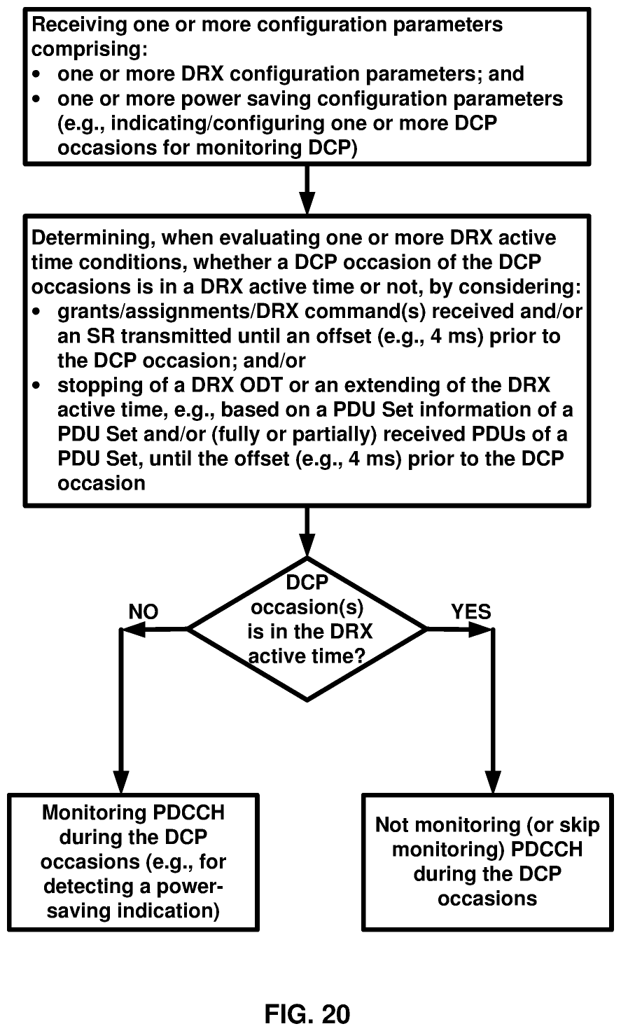

FIG. 20 shows a flowchart of a method/procedure for PDCCH monitoring in wireless communication systems. FIG. 20 shows an example embodiment of a DCP monitoring (e.g., via monitoring the PDCCH during at least one DCP occasion (or a low-power waking up signal, e.g., LP-WUS), e.g., based on the ps-RNTI and/or the one or more power saving configuration parameters) in wireless communication systems per an aspect of the present disclosure. FIG. 20 may show an example embodiment of a procedure for determining whether the wireless device wakes up for a next DRX cycle for not. For example, FIG. 20 may show example implementations of the method/procedure at/in a wireless device (e.g., an XR device) and/or the base station. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

As shown in FIG. 20, the wireless device may receive (e.g., from the base station) the one or more configuration parameters. For example, the one or more configuration parameters may comprise the one or more DRX configuration parameters and/or the one or more power saving configuration parameters. The one or more power saving configuration parameters may comprise configurations for monitoring the at least one power saving occasion (e.g., the at least one DCP occasion or the wakeup duration/occasion or one or more power saving occasions) in an active DL BWP. The one or more power saving configuration parameters may, for example, comprise the DCP monitoring configuration.

For example, the one or more power saving configuration parameters may configure the wireless device with the DCP monitoring for the active DL BWP. The wireless device may, via/using or based on the at least one power saving occasion (e.g., one or more DCP occasions), monitor PDCCH for detecting a DCI format 2_6 (e.g., a DCI having a format based on DCI format 2_6) and/or LP-WUS. The wireless device may, for example, receive the DCI having/with a format based on the DCI format 2_6. For example, the wireless device may, via/using or based on the at least one power saving occasion, monitor the PDCCH by the PS-RNTI and/or one or more other power saving RNTIs (e.g., for low power WUS, release 18 power saving enhancements).

The at least one power saving occasion may be before a DRX cycle of the first DRX configuration (e.g., of a DRX group). For example, the wireless device may start the DRX cycle at/on/from/in a slot. The slot may correspond to a starting time/occasion of a DRX ODT of the first DRX configuration (e.g., of the DRX group). In an example, the wireless device may start the DRX cycle from/at/on/in a subframe. The subframe may correspond to the starting time of the DRX ODT. For example, the wireless device may determine a starting time of the DRX ODT being the slot of the subframe.

In an example, the at least one power saving monitoring may be located the DCP gap/offset (e.g., ps-Offset) before the starting occasion/time of the DRX ODT (or the start of the DRX cycle), e.g., the first/initial/earliest/starting power saving occasion among/from/of the at least one power saving occasion may be located the DCP gap/offset before the DRX cycle. The at least one power saving monitoring may, for example, be located the DCP gap/offset (e.g., ps-Offset) before the start of the DRX ODT (or the start of the DRX cycle), e.g., a first/initial/starting/earliest symbol of the first/initial/earliest/starting power saving occasion among/from/of the at least one power saving occasion may be located the DCP gap/offset before the DRX cycle.

In an example embodiment, as shown in FIG. 20, the wireless device may determine whether to monitor the at least one DCP occasion or not. For example, the wireless device may, when evaluating the one or more DRX active time conditions, determine whether a (or all) DCP occasion(s) of the at least one DCP occasion (e.g., in time domain) being in the DRX active time (e.g., of the first DRX configuration or the DRX operation or the DRX group) or not. The wireless device may, to determine whether the (or all) DCP occasion(s) of the at least one DCP occasion (e.g., in time domain) being in the DRX active time (e.g., of the first DRX configuration or the DRX operation or the DRX group) or not, consider grants/assignments scheduled on Serving Cell(s) in the DRX group and a DRX Command MAC CE/Long DRX Command MAC CE received and Scheduling Request sent until the offset (e.g., 4 ms) prior to the DCP occasion of the at least one DCP occasion, when evaluating the one or more (e.g., all) DRX active time conditions.

In an example embodiment, as shown in FIG. 20, the wireless device may determine the early stopping condition of the DRX ODT of the first DRX configuration (or the DRX group) being satisfied, e.g., until/at least the offset (e.g., until/at least 4 ms) prior to the DCP occasion of the at least one DCP occasion, when evaluating the one or more (e.g., all) DRX active time conditions. For example, the DCP occasion may be at least the offset (e.g., at least 4 ms) after/from an occasion/time that the early stopping condition of the DRX ODT of the first DRX configuration is satisfied. For example, the wireless device may (fully) receive the PDU Set until/at least the offset (e.g., until, up to, at least 4 ms) prior to the DCP occasion of the at least one DCP occasion, e.g., when evaluating the one or more (e.g., all) DRX active time conditions.

In an example embodiment, as shown in FIG. 20, the wireless device may determine the extending condition of the DRX active time of the first DRX configuration not being satisfied, e.g., until/at least the offset (e.g., until/at least 4 ms) prior to the DCP occasion of the at least one DCP occasion. For example, the DCP occasion may be at least the offset (e.g., at least 4 ms) after/from an occasion/time that the extending condition of the DRX active time of the first DRX configuration is not satisfied. For example, the wireless device may not fully (or partially) receive the PDU Set until/at least the offset (e.g., until/at least 4 ms) prior to the DCP occasion of the at least one DCP occasion, when evaluating the one or more (e.g., all) DRX active time conditions. For example, the wireless device may receive no PDU of the PDU Set until/at least the offset (e.g., until/at least 4 ms) prior to the DCP occasion of the at least one DCP occasion, when evaluating the one or more (e.g., all) DRX active time conditions.

The DCP occasion of the at least one DCP occasion may be a start of a first/starting/earliest/initial DCP of the at least one DCP occasion. The DCP occasion of the at least one DCP occasion may, for example, be a start of a last/final/ending/latest DCP of the at least one DCP occasion.

For example, as shown in FIG. 20, based on the (all) DCP occasion(s) of the at least one DCP occasion (e.g., in time domain) being in the DRX active time (e.g., of the first DRX configuration or the DRX operation or the DRX group), the wireless device may not monitor the DCP occasions (e.g., not monitoring the PDCCH during/in the DCP occasions and/or for the PS-RNTI). The wireless device may start the DRX ODT of the first DRX configuration after the DCP gap/offset, e.g., from the first/initial/earliest/starting power saving occasion among/from/of the at least one power saving occasion.

For example, as shown in FIG. 20, based on the (all) DCP occasion(s) of the at least one DCP occasion (e.g., in time domain) not being in the DRX active time (e.g., of the first DRX configuration or the DRX operation or the DRX group), the wireless device may monitor the DCP occasions (e.g., monitoring the PDCCH during the DCP occasions and/or for the PS-RNTI and/or the at least one power saving occasion). For example, based on receiving/detecting a DCI comprising the wake-up indication bit associated with the current DRX cycle (e.g., receiving a DCI having/with a format based on the DCI format 2_6 or detecting the DCI format 2_6) while/when monitoring the at least one power saving occasion, the physical layer of the wireless device may report the value of the wake-up indication bit (the first value or the second value) for the wireless device to the higher layer (e.g., the MAC layer) of the wireless device. For example, the higher layer of the wireless device may, based on the wake-up indication bit, determine whether to start the DRX timer after the DRX slot offset from the beginning of the subframe or not. If ps-Wakeup is configured with value true and a DCP indication associated with the current DRX cycle (e.g., the DCP indication indicating starting the DRX ODT or the DCP indication with the wake-up indication bit being set to the first value) has not been received from lower layers, the wireless device may start the DRX ODT of the first DRX configuration after the DCP gap/offset, e.g., from the first/initial/earliest/starting power saving occasion among/from/of the at least one power saving occasion. If ps-Wakeup is configured with value true and a DCP indication associated with the current DRX cycle (e.g., the DCP indication indicating not starting the DRX ODT or the DCP indication with the wake-up indication bit being set to the second value) has been received from lower layers, the wireless device may not start the DRX ODT of the first DRX configuration after the DCP gap/offset.

In an example embodiment, based on all DCP occasions of the at least one DCP occasion (e.g., in time domain) in/within the DRX cycle occurring during an activated measurement gap of one or more measurement gaps, the wireless device may not monitor the DCP occasions. For example, the wireless device may receive a DL message (e.g., a DCI or a MAC CE or an RRC message, e.g., an RRC reconfiguration message) activating the measurement gap. For example, the one or more configuration parameters (e.g., MeasGapConfig) may configure the wireless device with the one or more measurement gaps (e.g., positioning measurement gaps). The wireless device may activate the measurement gap of the one or more measurement gap based on receiving the DL message activating the measurement gap (e.g., indicating an activation of the measurement gap). In an example, based on a (all) DCP occasion(s) in time domain of the at least one DCP occasion (e.g., in time domain) in/within the DRX cycle occurring during a deactivated measurement gap of the one or more measurement gaps, the wireless device may monitor the DCP occasions. For example, the wireless device may receive a second DL message (e.g., a DCI or a MAC CE or an RRC message) deactivating a measurement gap (e.g., the activated measurement gap). For example, the second DL message may indicate a deactivation of the measurement gap of the one or more measurement gaps.

When the DRX operation is configured and the DCP monitoring for the active DL BWP being configured, the wireless device may determine whether to transmit a periodic CSI (e.g., that is L1-RSRP or that is not L1-RSRP) on PUCCH or not, e.g., during/within/at a symbol n. For example, the symbol n may occur during the DRX ODT of the first DRX configuration. In an example, the wireless device may determine, prior to the start of the DRX ODT associated with the (current) DRX cycle (of the first DRX configuration, to not transmit the report (e.g., periodic SRS and/or semi-persistent SRS and/or semi-persistent CSI configured on PUSCH) during/within at the symbol n. The wireless device may not be in the active time of the DRX operation considering grants/assignments/DRX Command MAC CE/Long DRX Command MAC CE received, and the SR sent/transmitted until the predefined gap prior to the symbol n, e.g., when evaluating the one or more DRX active time conditions. For example, the wireless device may determine the extending condition of the DRX active time of the first DRX configuration not being satisfied, e.g., until/at least the offset (e.g., until/at least 4 ms) prior to the symbol n, e.g., when evaluating the one or more DRX active time conditions. For example, the wireless device may determine the early stopping condition of the DRX ODT of the first DRX configuration (or the DRX group) being satisfied, e.g., until/at least the offset (e.g., until/at least 4 ms) prior to the symbol n, when evaluating the one or more (e.g., all) DRX active time conditions. For example, the wireless device may determine the one or more DRX active time conditions not being satisfied.

In some cases, the report may be the periodic CSI on PUCCH (that is L1-RSRP) and the one or more configuration parameters configuring ps-TransmitPeriodicL1-RSRP with value true. In some other cases, the report may be the periodic CSI (that is not L1-RSRP) on PUCCH and the one or more configuration parameters not configuring ps-TransmitOtherPeriodicCSI with value true.

In an example, the wireless device may determine, prior to the start of the DRX ODT associated with the (current) DRX cycle (of the first DRX configuration, to transmit the report during/within at the symbol n. The wireless device may be in the active time of the DRX operation considering grants/assignments/DRX Command MAC CE/Long DRX Command MAC CE received, and the SR sent/transmitted until the predefined gap prior to the symbol n, e.g., when evaluating the one or more DRX active time conditions. For example, the wireless device may determine the extending condition of the DRX active time of the first DRX configuration being satisfied, e.g., until/at least the offset (e.g., until/at least 4 ms) prior to the symbol n, e.g., when evaluating the one or more DRX active time conditions. For example, the wireless device may determine the early stopping condition of the DRX ODT of the first DRX configuration (or the DRX group) not being satisfied, e.g., until/at least the offset (e.g., until/at least 4 ms) prior to the symbol n, when evaluating the one or more (e.g., all) DRX active time conditions. For example, the wireless device may determine the one or more DRX active time conditions being satisfied.

Some example embodiments may improve consumed power of the wireless device by reducing PDCCH processing power (e.g., not waking up unnecessarily). Example embodiments may reduce possibility of unnecessarily monitoring the DCP occasions, e.g., when arrival of PDU set is uncertain (due to jitter).

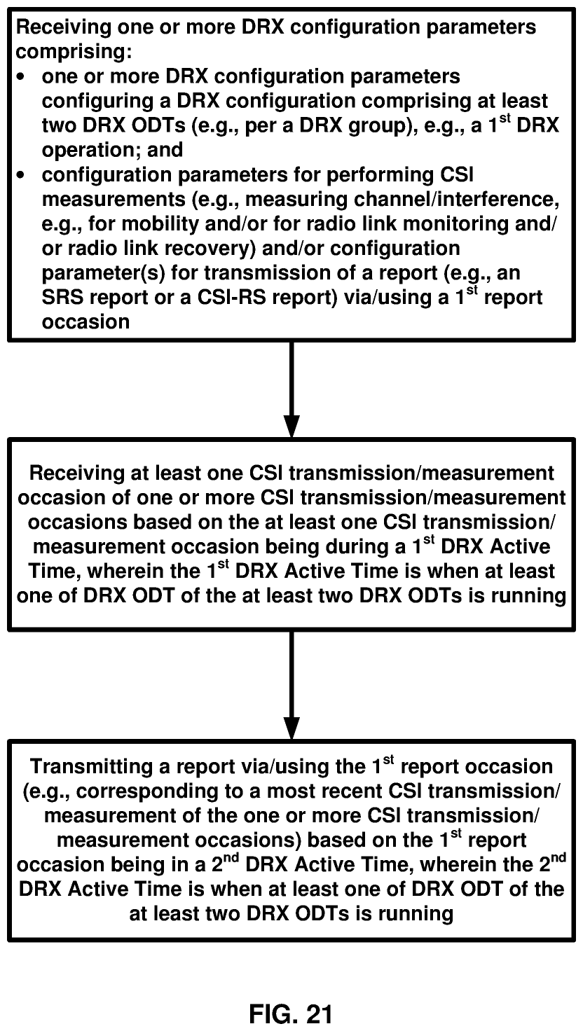

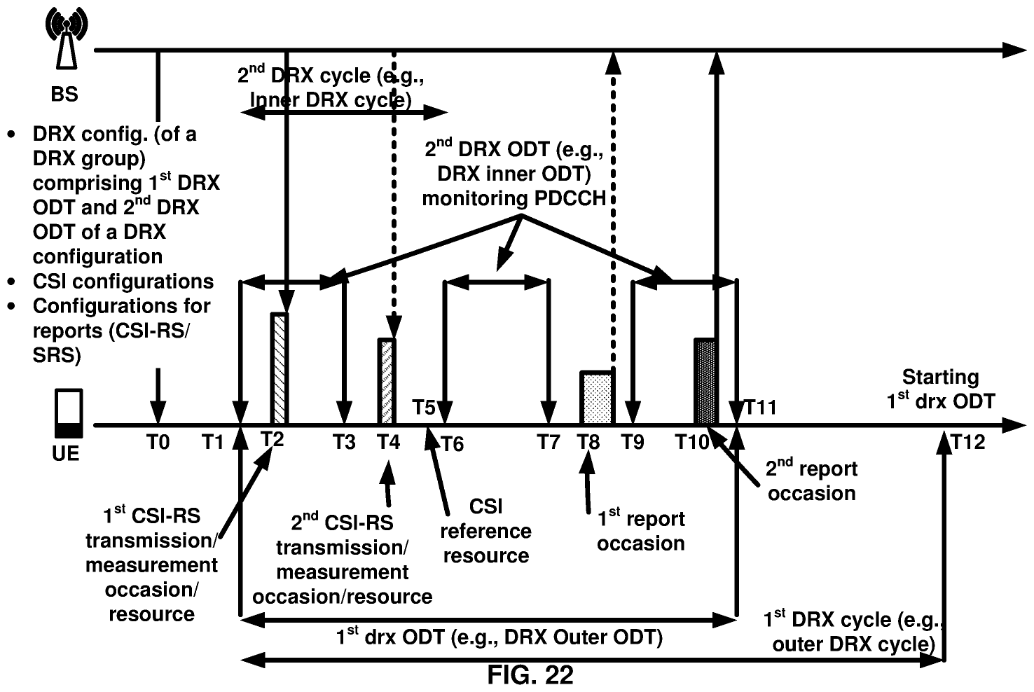

FIG. 21 shows a flowchart of a method/procedure for DRX operation in wireless communication systems. FIG. 22 shows an example embodiment of a DRX operation in wireless communication systems per an aspect of the present disclosure. For example, FIG. 22 may show example implementations of the method/procedure of the FIG. 21 at/in a wireless device (e.g., an XR device) and/or the base station. In some scenarios, FIGS. 21-22 may show example embodiments for determining a DRX active time of a DRX operation or of a DRX group, e.g., when a DRX configuration comprises two DRX ODTs per the DRX group. In some other scenarios, FIGS. 21-22 may show a procedure for determining whether to receive at least one CSI-RS channel/interference measurement and/or at least one CSI-IM interference measurement, e.g., when a DRX configuration comprises two DRX ODTs per the DRX group. In some aspect, FIGS. 21-2 may show a procedure for determining whether to transmit/send/report a report (e.g., a CSI-RS report and/or an SRS report), e.g., when a DRX configuration comprises two DRX ODTs per the DRX group. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

As shown in FIG. 21, the wireless device may, from the base station, receive the one or more configuration parameters (e.g., the one or more RRC configuration parameters). The one or more configuration parameters may, for example, comprise the one or more serving cell (e.g., the one or more Serving Cells or the one or more cells) configuration parameters (e.g., ServingCellConfigCommon, ServingCellConfigCommonSIB, and/or ServingCellConfig) for configuring one or more cells (e.g., one or more serving cells, e.g., the one or more Serving Cells). The one or more configuration parameters may comprise the one or more BWP configuration parameters (e.g., BWP-DownlinkDedicated IE), e.g., of a downlink (DL) BWP (e.g., initial downlink BWP) of a serving cell and/or of an UL BWP of the serving cell. For example, the one or more configuration parameters may comprise the one or more PDCCH configuration parameters (e.g., for PDCCH of the downlink BWP, e.g., in pdcch-Config IE and/or PDCCH-ServingCellConfig IE applicable for all downlink BWPs of the serving cell).

As shown in FIG. 21 and FIG. 22, the one or more configuration parameters may comprise the one or more DRX configuration parameters. For example, the one or more DRX configuration parameters may configure/comprise at least two DRX ODTs (e.g., per a DRX group). The DRX group may be a secondary DRX group or a (primary) DRX group. Hereafter, a DRX operation of FIGS. 21-22 may be referred to by a first DRX implementation/operation.

According to the first DRX operation, as shown in FIG. 22, the at least two DRX ODTs may correspond to a DRX configuration (e.g., of the DRX group) configured by the one or more DRX configuration parameters. The DRX configuration may be the first DRX configuration. For example, a first DRX ODT of the at least two DRX ODTs may be a DRX outer/outside/external/exterior/outermost ODT and a second DRX ODT of the at least two DRX ODTs may be a DRX inner/interior/inmost/inside/innermost ODT. The DRX configuration may comprise at least two DRX cycles. For example, the first DRX ODT of the DRX configuration may be drx-onDurationTimer. The second DRX ODT of the DRX configuration may be different than drx-onDurationTimer. In an example, the second DRX ODT of the DRX configuration may be different than drx-InactivityTimer. For example, the DRX configuration may indicate/configure at least one of the following: drx-InactivityTimer, a DRX slot offset (e.g., drx-SlotOffset), drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, drx-HARQ-RTT-TimerUL, downlinkHARQ-FeedbackDisabled (optional) and/or uplinkHARQ-Mode (optional).

As shown in FIG. 22, a first DRX cycle of the at least two DRX cycles may be an outer/outside/external/exterior/outermost DRX cycle. For example, the first DRX ODT of the at least two DRX ODTs may indicate a first duration at a beginning/start of the first DRX cycle. A second DRX cycle of the at least two DRX cycles may be an inner/interior/inmost/inside/innermost DRX cycle. The first DRX cycle may be a Long DRX cycle (e.g., drx-LongCycle). For example, the DRX configuration may not configure a Short DRX cycle (e.g., drx-ShortCycle). The wireless device may not expect that the DRX configuration comprise the second DRX cycle and the Short DRX cycle. The second DRX cycle may be different than the Short DRX cycle and/or the Long DRX cycle.

For example, the second DRX ODT of the at least two DRX ODTs may indicate a second duration at a beginning/start of the second DRX cycle. The wireless device may start the first DRX ODT at time/occasion T1 (or T12) corresponding to a first starting occasion/time of the first DRX ODT. The first starting occasion/time of the first DRX ODT may be a DRX offset (e.g., drx-StartOffset) of the DRX configuration from a beginning/starting of a subframe. For example, the wireless device may determine whether [(SFN×10)+subframe number] modulo (drx-ShortCycle)=(drx-StartOffset) modulo (drx-LongCycle) to start the first DRX ODT of the DRX configuration. As shown in FIG. 22, when the first DRX ODT is running, the wireless device may start the second DRX ODT one or more times (e.g., based on a configured pattern and/or a bitmap and/or the second DRX cycle of the DRX configuration). In the example of FIG. 22, the wireless device may determine to start the second DRX ODT based on the second DRX cycle and/or the first DRX ODT running. In the example of FIG. 22, the second DRX ODT may be running during three different/non-overlapping time durations (e.g., between time T1 to T3 and between time T6 to T7 and between time T9 to time T11). For example, the first DRX ODT may be running between time T1 to T11.

According to the first DRX implementation (shown in FIG. 22), the wireless device may monitor the PDCCH (e.g., for the at least one RNTI) when the first DRX ODT and the second DRX ODT is running. For example, the at least one RNTI may comprise an XR dedicated RNTI (e.g., XR-RNTI and/or XR-CS-RNTI). The first DRX implementation may allow the wireless device to non-uniformly monitor the PDCCH, e.g., when there is an uncertainty, e.g., due to jitter, in arrival of UL/DL data (e.g., XR packets/traffic). For example, the first DRX implementation may reduce the consumed power of the wireless device for monitoring the PDCCH.

As shown in FIG. 22 and FIG. 21, the one or more configuration parameters may comprise the one or more CSI configuration parameters and/or the one or more SRS configuration parameters, e.g., for performing CSI-RS/IM measurements (e.g., measuring channel/interference, e.g., for UL/DL beam management and/or mobility) and/or for transmitting the report. For example, the one or more CSI configuration parameters and/or the one or more SRS configuration parameters may comprise/indicate the at least one resource/occasion for transmission of the report (e.g., SRS or CSI-RS). The at least one resource/occasion may comprise a first resource/occasion. For example, the one or more configuration parameters may comprise/indicate one or more CSI transmission/measurement occasions/resources, e.g., for time/frequency tracking, CSI computation, L1-RSRP computation, L1-SINR computation, mobility, and/or tracking during fast SCell activation. The wireless device may use at least one CSI transmission/measurement occasion/resource of the one or more CSI transmission/measurement occasions/resources to receive CSI-RS transmissions/occasions and/or to perform CSI channel/interference measurements.

The at least one CSI transmission/measurement occasion of the one or more CSI transmission/measurement occasions may correspond to a CSI-RS resource setting (e.g., a CSI-ResourceConfig and/or CSI-RS-Resource-Mobility and/or a NZP-CSI-RS-ResourceSet and/or a NZP-CSI-RS-ResourceId) of the one or more CSI-RS resource settings; and/or a CSI report setting of the one or more CSI reporting settings (e.g., a CSI-ReportConfig); and/or a CSI measurement setting of the at least one CSI measurement setting (e.g., CSI-RS for tracking, and/or CSI-RS for L1-RSRP and L1-SINR computation, and/or CSI-RS for mobility). In one example, the at least one CSI transmission/measurement occasion of the one or more CSI transmission/measurement occasions may be for CSI-RS channel measurement or for a CSI-RS (and/or CSI-IM) interference measurement. In yet another example, the at least one CSI transmission/measurement occasion of the one or more CSI transmission/measurement occasions may correspond to CSI-RS measurements for mobility (e.g., CSI-RS-Resource-Mobility). In yet another example, the at least one CSI transmission/measurement occasion of the one or more CSI transmission/measurement occasions may correspond to the CSI-RS measurements for radio link monitoring (e.g., RadioLinkMonitoringRS), e.g., for beam management and/or radio link failure (RLF).

In an example embodiment, as shown in FIG. 21, the wireless device may receive at least one CSI transmission/measurement occasion of the one or more CSI transmission/measurement occasions based on the at least one CSI transmission/measurement occasion being during a first DRX active time (e.g., of the DRX configuration or the first DRX operation or the DRX group). For example, the first DRX active time may be when at least one of DRX ODT of the at least two DRX ODTs is running. According (or under or based on) a first case/scenario, the first DRX active time may be when the first DRX ODT of the at least two DRX ODTs is running and the second DRX ODT of the at least two DRX ODTs is not running (e.g., only the first DRX ODT of the at least two DRX ODTs is running). According (or under or based on) a second case/scenario, the first DRX active time may be when the at least two DRX ODTs are running.

In one example shown in FIG. 22, the wireless device may, according to (or based on) the second case, receive a first CSI transmission/measurement occasion (e.g., at time/occasion T2) of the one or more CSI transmission/measurement occasions and not receive a second CSI transmission/measurement occasion (e.g., at time/occasion T4) of the one or more CSI transmission/measurement occasions. The wireless device may, according to (or based on) the first case, receive the first CSI transmission/measurement occasion of the one or more CSI transmission/measurement occasions and receive the second CSI transmission/measurement occasion of the one or more CSI transmission/measurement occasions.

Under (or based on) the second case, the wireless device may less frequently receive one or more CSI transmission/measurement occasions, e.g., reducing consumed power of the wireless device for channel/interference measurement and/or increasing DL resources for UL/DL data transmission. The drawback may be a reduced performance of CSI channel/frequency measurement (e.g., for mobility and/or radio link monitoring and/or beam management).

Under (or based on) the first case, the wireless device may more frequently receive one or more CSI transmission/measurement occasions, e.g., increasing consumed power of the wireless device for channel/interference measurement and/or decreasing DL resources for UL/DL data transmission. The benefit may be an improvement in performance of CSI channel/frequency measurement (e.g., for mobility and/or radio link monitoring and/or beam management).

In an example embodiment, the wireless device may determine the first DRX active time (e.g., of the DRX configuration or the first DRX operation or the DRX group), e.g., for receiving the at least one CSI transmission/measurement occasion (e.g., at time/occasion T2) of the one or more CSI transmission/measurement occasions, according to the first case or the second case. The base station may configure the wireless device to determine the first DRX active time based on (or according to) the first case or the second case by considering DL resources for UL/DL data transmission (or control channel transmission) and/or radio link monitoring and/or beam management and/or mobility. The one or more configuration parameters may configure/indicate a first parameter. In response to the first parameter being enabled/configured, the wireless device may determine the first DRX active time (e.g., of the DRX configuration or the first DRX operation or the DRX group), e.g., for receiving the at least one CSI transmission/measurement occasion of the one or more CSI transmission/measurement occasions, according to the first case. In response to the first parameter not being enabled/configured (or being absent or being disabled), the wireless device may determine the first DRX active time (e.g., of the DRX configuration or the first DRX operation or the DRX group), e.g., for receiving the at least one CSI transmission/measurement occasion of the one or more CSI transmission/measurement occasions, according to the second case. For example, the base station may configure the first case or the second case as a default case for determining the first DRX active time (e.g., of the DRX configuration or the first DRX operation or the DRX group), e.g., for receiving the at least one CSI transmission/measurement occasion of the one or more CSI transmission/measurement occasions.

The wireless device may determine the first DRX active time (e.g., of the DRX configuration or the first DRX operation or the DRX group), e.g., for receiving the at least one CSI transmission/measurement occasion (e.g., at time/occasion T2) of the one or more CSI transmission/measurement occasions, according to the first case or the second case by considering at least one of the following: the length of the first DRX ODT of the at least two DRX ODTs (e.g., L1); and/or the length of the second DRX ODT of the at least two DRX ODTs (e.g., L2); and/or the length of the first DRX cycle of the at least two DRX cycles (e.g., D1); and/or the length of the second DRX cycle of the at least two DRX cycles (e.g., D2). For example, L1/L2 may be smaller (or alternatively greater) than a pre-configured (e.g., by the one or more configuration parameters) first threshold. For example, L1/D2 may be greater (or alternatively smaller) than a pre-configured (e.g., by the one or more configuration parameters) second threshold. In another example, D1/D2 may be smaller (or alternatively greater) than a pre-configured (e.g., by the one or more configuration parameters) third threshold. In some implementations, L1/D1 may be larger (or alternatively smaller) than a pre-configured (e.g., by the one or more configuration parameters) fourth threshold. In some implementations, L1 (or L2) may be larger (or alternatively smaller) than a pre-configured (e.g., by the one or more configuration parameters) fifth threshold. In some other implementations, D1 (or D2) may be larger (or alternatively smaller) than a pre-configured (e.g., by the one or more configuration parameters) sixth threshold. Although several examples are provided here, other similar examples based on different combinations of L1, L2, D1, and D2 (and/or other DRX parameters) may be applicable.

In an example embodiment, as shown in FIG. 21, the wireless device may transmit the report via/using an occasion (or a report occasion) of the at least one occasion based on the occasion being in a second DRX active time (e.g., of the DRX configuration or the first DRX operation or the DRX group). According (or under or based on) a third case/scenario, the second DRX active time may be when the first DRX ODT of the at least two DRX ODTs is running and the second DRX ODT of the at least two DRX ODTs is not running (e.g., only the first DRX ODT of the at least two DRX ODTs is running). According (or under or based on) a fourth case/scenario, the second DRX active time may be when the at least two DRX ODTs are running.

For example, the occasion may correspond to a most recent CSI measurement/transmission occasion of the one or more CSI measurement/transmission occasions. In an example, the most recent CSI measurement/transmission occasion may be the first CSI measurement/transmission occasion of the of the one or more CSI measurement/transmission occasions. In another example, the most recent CSI measurement/transmission occasion may be the second CSI measurement/transmission occasion of the of the one or more CSI measurement/transmission occasions. In an example embodiment, the second DRX active time may be when at least one of DRX ODT of the at least two DRX ODTs is running. In an example, the most recent CSI measurement/transmission occasion may be no later than a CSI reference resource (e.g., at time/occasion T5 in FIG. 22). For example, based on the most recent CSI measurement/transmission occasion may be later than the CSI reference resource the wireless device may drop (e.g., not transmit) the report via the occasion.

In one example shown in FIG. 22, the wireless device may, according to (or based on) the fourth case, transmit the report via/using a second report occasion (or a second occasion, e.g., at time/occasion T10 in FIG. 22) of the at least one occasion. For example, the wireless device may avoid/skip transmitting (e.g., not transmit or refrain from transmitting or drop) the report via/using a first report occasion (or a first occasion, e.g., at time/occasion T8 in FIG. 22).

The wireless device may, according to (or based on) the third case, transmit the report via/using the second report occasion of the at least one occasion. For example, the wireless device may transmit the report via/using the first report occasion. As seen in FIG. 22, both the second report occasion of the at least one occasion and the first report occasion of the at least one occasion is occurred (in time domain) no later than the CSI reference resource.

In one implementation, the second DRX active time (e.g., of the DRX configuration or the first DRX operation or the DRX group) may be the first DRX active time (e.g., of the DRX configuration or the first DRX operation or the DRX group), e.g., a same DRX active time is used for receiving the at least one CSI measurement/transmission occasion and the transmission of the report via/using the occasion. In another implementation, the second DRX active time (e.g., of the DRX configuration or the first DRX operation or the DRX group) may be different than the first DRX active time (e.g., of the DRX configuration or the first DRX operation or the DRX group), e.g., a different DRX active time is used for receiving the at least one CSI measurement/transmission occasion compared to a DRX active time that is used for the transmission of the report via/using the occasion.

Under (or based on) the fourth case, the wireless device may less frequently transmit the report (e.g., CSI-RS/SRS report), e.g., reducing consumed power of the wireless device for CSI-RS/SRS reporting. The drawback may be a reduced performance of beam management and/or mobility.

Under (or based on) the third case, the wireless device may more frequently transmit the report, e.g., increasing consumed power of the wireless device for CSI-RS/SRS reporting. The benefit may be an improvement in performance of beam management and/or mobility.

In an example embodiment, the wireless device may determine the second DRX active time (e.g., of the DRX configuration or the first DRX operation or the DRX group), e.g., for transmitting the report, according to the third case or the fourth case. The base station may configure the wireless device to determine the second DRX active time based on (or according to) the third case or the fourth case by considering DL resources for UL/DL data transmission (or control channel transmission) and/or radio link monitoring and/or beam management and/or mobility. The one or more configuration parameters may configure/indicate a second parameter. In response to the second parameter being enabled/configured, the wireless device may determine the second DRX active time (e.g., of the DRX configuration or the first DRX operation or the DRX group), e.g., for transmitting the report, according to the third case. In response to the second parameter not being enabled/configured (or being absent or being disabled), the wireless device may determine the second DRX active time (e.g., of the DRX configuration or the first DRX operation or the DRX group), e.g., for transmitting the report, according to the fourth case. For example, the base station may configure the third case or the fourth case as a default case for determining the second DRX active time (e.g., of the DRX configuration or the first DRX operation or the DRX group), e.g., for transmitting the report.

The wireless device may determine the second DRX active time (e.g., of the DRX configuration or the first DRX operation or the DRX group), e.g., for transmitting the report, according to the third case or the fourth case by considering at least one of the following: the length of the first DRX ODT of the at least two DRX ODTs (e.g., L1); and/or the length of the second DRX ODT of the at least two DRX ODTs (e.g., L2); and/or the length of the first DRX cycle of the at least two DRX cycles (e.g., D1); and/or the length of the second DRX cycle of the at least two DRX cycles (e.g., D2). For example, L1/L2 may be smaller (or alternatively greater) than a pre-configured (e.g., by the one or more configuration parameters) first threshold. For example, L1/D2 may be greater (or alternatively smaller) than a pre-configured (e.g., by the one or more configuration parameters) second threshold. In another example, D1/D2 may be smaller (or alternatively greater) than a pre-configured (e.g., by the one or more configuration parameters) third threshold. In some implementations, L1/D1 may be larger (or alternatively smaller) than a pre-configured (e.g., by the one or more configuration parameters) fourth threshold. In some implementations, L1 (or L2) may be larger (or alternatively smaller) than a pre-configured (e.g., by the one or more configuration parameters) fifth threshold. In some other implementations, D1 (or D2) may be larger (or alternatively smaller) than a pre-configured (e.g., by the one or more configuration parameters) sixth threshold. Although several examples are provided here, other similar examples based on different combinations of L1, L2, D1, and D2 (and/or other DRX parameters) may be applicable.

Some example embodiments may allow balancing consumed power of the wireless device for CSI channel/interference measurement and/or UL/DL spectral efficiency (and/or UL/DL beam management and/or mobility). Some example embodiments may allow balancing consumed power of the wireless device for reporting the SRS/CSI-RS report and/or UL/DL spectral efficiency (and/or UL/DL beam management and/or mobility).

For example, when the wireless device is configured to monitor DCP occasions (e.g., configured via the one or more power saving configuration parameters), e.g., to monitor DCI format 2_6, when a DRX ODT (e.g., the first DRX ODT and/or the second DRX ODT) of the at least two DRX ODTs is not started, the most recent CSI measurement/transmission occasion of the one or more CSI measurement/transmission occasions may occur in the first DRX active time of the first DRX operation. For example, the most recent CSI measurement/transmission occasion of the one or more CSI measurement/transmission occasions may occur during a time duration indicated by the DRX ODT of the at least two DRX ODTs of the first DRX operation outside the first DRX active time (e.g., of the DRX configuration or the first DRX operation or the DRX group). The most recent CSI measurement/transmission occasion of the one or more CSI measurement/transmission occasions may correspond to (or be used) for the report (e.g., a CSI report), e.g., during the second DRX active time (e.g., of the DRX configuration or the first DRX operation or the DRX group). In one example, the CSI report configured by higher layer parameter ps-TransmitOtherPeriodicCSI with the higher layer parameter reportConfigType set to ‘periodic’ and reportQuantity set to quantities other than ‘cri-RSRP’ and ‘ssb-Index-RSRP’. In another example, the CSI report (e.g., for reporting to report L1-RSRP) configured by higher layer parameter ps-TransmitPeriodicL1-RSRP with the higher layer parameter reportConfigType set to ‘periodic’ and reportQuantity set to ‘cri-RSRP’.

In yet another example, the CSI report configured by higher layer parameter ps-TransmitOtherPeriodicCSI with the higher layer parameter reportConfigType set to ‘periodic’ and reportQuantity set to quantities other than ‘cri-RSRP’, ‘ssb-Index-RSRP’, ‘cri-RSRP-Capability[Set] Index’, and/or ‘ssb-Index-RSRP-Capability[Set]Index’. When the DRX ODT of the at least two DRX ODTs of the DRX configuration is not started, the wireless device may transmit the report during the time duration indicated by the DRX ODT of the at least two DRX ODTs of the DRX configuration outside the first DRX active time (e.g., of the DRX configuration or the first DRX operation or the DRX group) based on receiving the at least one CSI measurement/transmission occasion of the one or more CSI measurement/transmission (e.g., for channel measurement and CSI-RS and/or CSI-IM occasion for interference measurement) during the time duration indicated by the DRX ODT of the at least two DRX ODTs of the DRX configuration outside the first DRX active time (e.g., of the DRX configuration or the first DRX operation or the DRX group) no later than the CSI reference resource and may drop the report otherwise.

In yet another example, the CSI report (e.g., for reporting to report L1-RSRP) configured by higher layer parameter ps-TransmitPeriodicL1-RSRP with the higher layer parameter reportConfigType set to ‘periodic’ and reportQuantity set to ‘cri-RSRP’, ‘ssb-Index-RSRP’, ‘cri-RSRP-Capability[Set] Index’, and/or ‘ssb-Index-RSRP-Capability[Set] Index’. When the wireless device is configured to monitor DCP occasions and the DRX ODT of the at least two DRX ODTs of the DRX configuration is not started, the wireless device may transmit the report (e.g., a L1-RSRP report) during the time duration indicated by the DRX ODT of the at least two DRX ODTs of the DRX configuration outside the first DRX active time (e.g., of the DRX configuration or the first DRX operation or the DRX group). When reportQuantity set to ‘cri-RSRP’ or ‘cri-RSRP-Capability[Set]Index’, based on receiving the at least one CSI measurement/transmission occasion of the one or more CSI measurement/transmission (e.g., for channel measurement) during the time duration indicated by the DRX ODT of the at least two DRX ODTs of the DRX configuration outside the first DRX active time (e.g., of the DRX configuration or the first DRX operation or the DRX group) no later than the CSI reference resource, the wireless device may transmit the report (e.g., a L1-RSRP report) and may drop the report otherwise.

In some implementations, the wireless device may not (required to) perform measurement of CSI-RS resources (e.g., receive the at least one CSI transmission/measurement occasion) other than during the first DRX active time for measurements based on CSI-RS-Resource-Mobility. When the wireless device is configured to monitor DCP occasions, the wireless device may not (required to) perform measurements other than during the first DRX active time and during a timer duration indicated by the DRX ODT of the at least two DRX ODTs of the DRX configuration outside the first DRX active time (e.g., of the DRX configuration or the first DRX operation or the DRX group) based on CSI-RS-Resource-Mobility.

In some implementations, when a DRX cycle (e.g., the first DRX cycle and/or the second DRX cycle) of the at least two DRX cycles is larger than a threshold (e.g., 80 msec), the wireless device may not expect the at least one CSI measurement/transmission occasion/resource of the one or more CSI measurement/transmission occasions being available other than during the first DRX active time of the first DRX operation for measurements based on CSI-RS-Resource-Mobility. When the wireless device is configured to monitor DCP occasions and the DRX cycle being larger than the threshold (e.g., 80 msec), the wireless device may not expect that the at least one CSI measurement/transmission occasion/resource of the one or more CSI measurement/transmission occasions being available other than during the first DRX active time and during a time duration indicated by the DRX ODT of the at least two DRX ODTs of the DRX configuration outside the first DRX active time (e.g., of the DRX configuration or the first DRX operation or the DRX group) based on CSI-RS-Resource-Mobility. Otherwise, the wireless device may assume/consider the at least one CSI measurement/transmission occasion/resource of the one or more CSI measurement/transmission occasions being available for measurements based on CSI-RS-Resource-Mobility.

For example, the wireless device may transmit/send/report the report (e.g., a CSI report) based on receiving the at least one CSI transmission/measurement occasion of the one or more CSI measurement/transmission occasions (e.g., for channel measurement and CSI-RS and/or CSI-IM occasion for interference measurement) in the first DRX active time of the first DRX operation no later than the CSI reference resource and may drop the report otherwise. When a CSI-RS Resource Set for channel measurement corresponding to the CSI report is configured with two Resource Groups and/or N Resource Pairs, the wireless device may report/transmit/send the CSI report only if receiving the at least one CSI transmission/measurement occasion of the one or more CSI measurement/transmission occasions for each CSI-RS resource in a Resource Pair of the N Resource Pairs within the same first DRX active time of the first DRX operation no later than the CSI reference resource and may drop the report otherwise.

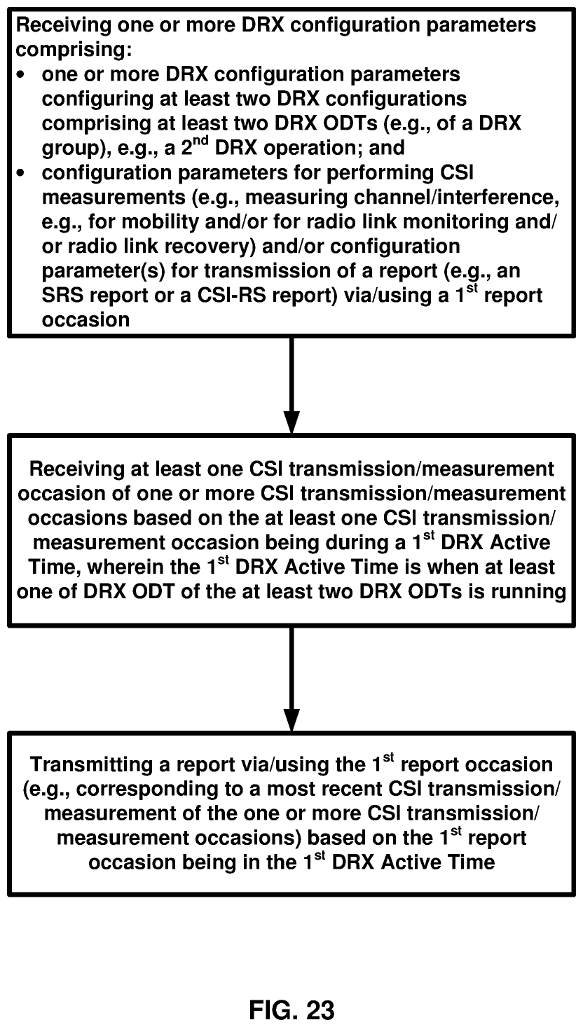

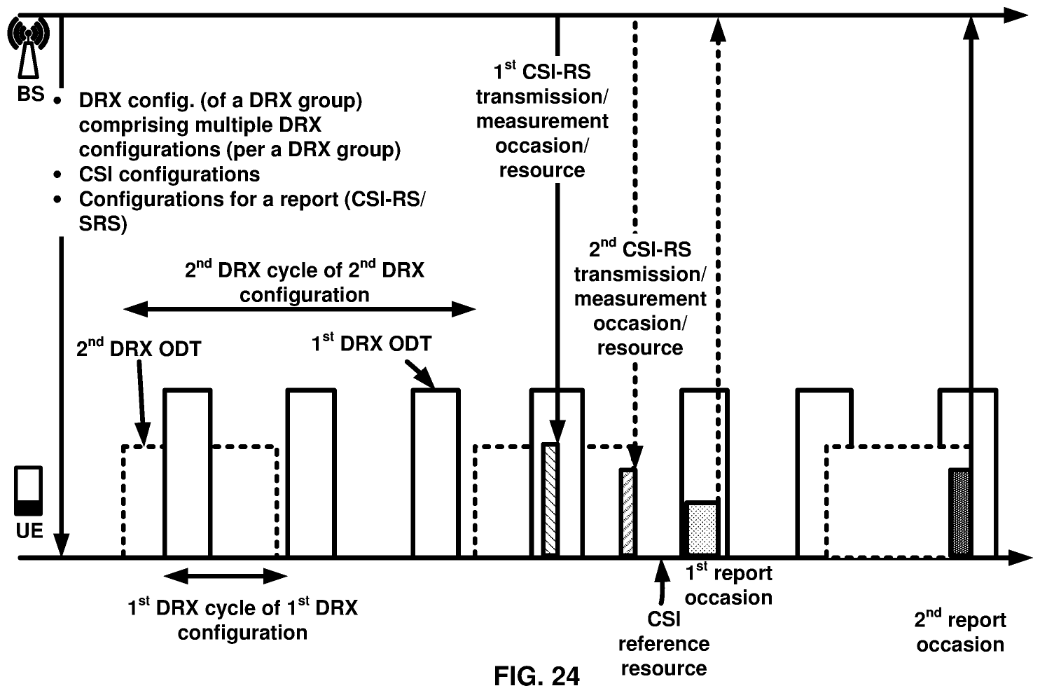

FIG. 23 shows a flowchart of a method/procedure for DRX operation in wireless communication systems. FIG. 24 shows an example embodiment of a DRX operation in wireless communication systems per an aspect of the present disclosure. For example, FIG. 24 may show example implementations of the method/procedure of the FIG. 23 at/in a wireless device (e.g., an XR device) and/or the base station. In some scenarios, FIGS. 23-24 may show example embodiments for determining a DRX active time of a DRX operation or of a DRX group, e.g., when the wireless device is configured with multiple (at least two) DRX configurations per the DRX group. In some other scenarios, FIGS. 23-24 may show a procedure for determining whether to receive at least one CSI-RS channel/interference measurement and/or at least one CSI-IM interference measurement, e.g., when the wireless device is configured with multiple DRX configurations per the DRX group. In some aspect, FIGS. 23-24 may show a procedure for determining whether to transmit/send/report a report (e.g., a CSI-RS report and/or an SRS report), e.g., when the wireless device is configured with multiple DRX configurations per the DRX group. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

As shown in FIG. 23 and FIG. 24, the wireless device may, from the base station, receive the one or more configuration parameters (e.g., the one or more RRC configuration parameters). The one or more configuration parameters may, for example, comprise the one or more serving cell (e.g., the one or more Serving Cells or the one or more cells) configuration parameters (e.g., ServingCellConfigCommon, ServingCellConfigCommonSIB, and/or ServingCellConfig) for configuring one or more cells (e.g., one or more serving cells, e.g., the one or more Serving Cells). The one or more configuration parameters may comprise the one or more BWP configuration parameters (e.g., BWP-DownlinkDedicated IE), e.g., of a downlink (DL) BWP (e.g., initial downlink BWP) of a serving cell and/or of an UL BWP of the serving cell. For example, the one or more configuration parameters may comprise the one or more PDCCH configuration parameters (e.g., for PDCCH of the downlink BWP, e.g., in pdcch-Config IE and/or PDCCH-ServingCellConfig IE applicable for all downlink BWPs of the serving cell).

As shown in FIG. 23 and FIG. 24, the one or more configuration parameters may comprise the one or more DRX configuration parameters. For example, the one or more DRX configuration parameters may configure/comprise at least two DRX configurations (e.g., per a DRX group). The DRX group may be a secondary DRX group or a (primary) DRX group. Hereafter, a DRX operation of FIGS. 23-24 may be referred to by a second DRX implementation/operation. In some cases, the second DRX operation may comprise the first DRX operation. The at least two DRX configurations (e.g., of the DRX group) may correspond to unicast UL/DL transmissions (e.g., not for MBS multicast/broadcast transmissions). For example, a (each) DRX configuration of the at least two DRX configurations may correspond to one or more streams/(QoS) flows/logical channels (e.g., corresponding to video/audio/pose and control data/information). In some cases, the base station may configure the at least two DRX configurations for different PDB requirements of different XR data/traffic, e.g., a first DRX configuration of the at least two DRX configurations for one or more XR traffic flows/streams with a first delay budget (e.g., 10 ms) and a second DRX configuration of the at least two DRX configurations for one or more XR traffic flows/streams with a second delay budget (30 ms). In some examples, a first DRX configuration of the at least two DRX configurations may be an XR-dedicated DRX configuration (e.g., for XR traffic/data) and a second DRX configuration of the at least two DRX configurations may be a non-XR DRX configuration (e.g., not for XR traffic/data).

As shown in example of FIG. 24, each DRX configuration the at least two DRX configurations may have a corresponding DRX cycle (e.g., a first DRX cycle of the first DRX configuration of the at least two DRX configurations and a second DRX cycle of the second DRX configuration of the at least two DRX configurations). For example, each DRX configuration the at least two DRX configurations has a corresponding DRX ODT (e.g., a first DRX ODT of the first DRX configuration of the at least two DRX configurations and a second DRX ODT of the second DRX configuration of the at least two DRX configurations). For example, each DRX configuration the multiple DRX configurations may have corresponding DRX timer(s) (e.g., a DRX inactivity timer (IAT), a DRX retransmission timer for UL/DL, or the like). For example, a first plurality of serving cells (e.g., from/of the one or more serving cells) may correspond to a first DRX configuration and a second plurality of serving cells (e.g., from/of the one or more serving cells) may correspond to a second DRX configuration. The one or more serving cells may correspond to the DRX group that comprises the multiple DRX configuration parameters.

In some implementations, each DRX configuration of the at least two DRX configurations may comprise at least one of the following: a DRX ODT (e.g., drx-onDurationTimer), a DRX cycle, a drx-InactivityTimer, drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, drx-HARQ-RTT-TimerUL, downlinkHARQ-FeedbackDisabled (optional) and uplinkHARQ-Mode (optional). In some scenarios, at least one of the following parameters may be common across the at least two DRX configurations: a drx-InactivityTimer, drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, drx-HARQ-RTT-TimerUL, downlinkHARQ-FeedbackDisabled (optional) and uplinkHARQ-Mode (optional). For example, each DRX configuration the at least two DRX configurations may comprise a separate/corresponding DRX slot offset drx-SlotOffset, e.g., drx-InactivityTimer, drx-RetransmissionTimerDL, drx-RetransmissionTimerUL, drx-LongCycleStartOffset, or the like may be common across the at least two DRX configurations, e.g., per the DRX group. This allows dynamically activating (implicitly by the wireless device and/or explicitly by receiving an activation command) a DRX configuration of the multiple DRX configurations, e.g., based on changes in traffic characteristics (e.g., periodicity) or non-integer periodicity of the XR traffic.

In some examples, each DRX configuration the at least two DRX configurations may correspond to a set/bundle of HARQ processes. For example, as shown in FIG. 24, a first DRX configuration of the at least two DRX configurations has a corresponding first DRX cycle and/or a corresponding first DRX ODT and a second DRX configuration of the at least two DRX configurations has a corresponding second DRX cycle and/or a corresponding second DRX ODT. In the example of FIG. 24, the length of the first DRX ODT is smaller than the length of the second DRX ODT and the second DRX cycle is greater/longer than the first DRX cycle. However, other implementations may be possible, e.g., based on periodicity of XR streams/flows and/or data bursts.

In some implementations, at least one DRX configuration of the at least two DRX configurations may be a dedicated DRX configuration for XR traffic/data. For example, a DRX configuration of the at least two DRX configurations may be used by the wireless device to monitor the PDCCH based on certain RNTIs of the at least one RNTI. For example, a first DRX configuration of the at least two DRX configurations may correspond to a first XR-dedicated RNTI (e.g., a first XR-RNTI and/or a first XR-CS-RNTI, e.g., for video frame transmissions). A second DRX configuration of the at least two DRX configurations may correspond to a second XR-dedicated RNTI (e.g., a second XR-RNTI and/or a second XR-CS-RNTI, e.g., for audio transmissions).

In another example, a first DRX configuration of the at least two DRX configurations may be configured (or be a default DRX configuration) for performing/receiving CSI measurement/transmission occasions and/or transmitting the report. For example, a second DRX configuration of the at least two DRX configurations may be configured (or be a default DRX configuration) for monitoring the PDCCH.

In other implementations, as shown in FIG. 24, the at least two DRX configurations may correspond to different characteristics of XR traffic. For example, a first DRX configuration of the at least two DRX configurations may correspond to a first mode/class/type of the XR traffic (e.g., 30 FPS periodicity) and a second DRX configuration of the at least two DRX configurations may correspond to a second mode/class/type of the XR traffic (e.g., 60 FPS periodicity). In some examples, when application parameters (e.g., XR traffic periodicity, quality of service, PSDB, PSER, or the like) of an XR application/service (e.g., the XR device) changes from a first set of application parameters to a second set of application parameters, the wireless device and/or the base station may activate a second DRX configuration of the at least two DRX configurations and deactivate a first DRX configuration of the at least two DRX configurations. For example, the wireless device may transmit a MAC CE (or a UCI, e.g., via PUCCH) to inform (or indicate to) the base station regarding changes (at the wireless device) from a first set of application parameters to a second set of application parameters (e.g., or activation of the second DRX configuration and/or deactivation of the first DRX configuration).

In some examples, the base station may, corresponding to a first DRX configuration of the at least two DRX configurations, deactivate UL/DL HARQ retransmissions (e.g., semi-statistically for certain streams/flows/logical channels (e.g., pose/control information) or dynamically in response to violation of delay budget of a PDU or a PDU Set), e.g., not starting a drx-HARQ-RTT-TimerUL/DL and/or a DRX-RetransmissionTimerUL/DL after performing a new PUSCH/PDSCH transmission, e.g., when the delay budget of the corresponding PDU or HARQ process being violated (not being satisfied). For example, the base station may, corresponding to a second DRX configuration of the at least two DRX configurations, activate UL/DL HARQ retransmissions, e.g., starting a drx-HARQ-RTT-TimerUL/DL and/or a DRX-RetransmissionTimerUL/DL after performing a new PUSCH/PDSCH transmission.

As shown in FIG. 23 and FIG. 24, the one or more configuration parameters may comprise the one or more CSI configuration parameters and/or the one or more SRS configuration parameters, e.g., for performing CSI-RS/IM measurements (e.g., measuring channel/interference, e.g., for UL/DL beam management and/or mobility) and/or for transmitting the report (e.g., SRS or CSI-RS). The at least one resource/occasion may comprise a first report occasion (or a first occasion/resource) and/or a second report occasion (or a second resource/occasion). For example, the one or more CSI configuration parameters may comprise/indicate the one or more CSI transmission/measurement occasions/resources, e.g., for time/frequency tracking, CSI computation, L1-RSRP computation, L1-SINR computation, mobility, and/or tracking during fast SCell activation. The wireless device may use at least one CSI transmission/measurement occasion/resource of the one or more CSI transmission/measurement occasions/resources to receive CSI-RS transmissions/occasions and/or to perform CSI channel/interference measurements.

In an example embodiment, as shown in FIG. 23, the wireless device may receive at least one CSI transmission/measurement occasion of the one or more CSI transmission/measurement occasions based on the at least one CSI transmission/measurement occasion being during a first DRX active time (e.g., of the second DRX operation or the DRX group). For example, the first DRX active time may be when at least one of DRX ODT of the at least two DRX ODTs (e.g., corresponding to the at least two DRX configurations of the second DRX operation) is running. According (or under or based on) a first case/scenario, the first DRX active time may be when at least one DRX ODT of the at least two DRX ODTs is running. According (or under or based on) a second case/scenario, the first DRX active time may be when the at least two DRX ODTs are (simultaneously) running. According (or under or based on) a third case/scenario, the first DRX active time may be when a default/designated/configured/dedicated DRX ODT, corresponding to a default/designated/configured/dedicated DRX configuration of the at least two DRX configurations, is running. In an example embodiment, the base station may configure (e.g., via the one or more DRX configuration parameters) the default/designated/configured/dedicated DRX configuration (e.g., for receiving/performing the CSI measurement/transmission).

In an example embodiment, the wireless device may determine the default/designated/configured/dedicated DRX configuration (e.g., for receiving/performing the CSI measurement/transmission). For example, the default/designated/configured/dedicated DRX configuration may correspond to a DRX configuration of the at least two DRX configurations with a maximum/greatest DRX ODT of the at least two DRX ODTs (e.g., the second DRX configuration in FIG. 24). For example, the default/designated/configured/dedicated DRX configuration may correspond to a DRX configuration of the at least two DRX configurations with a minimum/smallest DRX ODT length among/from the at least two DRX ODTs (e.g., the first DRX configuration in FIG. 24).

In another example, the default/designated/configured/dedicated DRX configuration may correspond to a DRX configuration of the at least two DRX configurations with a maximum/greatest DRX cycle length among/from the at least two DRX cycles (e.g., the second DRX configuration in FIG. 24). For example, the default/designated/configured/dedicated DRX configuration may correspond to a DRX configuration of the at least two DRX configurations with a minimum/smallest DRX cycle length among/from the at least two DRX cycles (e.g., the first DRX configuration in FIG. 24).

In yet another example, the default/designated/configured/dedicated DRX configuration may correspond to an activated DRX configuration of the at least two DRX configurations. For example, the base station may transmit an activation command (e.g., a DCI and/or a MAC CE and/or an RRC message/signal, e.g., an RRC reconfiguration/setup/release message) activating a DRX configuration of the at least two DRX configurations. For example, the wireless device may, in response to receiving the activation command, activate the DRX configuration and/or deactivate a current active DRX configuration. Prior to receiving the activation command, the current active DRX configuration may be the default/designated/configured/dedicated DRX configuration. After or upon receiving the activation command, the DRX configuration of the at least two DRX configurations indicated by the activation command may be the default/designated/configured/dedicated DRX configuration. In some examples, the current active DRX command may be indicated by the RRC signaling (e.g., the one or more DRX configuration parameters).

In one example shown in FIG. 24, the wireless device may, according to (or based on) the second case (e.g., when both the first DRX ODT and the second DRX ODT are running), receive a first CSI transmission/measurement occasion of the one or more CSI transmission/measurement occasions and not receive a second CSI transmission/measurement occasion of the one or more CSI transmission/measurement occasions. The wireless device may, according to (or based on) the first case (e.g., when only the first DRX ODT is running), receive the first CSI transmission/measurement occasion of the one or more CSI transmission/measurement occasions and receive the second CSI transmission/measurement occasion of the one or more CSI transmission/measurement occasions. In some other examples, the wireless device may, according to (or based on) the first case (e.g., when only the second DRX ODT is running), receive the second CSI transmission/measurement occasion of the one or more CSI transmission/measurement occasions and not receive the first CSI transmission/measurement occasion of the one or more CSI transmission/measurement occasions. In yet other example, the wireless device may, according to (or based on) the first case (e.g., when at least one of the second DRX ODT or the first DRX ODT is running), receive the second CSI transmission/measurement occasion of the one or more CSI transmission/measurement occasions and receive the first CSI transmission/measurement occasion of the one or more CSI transmission/measurement occasions.

Under (or based on) the second case and/or the third case, the wireless device may less frequently receive one or more CSI transmission/measurement occasions, e.g., reducing consumed power of the wireless device for channel/interference measurement and/or increasing DL resources for UL/DL data transmission. The drawback may be a reduced performance of CSI channel/frequency measurement (e.g., for mobility and/or radio link monitoring and/or beam management).

Under (or based on) the first case, the wireless device may more frequently receive one or more CSI transmission/measurement occasions, e.g., increasing consumed power of the wireless device for channel/interference measurement and/or decreasing DL resources for UL/DL data transmission. The benefit may be an improvement in performance of CSI channel/frequency measurement (e.g., for mobility and/or radio link monitoring and/or beam management).

The base station may configure the wireless device to determine the first DRX active time based on (or according to) the first case or the second case or the third case. The one or more configuration parameters may configure/indicate a first parameter (e.g., 2 bits). For example, the first parameter with a value of ‘00’ may indicate determination of the first DRX active time based on (or according to) the first case; or with a value of ‘01’ may indicate determination of the first DRX active time based on (or according to) the second case; or with a value of ‘10’ may indicate determination of the first DRX active time based on (or according to) the third case.

In an example embodiment, as shown in FIG. 23 and FIG. 24, the wireless device may transmit the report via/using an occasion (or a report occasion, e.g., a first report occasion and/or a second report occasion) of the at least one occasion based on the occasion being in the first DRX active time (e.g., of the second DRX operation or the DRX group).

For example, the occasion may correspond to a most recent CSI measurement/transmission occasion of the one or more CSI measurement/transmission occasions. In an example, the most recent CSI measurement/transmission occasion may be the first CSI measurement/transmission occasion of the of the one or more CSI measurement/transmission occasions. In another example, the most recent CSI measurement/transmission occasion may be the second CSI measurement/transmission occasion of the of the one or more CSI measurement/transmission occasions. In an example, as shown in FIG. 24, the most recent CSI measurement/transmission occasion may be no later than a CSI reference resource. For example, based on the most recent CSI measurement/transmission occasion may be later than the CSI reference resource the wireless device may drop (e.g., not transmit) the report via the occasion. As seen in FIG. 24, both the second report occasion of the at least one occasion and the first report occasion of the at least one occasion is occurred (in time domain) no later than the CSI reference resource.

In one example shown in FIG. 24, the wireless device may, according to (or based on) the first case, transmit the report via/using the second report occasion of the at least one occasion and/or the first report occasion of the at least one occasion. In some examples, the wireless device may, according to (or based on) the first case, transmit the report via/using only the second report occasion of the at least one occasion or the first report occasion of the at least one occasion. For example, the wireless device may avoid/skip transmitting (e.g., not transmit or refrain from transmitting or drop) the report via/using the first report occasion (e.g., when the second DRX ODT is running). The wireless device may, according to (or based on) the second case, transmit the report via/using the second report occasion of the at least one occasion (e.g., when both the second DRX ODT and the first DRX ODT are running). The wireless device may, according to (or based on) the third case, transmit the report via/using either the second report occasion of the at least one occasion or the first report occasion of the at least one occasion (e.g., depending on which of the first DRX configuration and the second DRX configuration is the default/designated/dedicated DRX configuration).

Under (or based on) the second case and the third case, the wireless device may less frequently transmit the report (e.g., CSI-RS/SRS report), e.g., reducing consumed power of the wireless device for CSI-RS/SRS reporting. The drawback may be a reduced performance of beam management and/or mobility. Under (or based on) the first case, the wireless device may more frequently transmit the report, e.g., increasing consumed power of the wireless device for CSI-RS/SRS reporting. The benefit may be an improvement in performance of beam management and/or mobility.

Some example embodiments may allow balancing consumed power of the wireless device for CSI channel/interference measurement and/or UL/DL spectral efficiency (and/or UL/DL beam management and/or mobility). Some example embodiments may allow balancing consumed power of the wireless device for reporting the SRS/CSI-RS report and/or UL/DL spectral efficiency (and/or UL/DL beam management and/or mobility).

For example, when the wireless device is configured to monitor DCP occasions (e.g., configured via the one or more power saving configuration parameters), e.g., to monitor DCI format 2_6, when a DRX ODT of the at least two DRX ODTs is not started, the most recent CSI measurement/transmission occasion of the one or more CSI measurement/transmission occasions may occur in the first DRX active time of the second DRX operation. The DRX ODT may correspond to the default/dedicated/designated DRX configuration. For example, the DRX ODT may be at least one of the at least two DRX ODTs, e.g., the first DRX ODT and/or the second DRX ODT. For example, the most recent CSI measurement/transmission occasion of the one or more CSI measurement/transmission occasions may occur during a time duration indicated by the DRX ODT of the at least two DRX ODTs of the second DRX operation outside the first DRX active time (e.g., of the second DRX operation or the DRX group). The most recent CSI measurement/transmission occasion of the one or more CSI measurement/transmission occasions may correspond to (or be used) for the report (e.g., a CSI report), e.g., during the first DRX active time (e.g., of the second DRX operation or the DRX group). In one example, the CSI report configured by higher layer parameter ps-TransmitOtherPeriodicCSI with the higher layer parameter reportConfigType set to ‘periodic’ and reportQuantity set to quantities other than ‘cri-RSRP’ and ‘ssb-Index-RSRP’. In another example, the CSI report (e.g., for reporting to report L1-RSRP) configured by higher layer parameter ps-TransmitPeriodicL1-RSRP with the higher layer parameter reportConfigType set to ‘periodic’ and reportQuantity set to ‘cri-RSRP’.

In yet another example, the CSI report configured by higher layer parameter ps-TransmitOtherPeriodicCSI with the higher layer parameter reportConfigType set to ‘periodic’ and reportQuantity set to quantities other than ‘cri-RSRP’, ‘ssb-Index-RSRP’, ‘cri-RSRP-Capability[Set]Index’, and/or ‘ssb-Index-RSRP-Capability[Set]Index’. When the DRX ODT of the at least two DRX ODTs of the DRX configuration is not started, the wireless device may transmit the report during the time duration indicated by the DRX ODT of the at least two DRX ODTs of the second DRX operation outside the first DRX active time (e.g., of the second DRX operation or the DRX group) based on receiving the at least one CSI measurement/transmission occasion of the one or more CSI measurement/transmission (e.g., for channel measurement and CSI-RS and/or CSI-IM occasion for interference measurement) during the time duration indicated by the DRX ODT of the at least two DRX ODTs of the second DRX operation outside the first DRX active time (e.g., of the second DRX operation or the DRX group) no later than the CSI reference resource and may drop the report otherwise.

In yet another example, the CSI report (e.g., for reporting to report L1-RSRP) configured by higher layer parameter ps-TransmitPeriodicL1-RSRP with the higher layer parameter reportConfigType set to ‘periodic’ and reportQuantity set to ‘cri-RSRP’, ‘ssb-Index-RSRP’, ‘cri-RSRP-Capability[Set]Index’, and/or ‘ssb-Index-RSRP-Capability[Set]Index’. When the wireless device is configured to monitor DCP occasions and the DRX ODT of the at least two DRX ODTs of the second DRX operation is not started, the wireless device may transmit the report (e.g., a L1-RSRP report) during the time duration indicated by the DRX ODT of the at least two DRX ODTs of the second DRX operation outside the first DRX active time (e.g., of the second DRX operation or the DRX group). When reportQuantity set to ‘cri-RSRP’ or ‘cri-RSRP-Capability[Set]Index’, based on receiving the at least one CSI measurement/transmission occasion of the one or more CSI measurement/transmission (e.g., for channel measurement) during the time duration indicated by the DRX ODT of the at least two DRX ODTs of the second DRX operation outside the first DRX active time (e.g., of the second DRX operation or the DRX group) no later than the CSI reference resource, the wireless device may transmit the report (e.g., a L1-RSRP report) and may drop the report otherwise.

In some implementations, the wireless device may not (required to) perform measurement of CSI-RS resources (e.g., receive the at least one CSI transmission/measurement occasion) other than during the first DRX active time for measurements based on CSI-RS-Resource-Mobility. When the wireless device is configured to monitor DCP occasions, the wireless device may not (required to) perform measurements other than during the first DRX active time and during a timer duration indicated by the DRX ODT of the at least two DRX ODTs of the second DRX operation outside the first DRX active time (e.g., of the second DRX operation or the DRX group) based on CSI-RS-Resource-Mobility.

In some implementations, when a DRX cycle (e.g., the first DRX cycle and/or the second DRX cycle) of the at least two DRX cycles of the second DRX operation is larger than a threshold (e.g., 80 msec), the wireless device may not expect the at least one CSI measurement/transmission occasion/resource of the one or more CSI measurement/transmission occasions being available other than during the first DRX active time of the second DRX operation for measurements based on CSI-RS-Resource-Mobility. When the wireless device is configured to monitor DCP occasions and the DRX cycle being larger than the threshold (e.g., 80 msec), the wireless device may not expect that the at least one CSI measurement/transmission occasion/resource of the one or more CSI measurement/transmission occasions being available other than during the first DRX active time of the second DRX operation and during a time duration indicated by the DRX ODT of the at least two DRX ODTs of the second DRX operation outside the first DRX active time (e.g., of the second DRX operation or the DRX group) based on CSI-RS-Resource-Mobility. Otherwise, the wireless device may assume/consider the at least one CSI measurement/transmission occasion/resource of the one or more CSI measurement/transmission occasions being available for measurements based on CSI-RS-Resource-Mobility.

For example, the wireless device may transmit/send/report the report (e.g., a CSI report) based on receiving the at least one CSI transmission/measurement occasion of the one or more CSI measurement/transmission occasions (e.g., for channel measurement and CSI-RS and/or CSI-IM occasion for interference measurement) in the first DRX active time of the second DRX operation no later than the CSI reference resource and may drop the report otherwise. When a CSI-RS Resource Set for channel measurement corresponding to the CSI report is configured with two Resource Groups and/or N Resource Pairs, the wireless device may report/transmit/send the CSI report only if receiving the at least one CSI transmission/measurement occasion of the one or more CSI measurement/transmission occasions for each CSI-RS resource in a Resource Pair of the N Resource Pairs within the same first DRX active time of the second DRX operation no later than the CSI reference resource and may drop the report otherwise.

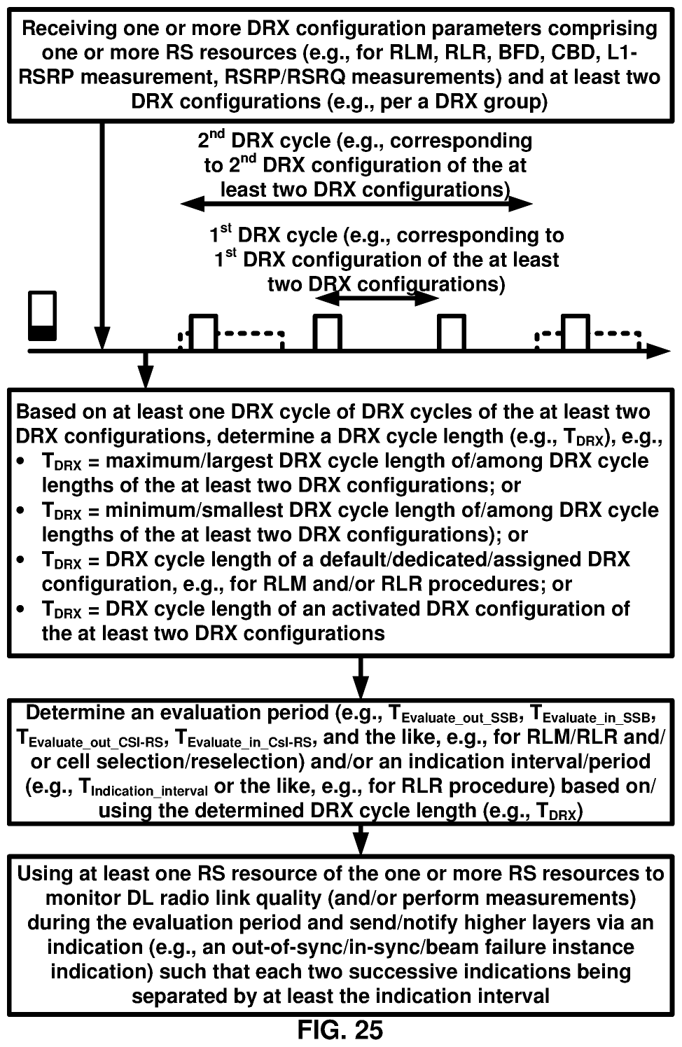

FIG. 25 shows a flowchart of a radio link monitoring/recovery method/procedure during a DRX operation in wireless communication systems per an aspect of the present disclosure. For example, FIG. 25 may show an implementation of a beam failure detection (BFD) procedure and/or candidate beam detection (CBD) and/or a radio link recovery (RLR) procedure at/in a wireless device (e.g., an XR device) and/or the base station. In some scenarios, FIG. 25 may show example embodiments for determining an evaluation period for assessing/measuring/monitoring a downlink radio link quality, e.g., when the wireless device is configured with at least two DRX configurations. In some other scenarios, when the wireless device is configured with at least two DRX configurations, FIG. 25 may show example embodiments for determining an indication interval/period for sending/indicating out-of-sync/in-sync/beam failure indications from the physical layer of the wireless device to the higher layers for radio link monitoring/recovery procedure. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

As shown in FIG. 25, the wireless device may, from the base station, receive the one or more configuration parameters. The one or more configuration parameters may, for example, comprise the one or more serving cell (e.g., the one or more Serving Cells or the one or more cells) configuration parameters (e.g., ServingCellConfigCommon, ServingCellConfigCommonSIB, and/or ServingCellConfig) for configuring one or more cells (e.g., one or more serving cells, e.g., the one or more Serving Cells). The one or more configuration parameters may comprise the one or more BWP configuration parameters (e.g., BWP-DownlinkDedicated IE), e.g., of a downlink (DL) BWP (e.g., initial downlink BWP) of a serving cell and/or of an UL BWP of the serving cell. For example, the one or more configuration parameters may comprise the one or more PDCCH configuration parameters (e.g., for PDCCH of the downlink BWP, e.g., in pdcch-Config IE and/or PDCCH-ServingCellConfig 1E applicable for all downlink BWPs of the serving cell). As shown in FIG. 25, the one or more configuration parameters may comprise the one or more DRX configurations. For example, the one or more DRX configuration parameters may configure the at least two DRX configurations (e.g., per the DRX group), e.g., the second DRX operation as discussed in FIG. 23 and/or FIG. 24.

The one or more configuration parameters may, for example, comprise one or more radio link monitoring (RLM) configuration parameters. The one or more RLM configuration parameters may comprise at least one of: beamFailureRecoveryConfig, and/or beamFailureRecoverySpCellConfig, and/or beamFailureRecoverySCellConfig and/or the radioLinkMonitoringConfig. For example, the one or more RLM configuration parameters may configure/indicate one or more RS resources (e.g., for performing RLM procedure, and/or radio link recovery procedure (or beam failure recovery procedure), and/or beam failure detection procedure), and/or L1-RSRP measurement, or the like. In some implementations, the radio link recovery procedure may comprise (or may be) a Beam Failure Detection and Recovery procedure.

The one or more RS configuration parameters may comprise/indicate/configure RS resources for RLM procedure (e.g., via one or more RLM-RS resources). The RLM procedure may be a relaxed RLM procedure (e.g., when the wireless device supports rlm-Relaxation-r17 and/or configured with explicit signaling goodServingCellEvaluationRLM). For example, the one or more RS resources may comprise RS resources for radio link recovery procedure, e.g., BFD (e.g., via one or more BFD-RS resources) and/or CBD procedures. The wireless device may use the one or more RS resources to monitor downlink radio link quality, e.g., based on reference signals (RSs) configured/indicated by one or more RS resources. In an example, the one or more RLM configuration parameters may comprise the one or more RS resources. For example, the one or more RS resources may comprise one or more CSI-RS resources.

The wireless device may monitor downlink radio link quality in order to detect the downlink radio link quality of a serving cell (e.g., a PCell, PSCell and deactivated PSCell if configured with bfd-and-RLM with value true). In an example, the one or more RS resources may comprise one or more (e.g., all) SSBs, or one or more (all) CSI-RSs (e.g., configured via the one or more CSI configuration parameters), or a mix of SSBs and CSI-RSs. For example, downlink radio link quality may comprise (or correspond to) the one or more (e.g., all) SSBs, or the one or more (all) CSI-RSs, or the mix of SSBs and CSI-RSs. For example, for an FR1 serving cell and/or an FR2 serving cell, an SSB of the one or more SSBs (e.g., configured by the one or more RS resources) may be for RLM, RLR, BFD, CBD or L1-RSRP measurement. For example, for an FR1 serving cell and/or an FR2 serving cell, a CSI-RS resource of the one or more CSI-RSs (e.g., configured by the one or more RS resources) may be for RLM, RLR, BFD, CBD or L1-RSRP measurement.

The wireless device may monitor downlink radio link quality of the serving cell of the one or more serving cells (e.g., a primary cell), e.g., for the purpose of indicating out-of-sync/in-sync/beam failure detection status/indication to higher layers (e.g., MAC/RRC layer) of the wireless device. For example, wireless device may monitor downlink radio link quality of the serving cell (e.g., the PSCell) in the (active) DL BWP. The MAC entity/layer of the wireless device may be configured by RRC (e.g., via the one or more RLM configuration parameters), e.g., per the serving cell, with the beam failure recovery procedure. Based on the beam failure recovery procedure the wireless device may indicate to the (serving) base station of a new SSB or CSI-RS (e.g., configured via the one or more RS resources) when beam failure is detected (e.g., BFD procedure) on the serving SSB(s)/CSI-RS(s) configured by the one or more RS resources. Beam failure is detected by counting beam failure instance indication from the lower layers (e.g., the layer 1/physical layer of the wireless device) to the MAC entity/layer of the wireless device.

For example, the wireless device may perform radio link monitoring (RLM) using an associated SS/PBCH block when the associated SS/PBCH block index is provided by the one or more RLM configuration parameters (e.g., RadioLinkMonitoringRS), e.g., when the active DL BWP is the initial DL BWP and for SS/PBCH block and CORESET multiplexing pattern 2 or 3. In an example, when the one or more serving cells comprise a SCG, and the one or more RLM configuration parameters configure/indicate rlf-TimersAndConstants (e.g., when is not set to release), the wireless device may monitor the downlink radio link quality of the PSCell of the SCG, e.g., for the purpose of indicating out-of-sync/in-sync status to the higher layers (e.g., MAC/RRC layer) of the wireless device.

For example, the one or more RLM configuration parameters (e.g., the one or more RS resources) may, for the (or each) DL BWP of the serving cell (e.g., a SpCell), comprise a set of resource indexes (e.g., through a corresponding set of RadioLinkMonitoringRS) for radio link monitoring by failureDetectionResources. A resource index of the set of resource indexes may be a CSI-RS resource configuration index, by csi-RS-Index, or a SS/PBCH block index, by ssb-Index. For example, the one or more RS resources may configure the wireless device with up to NLR-RLM RadioLinkMonitoringRS for link recovery procedures and for radio link monitoring, the wireless device may, from the NLR-RLM RadioLinkMonitoringRS, use up to NRLM RadioLinkMonitoringRS the radio link monitoring. For example, the wireless device may use up to two RadioLinkMonitoringRS of the NLR-RLM RadioLinkMonitoringRS for link recovery procedures. The wireless device may determine parameters NLR-RLM and NRLM based on Lmax, where Lₘₐₓ is a maximum number of SS/PBCH block indexes in a cell, and the maximum number of transmitted SS/PBCH blocks within a half frame is Lₘₐₓ. For example, for Lmax=4, NLR-RLM=2 and NRLM=2.

In some implementations, the set of resource indexes may be TCI states that is used/configured for reception of PDCCH, e.g., when the one or more RLM configuration parameters do not comprise RadioLinkMonitoringRS. For example, the wireless device may use a CSI-RS configured by an active TCI state of the TCI states (e.g., an RS provided for an active TCI state for PDCCH reception) for radio link monitoring based on the active TCI state for PDCCH reception includes only one RS. When the active TCI state for PDCCH reception includes two RS, the wireless device may expect that one RS of the two RS being configured with qcl-Type set to ‘typeD’ and the wireless device may use the RS configured with qcl-Type set to ‘typeD’ for radio link monitoring.

The one or more RS resources may, for the (each) DL BWP of the serving cell, provide/configure/indicate a set q̅₀ of periodic CSI-RS resource configuration indexes by failureDetectionResourcesToAddModList and/or a set q̅₁ of periodic CSI-RS resource configuration indexes and/or SS/PBCH block indexes by candidateBeamRSList or candidateBeamRSListExt or candidateBeamRSSCellList for radio link quality measurements on the DL BWP of the serving cell. In some examples, instead of the sets q̅₀ and q̅₁, for the (each) DL BWP of the serving cell, the one or more RLM configuration parameters may configure/indicate respective two sets q̅_{0,0} and q̅_{0,1} of periodic CSI-RS resource configuration indexes by failureDetectionSet1 and failureDetectionSet2 and/or corresponding two sets q̅_{1,0} and q̅_{1,1} of periodic CSI-RS resource configuration indexes and/or SS/PBCH block indexes by candidateBeamRSList1 and candidateBeamRSList2, respectively, for radio link quality measurements on the DL BWP of the serving cell. The set q̅_{0,0} may be associated with the set q̅_{1,0} and the set q̅_{0,1} may be associated with the set q̅_{1,1}.

When the wireless device is not provided q̅₀ by failureDetectionResourcesToAddModList for a BWP of the serving cell, the wireless device may determine the set q̅₀ to include periodic CSI-RS resource configuration indexes (e.g., provided by the one or more CSI configuration parameters) with same values as the RS indexes in the RS sets indicated by TCI-State for respective CORESETs that the wireless device uses for monitoring PDCCH. When the UE is not provided q̅_{0,0} and q̅_{0,1} for a BWP of the serving cell, the wireless device may determine the set q̅_{0,0} and q̅_{0,1} to include periodic CSI-RS resource configuration indexes (e.g., provided by the one or more CSI configuration parameters) with same values as the RS indexes in the RS sets indicated by TCI-State for first and second CORESETs that the wireless device uses for monitoring PDCCH, respectively, where the UE is provided two coresetPoolIndex values 0 and 1 for the first and second CORESETs, or is not provided coresetPoolIndex value for the first CORESETs and is provided coresetPoolIndex value of 1 for the second CORESETs, respectively. If there are two RS indexes in a TCI state, the set q̅₀ or q̅_{0,0}, or q̅_{0,1} includes RS indexes configured with qcl-Type set to ‘typeD’ for the corresponding TCI states. If a CORESET that the wireless device uses for monitoring PDCCH includes two TCI states and the wireless device is provided sfnSchemePdcch set to ‘sfnSchemeA’ or ‘sfnSchemeB’, the set q̅₀ includes RS indexes in the RS sets associated with the two TCI states.

The wireless device may expect the set q̅₀ to include up to two RS indexes. If the wireless device is provided q̅_{0,0} or q̅_{0,1}, the UE expects the set q̅_{0,0} or the set q̅_{0,1} to include up to a number of N_{BFD} RS indexes indicated by maxBFD-RS-resourcesPerSetPerBWP. If the wireless device is not provided q̅_{0,0} or q̅_{0,1}, and if a number of active TCI states for PDCCH receptions in the first or second CORESETs is larger than N_{BFD}, the wireless device may determine the set q̅_{0,0} or q̅_{0,1} to include periodic CSI-RS resource configuration indexes (e.g., provided by the one or more CSI configuration parameters) with same values as the RS indexes in the RS sets associated with the active TCI states for PDCCH receptions in the first or second CORESETs corresponding to search space sets according to an ascending order for PDCCH monitoring periodicity. If more than one first or second CORESETs correspond to search space sets with same monitoring periodicity, the wireless device may determine the order of the first or second CORESETs according to a descending order of a CORESET index.

In an example, to perform RLM/RLR, on each RS of the one or more RS resources, the wireless device may estimate/measure/evaluate the downlink radio link quality and determine whether the downlink radio link quality satisfies a threshold or not. For example, to determine whether the downlink radio link quality satisfies the threshold, the wireless device may compare the downlink radio link quality against a first threshold. For example, to determine whether the downlink radio link quality satisfies the threshold, the wireless device may compare the downlink radio link quality against a second threshold.

For example, on each RS resource in the set q̅₀ of the one or more RS resources, the wireless device may estimate/measure/evaluate the downlink radio link quality and compare it to the first threshold (e.g., Qout_LR) for the purpose of accessing downlink radio link quality of the serving cell beams.

For example, on each RS resource of the one or more RS resources, the wireless device may, e.g., to determine whether the downlink radio link quality satisfies the threshold, estimate the downlink radio link quality and compare it to the first threshold (e.g., Qout and/or Qout,LR and/or Qout_SSB and/or Qout_CSI-RS and/or Qout, RedCap and/or Qout, CCA and/or Qout_SSB,CCA or the like) and/or the second threshold (e.g., Qin and/or Qin,LR and/or Qin_SSB and/or Qin_CSI-RS and/or Qin,CCA and/or Qin_SSB,CCA and/or Qin, RedCap or the like) for the purpose of monitoring downlink radio link quality of the cell. For example, the first threshold and/or the second threshold may be used (by the wireless device) for RLM procedure and/or link recovery procedure (e.g., beam failure detection and recovery procedure). The first threshold may be defined as the level at which the downlink radio link cannot be reliably received and may correspond to an out-of-sync block error rate (e.g., BLERout and/or BLERout, CCA or the like). For SSB based radio link monitoring, the wireless device may derive/calculate/estimate the first threshold, e.g., Qout_SSB, based on hypothetical PDCCH transmission parameters. For CSI-RS based radio link monitoring, the wireless device may derive/calculate/estimate the first threshold, e.g., Qout_CSI-RS, based on hypothetical PDCCH transmission parameters. The second threshold may be defined as the level at which the downlink radio link quality can be received with significantly higher reliability than at the threshold and may correspond to an in-sync block error rate (e.g., BLERin and/or BLERin, CCA or the like). For example, for SSB based radio link monitoring, the wireless device may derive/calculate/estimate the second threshold, e.g., Qin_SSB, based on hypothetical PDCCH transmission parameters. For CSI-RS based radio link monitoring, the wireless device may derive/calculate/estimate the second threshold, e.g., Qin_CSI-RS, based on hypothetical PDCCH transmission parameters. In an example, the wireless device may determine based on/via the one or more RLM configuration parameters (e.g., via parameter rlmInSyncOutOfSync Threshold) the out-of-sync block error rate (e.g., BLERout) and/or the in-sync block error rate (e.g., BLERin). For example, the one or more RLM configuration parameters (e.g., via parameter rlmInSyncOutOfSyncThreshold) indicate the out-of-sync block error rate (e.g., BLERout) and the in-sync block error rate (e.g., BLERin). When the parameter rlmInSyncOutOfSyncThreshold is not configured (e.g., via the one or more RLM configuration parameters), the wireless device may determine the out-of-sync block error rate (e.g., BLERout) and the in-sync block error rate (e.g., BLERin) based on a pre-defined/pre-configured configurations/rule.

The first threshold (e.g., Qout_LR and/or Qout_LR_SSB and/or Qout_LR_CSI-RS and/or Qout_LR_SSB,CCA or the like) may be defined as the level at which the downlink radio level link of a given resource configuration on the set q̅₀ of the one or more RS resources cannot be reliably received and may correspond to the out-of-sync block error rate BLERout=10% (or BLERout, CCA=10%) block error rate of a hypothetical PDCCH transmission. For example, the wireless device may send/deliver configuration indexes from the set q̅₁ of the one or more RS resources to higher layers (e.g., RRC/MAC) of the wireless device and the corresponding L1-RSRP measurement provided that the measured L1-RSRP is equal to or better than the second threshold (e.g., Qin_LR and/or Qin_LR,CCA) which is indicated by higher layer parameter rsrp-ThresholdSSB.

The physical layer in the wireless device may assess/estimate/measure the downlink radio link quality according to the one or more RLM resources (e.g., the set q̅₀, q̅_{0,0}, or q̅_{0,1}) against the first threshold (e.g., Qout,LR) and/or the second threshold (e.g., Qin,LR). For the set q̅₀, the wireless device may assess the downlink radio link quality (only) according to SS/PBCH blocks (of the one or more RLM resources) on the PCell or the PSCell or periodic CSI-RS resource configurations that are quasi co-located with the DM-RS of PDCCH receptions by the wireless device. The wireless device may apply the second threshold (e.g., Qin,LR) to an L1-RSRP measurement obtained from a SS/PBCH block of the one or more RLM resources. The wireless device may, for example, apply the second threshold (e.g., Qin,LR) to the L1-RSRP measurement obtained for a CSI-RS resource of the one or more RLM resources after scaling a respective CSI-RS reception power with a value provided by powerControlOffsetSS.

In an example, the physical layer in the wireless device may provide/indicate/send an indication to higher layers (e.g., MAC/RRC layer) of the wireless device based on/when the downlink radio link quality for (all) corresponding resource configurations that the wireless device uses to assess the radio link quality (e.g., in the set q̅₀, or in the set q̅_{0,0} or q̅_{0,1}) being worse than the first threshold (e.g., Qout,LR). The physical layer of the wireless device may inform the higher layers (e.g., MAC/RRC layer) of the wireless device when the downlink radio link quality is worse than the first threshold (e.g., Qout,LR) with a periodicity determined by the maximum between the shortest periodicity among the one or more RLM resources (e.g., SS/PBCH blocks on the PCell or the PSCell and/or the periodic CSI-RS configurations in the set q̅₀, q̅_{0,0}, or q̅_{0,1}) and a first value (e.g., 2 msec).

As shown in FIG. 25, the wireless device may estimate/calculate/measure/monitor downlink radio link quality on a first RS resource (e.g., SSB and/or CSI-RS) of the one or more RS resources over one or more evaluation periods (e.g., TEvaluate_out_SSB and/or TEvaluate_BFD_SSB and/or TEvaluate_CBD_CSI-RS or the like). An evaluation period of the one or more evaluation periods may be used (e.g., by the wireless device) for RLM procedure and/or link recovery procedure and/or BFD procedure. For example, an evaluation period may be RLM procedure, e.g., a first evaluation period (e.g., TEvaluate_out_SSB and/or TEvaluate_out_SSB_Relax and/or TEvaluate_out_CSI-RS and/or TEvaluate_out_CSI-RS_Relax and/or TEvaluate_out_SSB,CCA and/or TEvaluate_out_SSB,RedCap and/or TEvaluate_out_CSI-RS, RedCap) in milliseconds/slots/subframes/symbols. The evaluation period may be used for an RLM procedure, e.g., a second evaluation period (e.g., TEvaluate_in_SSB and/or TEvaluate_in_SSB_Relax and/or TEvaluate_in_CSI-RS and/or TEvaluate_in_CSI-RS_Relax and/or TEvaluate_in_SSB,CCA and/or TEvaluate_in_SSB, RedCap and/or TEvaluate_in_CSI-RS, RedCap or the like) in milliseconds/slots/subframes/symbols. An evaluation period may be used for the BFD procedure and/or the radio link recovery procedure (e.g., TEvaluate_BFD_SSB and/or TEvaluate_CBD_CSI-RS and/or TEvaluate_BFD_SSB_CCA or the like). For example, the first evaluation period may be a last/final/latest evaluation period among/from one or more first evaluation periods. For example, the second evaluation period may be a last/final/latest evaluation period among/from one or more second evaluation periods. The wireless device may, for example, estimate/calculate/measure/monitor downlink radio link quality on a second RS resource (e.g., the first RS resource) of the one or more RS resources over a second evaluation period (e.g., TEvaluate_in_SSB and/or TEvaluate_in_SSB_Relax and/or TEvaluate_in_CSI-RS and/or TEvaluate_in_CSI-RS_Relax and/or TEvaluate_in_SSB,CCA and/or TEvaluate_in_SSB,RedCap and/or TEvaluate_in_CSI-RS,RedCap or the like) in milliseconds/slots/subframes/symbols.

For example, within/during the evaluation period, the wireless device may measure SS-RSRP and SS-RSRQ level of the serving cell and evaluate a cell selection criterion S (e.g., when the wireless device is in the RRC_INACTIVE/IDLE state), e.g., for cell selection/reselection (e.g., intra-frequency NR cells, and/or inter-frequency NR cells, and/or inter-RAT E-UTRAN cells, or the like).

The wireless device may evaluate/asses/determine (or may be able to evaluate/asses/determine) whether the downlink radio link quality on the first RS resource of the one or more RS resources (e.g., estimated over an evaluation period, e.g., the first evaluation period) becomes worse than the first threshold (e.g., Qout_SSB) within/during the evaluation period, e.g., whether the downlink radio link quality on the first RS resource of the one or more RS resources is smaller/lower than the first threshold (e.g., within/during the evaluation period) or not.

The wireless device may evaluate/asses/determine (or may be able to evaluate/asses/determine) whether the downlink radio link quality on the second RS resource of the one or more RS resources (e.g., estimated over an evaluation period, e.g., the second evaluation period) becomes better than the second threshold (e.g., Qin_SSB) within/during the evaluation period, e.g., whether the downlink radio link quality on the second RS resource of the one or more RS resources is greater/larger than the second threshold (e.g., within/during the evaluation period) or not. For example, the wireless device may evaluate/asses/determine (or may be able to evaluate/asses/determine) whether the L1-RSRP measured on a SSB resource in set q̅₁ of the one or more RS estimated over the evaluation period (e.g., TEvaluate_CBD_SSB) becomes better than the second threshold (e.g., Qin_LR).

An evaluation period (e.g., the first evaluation period and/or the second evaluation period) may be for (or correspond to) an FR1 serving cell, and/or FR2 (e.g., FR2-1 and/or FR2-2) serving cell, and/or a deactivated PSCell. The evaluation period may be for the RLM procedure, e.g., TEvaluate_out_SSB and/or TEvaluate_out_SSB_Relax and/or TEvaluate_out_CSI-RS and/or TEvaluate_out_CSI-RS_Relax and/or TEvaluate_out_SSB,CCA and/or TEvaluate_out_SSB, RedCap and/or TEvaluate_out_CSI-RS,RedCap. In some cases, the evaluation period may be for link recovery procedure (BFD procedure), e.g., TEvaluate_BFD_SSB and/or TEvaluate_BFD_CSI-RS and/or TEvaluate_CBD_SSB or the like.

In an example embodiment, as shown in FIG. 25, the wireless device may determine the evaluation period (e.g., the first evaluation period and/or the second evaluation period) based on/using at least one DRX cycle of the one or more DRX configuration parameters. The wireless device may determine a length of evaluation period based on/using at least one DRX cycle of the one or more DRX configuration parameters. For example, the wireless device may, for determining the length of the evaluation period, determine a length of a DRX cycle (e.g., a DRX cycle length, TDRX) based on/using the at least one DRX cycle of the one or more DRX configuration parameters. For example, the wireless device may determine the length of the evaluation period based on whether the evaluation period is used for the RLM procedure or for beam failure detection and recovery (e.g., radio link recovery) procedure. The wireless device may determine whether the RLM procedure is a relaxed RLM procedure or not. The wireless device may, for example, determine whether the RLM procedure and/or RLR procedure is for an FR1 serving cell or an FR2 serving cell. The indication interval (e.g., for BFD and/or RLM) may be based on Max(TDRX, TRLM-RS,M). TRLM-RS,M may be shortest/smallest/minimum periodicity of the one or more RS resources for the serving cell (e.g., the monitored cell). For example, when an RS resource is SSB, TRLM-RS,M corresponds to a periodicity of the SSB of the one or more RS resources configured for RLM/RLR (e.g., TSSB). In an example, when an RS resource is CSI-RS, TRLM-RS,M corresponds to a periodicity of a CSI-RS resource of the one or more RS resources configured for RLM/RLR (e.g., TCSI-RS). For a deactivation PSCell, TRLM-RS,M may be measCyclePSCell (e.g., a measurement cycle length of a deactivated PSCell). The TDRX may be less than or equal to a first value (e.g., 320 ms for a FR1 serving cell, 80 ms for a FR2 serving cell or a relaxed RLM procedure, or 160 ms). The TDRX may be greater than the first value (e.g., 320 ms for a FR1 serving cell, 80 ms for a FR2 serving cell or a relaxed RLM procedure).

In an example embodiment, as shown in FIG. 25, TDRX may be a maximum/greatest/largest DRX cycle length among/from DRX cycle lengths of (or corresponding to) the at least two DRX cycles of the at least two DRX configurations. For example, TDRX=maximum(TDRX,1, TDRX,2, . . . TDRX,N) where TDRX,i is the DRX cycle length of i-th DRX configuration of the at least two DRX configurations. TDRX,i may be the i-th DRX cycle length of the at least two DRX cycle lengths. Parameter N may be a number of configured DRX configurations (e.g., the at least two DRX configurations) per/of the second DRX operation. For example, parameter N may be a number of DRX cycles per the second DRX operation.

In an example embodiment, as shown in FIG. 25, TDRX may be a minimum/smallest DRX cycle length among/from DRX cycle lengths of (or corresponding to) the at least two DRX cycles of the second DRX operation (e.g., of the at least two DRX configurations), e.g., TDRX=minimum(TDRX,1, TDRX,2, . . . TDRX,N).

In an example embodiment, as shown in FIG. 25, TDRX may correspond to a DRX cycle length of a first DRX configuration of the at least two DRX configurations of the second DRX operation. For example, the first DRX configuration may be a default/designated/configured/dedicated DRX configuration of the at least two DRX configurations of the second DRX operation. In an example embodiment, the base station may, for/corresponding to the one or more evaluation periods (comprising the first evaluation period and/or the second evaluation period), configure (e.g., via the one or more DRX configuration parameters) the default/designated/configured/dedicated DRX configuration. For example, the first DRX configuration may be the default/designated/configured/dedicated DRX configuration for RLM procedure. For example, the first DRX configuration may be the default/designated/configured/dedicated DRX configuration for RLR procedure.

In an example embodiment, as shown in FIG. 25, the first DRX configuration may correspond to the activated DRX configuration of the at least two DRX configurations (of the second DRX operation), e.g., as discussed for embodiments of FIG. 22 and/or FIG. 24. For example, the wireless device may, in response to receiving the activation command (e.g., a DCI and/or a MAC CE and/or an RRC message/signal, e.g., an RRC reconfiguration/setup/release message), activate the first DRX configuration.

In an example, as shown in FIG. 25, the layer 1 (e.g., physical layer) of the wireless device may, to perform the RLM/RLR procedure, send/indicate an indication to (notify/inform) higher layers (e.g., MAC/RRC) of the wireless device. The indication may be at least one of the following: an out-of-sync indication, and/or an in-sync indication, and/or a beam failure instance indication.

Based on the downlink radio link quality on the one or more (e.g., all) RS resources being worse/smaller/lower than the first threshold (e.g., Qout), the layer 1 (e.g., physical layer) of the wireless device may send/indicate/notify/inform (e.g., in a frame where the downlink radio link quality is assessed/determined/estimated) an out-of-sync indication for the serving cell to the higher layers (e.g., MAC/RRC) of the wireless device. The wireless device may apply a first layer 3 filter to the received out-of-sync indication(s) from the layer 1 of the wireless device. In another example, when the downlink radio link quality on all the RS resources in the set q̅₀ one or more RS resources is worse than the first threshold (e.g., Qout_LR), the layer 1 (e.g., physical layer) of the wireless device may send/indicate/notify/inform a beam failure instance indication to (e.g., MAC/RRC) of the wireless device.

Based on the downlink radio link quality on at least one RS resource of the one or more RS resources being better/larger/greater than the second threshold (e.g., Qin), the layer 1 (e.g., physical layer) of the wireless device may send/indicate/notify/inform (e.g., in a frame where the downlink radio link quality is assessed/determined/estimated) an in-sync indication for the serving cell to the higher layers (e.g., MAC/RRC) of the wireless device. The wireless device may apply a second layer 3 filter to the received in-sync indications.

Two successive indications (e.g., two successive out-of-sync indications and/or two successive in-sync indications and/or two successive beam failure instance indications) from the layer 1 of the wireless device to the higher layer of the wireless device (e.g., RRL/MAC layer) may be separated by at least an indication interval/period/window (e.g., TIndication_interval and/or TIndication_interval_BFD and/or TIndication_interval,CCA and/or TIndication_interval,RedCap), e.g., in milliseconds/slots/symbols/subframes. For example, two successive beam failure instance indications from the layer 1 of the wireless device to the higher layers of the wireless device may be separated by at least the indication interval (e.g., TIndication_interval_BFD). In another example, two successive in-sync indications (or out-of-sync indications) from the layer 1 of the wireless device to the higher layers of the wireless device may be separated by at least the indication interval (e.g., TIndication_interval).

For example, the layer 1 of the wireless device may send/indicate a first out-of-sync indication of the two successive out-of-sync indications to the higher layers of the wireless device. The wireless device may wait for the indication interval to send/indicate a second out-of-sync indication of the two successive out-of-sync indications to the higher layers of the wireless device. For example, the wireless device may send/indicate the second out-of-sync indication of the two successive out-of-sync indications to the higher layers of the wireless device after the indication interval from sending/indicating first out-of-sync indication of the two successive out-of-sync indications.

In another example, the layer 1 of the wireless device may send/indicate a first in-sync indication of the two successive in-sync indications to the higher layers of the wireless device. The wireless device may wait for the indication interval to send/indicate a second in-sync indication of the two successive in-sync indications to the higher layers of the wireless device. For example, the wireless device may send/indicate the second in-sync indication of the two successive in-sync indications to the higher layers of the wireless device after the indication interval from sending/indicating first in-sync indication of the two successive in-sync indications.

In another example, the layer 1 of the wireless device may send/indicate a first beam failure instance indication of two successive beam failure instance indications to the higher layers of the wireless device. The wireless device may wait for the indication interval to send/indicate a second beam failure instance indication of the two successive beam failure instance indications to the higher layers of the wireless device. For example, the wireless device may send/indicate the second beam failure instance indication of the two successive beam failure instance indications to the higher layers of the wireless device after the indication interval from sending/indicating first beam failure instance indication of the two successive beam failure instance indications.

In an example embodiment, as shown in FIG. 25, the wireless device may determine a length of the indication interval/period based on the (determined) DRX cycle length, e.g., TDRX or DRX_cycle_length. For example, the wireless device may determine the indication interval/period as a maximum between a shortest periodicity for radio link monitoring resources (e.g., a shortest periodicity of SSB configured for RLM and/or a shortest periodicity of a CSI-RS resource configured for RLM) and a DRX period (e.g., TDRX or DRX_cycle_length). For example, when the TDRX is less than or equal to the first value (e.g., 320 ms), the indication interval (e.g., for BFD and/or RLM) may be Max(10 ms, 1.5×DRX_cycle_length, 1.5×TRLM-RS,M)). When the TDRX is greater than the first value (e.g., 320 ms), the indication interval is equal to the TDRX (or DRX cycle_length). The physical layer (layer 1) in the wireless device may assess/monitor/measure/determine once per indication period/interval the downlink radio link quality (e.g., estimated/evaluated over the evaluation period, e.g., a previous/last evaluation period, e.g., the first evaluation period and/or the second evaluation period) against the first threshold (e.g., Qout) and/or the second threshold (e.g., Qin).

For example, the wireless device may not relax beam failure detection (BFD) measurements and apply a relaxed link recovery procedure provided that the determined DRX cycle length being smaller than a threshold (e.g., 80 ms). The wireless device may determine a timer beamFailureDetectionTimer is running.

When the wireless device transitions/transits/switches between DRX and no DRX or when DRX cycle periodicity changes (e.g., in response to receiving an RRC reconfiguration message), for each RLM-RS resource of the one or more RLM-RS resources (e.g., for out-of-sync evaluation and in-sync evaluation of the monitored cell, e.g., the serving cell), for a duration of time equal to the evaluation period corresponding to the second mode after the transition occurs, the wireless device may use an evaluation period that is no less than the minimum of evaluation period corresponding to the first mode (e.g., corresponding to a mode prior to the transmission occurs) and the second mode. Subsequent to the duration, the wireless device may use an evaluation period corresponding to the second mode for each RLM-RS resource of the one or more RLM-RS resources (e.g., for out-of-sync evaluation and in-sync evaluation of the monitored cell, e.g., the serving cell).

For example, the wireless device may determine a change in a periodicity of XR data burst/PDU Set (e.g., from 45 FPS in a pervious/old configuration/setting/application to a 30 FPS in a new configuration/setting/application or from 60 FPS in a pervious configuration/setting/application to 120 FPS in a new configuration/setting/application, or the like). The wireless device may transmit an UL signal/message to the base station indicating the change in the periodicity of XR data burst. The base station may transmit a DL signal/message to the wireless device indicating a change in a DRX cycle (e.g., from an old/pervious DRX cycle corresponding to the pervious/old configuration/setting/application to a new DRX cycle corresponding to the new configuration/setting/application. In some cases, the previous/old configuration/setting/application may correspond to the first mode and the new configuration/setting/application may correspond to the second mode. The UL signal/message may be a PUCCH or PUSCH. The UL signal/message may be an SR. The UL signal may be an UL MAC CE. The DL signal/message may be a DCI or a DL MAC CE. The DL signal/message may be an RRC reconfiguration message.

When the wireless device transitions/transits/switches from a first configuration of RLM resources to a second configuration of RLM resources (e.g., in response to receiving an RRC reconfiguration message) that is different from the first configuration, for each RLM resource present in the second configuration (e.g., for out-of-sync evaluation and in-sync evaluation of the monitored cell, e.g., the serving cell), for a duration of time equal to the evaluation period corresponding to the second configuration after the transition occurs, the wireless device may use an evaluation period that is no less than the minimum of evaluation periods corresponding to the first configuration and the second configuration (e.g., for out-of-sync evaluation and in-sync evaluation of the monitored cell, e.g., the serving cell). Subsequent to the duration, the wireless device may use an evaluation period corresponding to the second configuration for each RLM resource present in the second configuration (e.g., for out-of-sync evaluation and in-sync evaluation of the monitored cell, e.g., the serving cell).

When the wireless device transitions/transits/switches from a first configuration of active TCI state of the CORESET to a second configuration of active TCI state of the CORESET, for each CSI-RS for RLM present in the second configuration, the wireless device may use an evaluation period corresponding to the second configuration from the time of transition (e.g., for out-of-sync evaluation and in-sync evaluation of the monitored cell, e.g., the serving cell).

Example embodiments may allow the wireless device to properly determine the evaluation period and/or the indication interval, e.g., based on the determined DRX cycle length, for RLM/RLR procedures. Example embodiments may balance consumed power of the wireless device with respect to a performance of the RLM/RLR procedures.

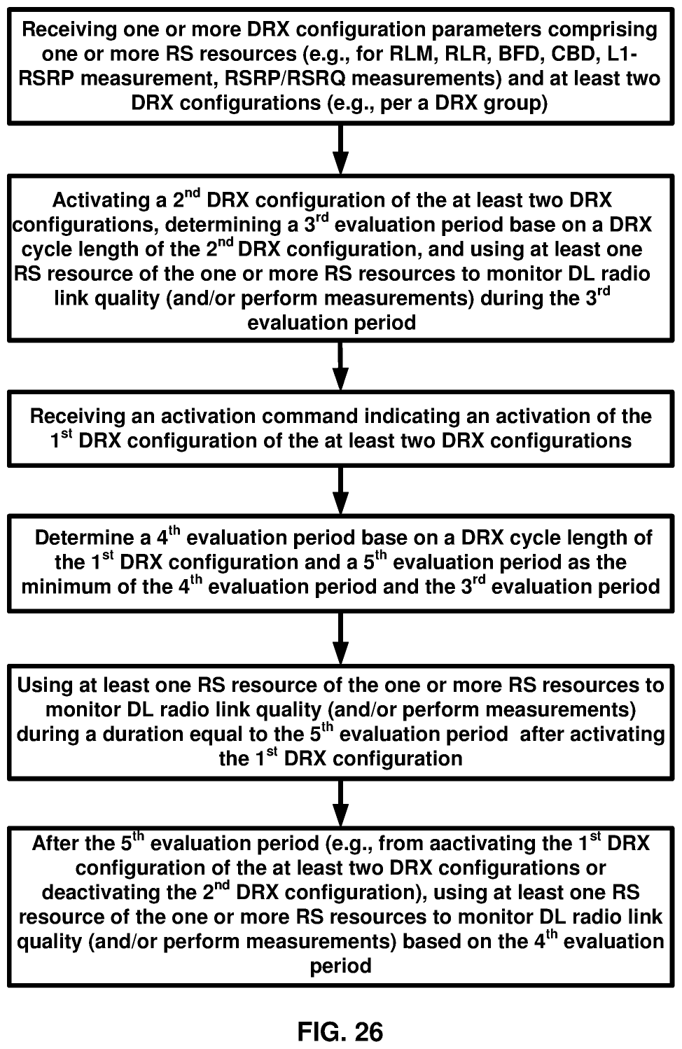

FIG. 26 shows a flowchart of a radio link monitoring/recovery method/procedure during a DRX operation in wireless communication systems per an aspect of the present disclosure. For example, FIG. 26 may show an implementation of an RLM procedure, a BFD procedure and/or a CBD and/or an RLR procedure at/in a wireless device (e.g., an XR device) and/or the base station. In some scenarios, FIG. 26 may show example embodiments for determining an evaluation period for assessing/measuring/monitoring a downlink radio link quality, e.g., when the wireless device is configured with at least two DRX configurations. In some other scenarios, when the wireless device is configured with at least two DRX configurations, FIG. 26 may show example embodiments for determining an indication interval/period for sending/indicating out-of-sync/in-sync/beam failure indications from the physical layer of the wireless device to the higher layers for radio link monitoring/recovery procedure. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

As shown in FIG. 26 and similar to embodiments of FIG. 25, the wireless device may, from the base station, receive the one or more configuration parameters. As shown in FIG. 26, the one or more configuration parameters may comprise the one or more DRX configurations configuring the at least two DRX configurations (e.g., per the DRX group), e.g., the second DRX operation as discussed in FIG. 23 and/or FIG. 24. The one or more configuration parameters may, for example, comprise the one or more radio link monitoring (RLM) configuration parameters.

As shown in FIG. 26, the wireless device may activate a second DRX configuration of the at least two DRX configurations (of the second DRX operation), e.g., per the DRX group. For example, the wireless device may activate the second DRX configuration of the at least two DRX configurations based on/in response to/after receiving the one or more DRX configuration parameters. For example, the second DRX configuration of the at least two DRX configurations may be a default/dedicated/designated/assigned DRX configuration for performing at least one of RLM procedure, BFD procedure, CBD procedure, L1-RSRP measurement, and/or RLR procedure. As shown in FIG. 26, the wireless device may, based on a DRX cycle length (e.g., TDRX) of the second DRX configuration, determine a third evaluation period of the one or more evaluation periods (e.g., TEvaluate_out_SSB and/or TEvaluate_BFD_SSB and/or TEvaluate_CBD_CSI-RS or the like). For example, the wireless device may, to perform RLM procedure, BFD procedure, CBD procedure, L1-RSRP measurement, and/or RLR procedure, estimate/calculate/measure/monitor downlink radio link quality on at least one RS resource of the one or more RS resources within/during the third evaluation period. The wireless device may evaluate/asses/determine (or may be able to evaluate/asses/determine) whether the downlink radio link quality on the at least one RS resource of the one or more RS resources (e.g., estimated over the third evaluation period) becomes worse than the first threshold (e.g., Qout_SSB) within/during the third evaluation period. The wireless device may evaluate/asses/determine (or may be able to evaluate/asses/determine) whether the downlink radio link quality on the at least one RS resource of the one or more RS resources (e.g., estimated over the third evaluation period) becomes better than the second threshold (e.g., Qin_SSB) within/during the third evaluation period. For example, the layer 1 (e.g., physical layer) of/in the wireless device may send/indicate an out-of-sync indication or an in-sync indication or a beam failure indication to the higher layers (e.g., MAC/RRC layers) of the wireless device.

As shown in FIG. 26, the wireless device may receive an activation command (e.g., a DCI and/or a MAC CE and/or an RRC message/signal, e.g., an RRC reconfiguration/setup/release message), e.g., from the base station, indicating activation of the DRX configuration of the at least two DRX configurations. For example, the wireless device may, in response to receiving the activation command, activate the first DRX configuration.

The wireless device may transition/transits/switches from the second DRX configuration of the at least two DRX configurations (e.g., a first mode/state) to the first DRX configuration of the at least two DRX configurations (e.g., a second mode/state), e.g., in response to/after/based on receiving the activation command. In an example, prior to the receiving the activation command (e.g., the first mode/state), the active DRX configuration may be the second DRX configuration of the at least two DRX configurations.

The wireless device may, based on the activation command, apply the activation command, e.g., activate the first DRX configuration of the at least two DRX configurations and deactivate the second DRX configuration of the at least two DRX configurations. For example, the wireless device may apply the activation command at least a third offset from receiving the activation command or from a transmitting a positive acknowledgement (e.g., a HARQ-ACK with positive acknowledgement). The third offset may be based on the MAC layer processing delay (e.g., 3 ms or 3 subframes) and/or a subcarrier spacing of a PUCCH transmission (comprising the positive acknowledgement), e.g., 3Nₛₗₒₜ^{subframe,μ}+1.

As shown in FIG. 26, the wireless device may determine a fourth evaluation period of the one or more evaluation periods (e.g., TEvaluate_out_SSB and/or TEvaluate_BFD_SSB and/or TEvaluate_CBD_CSI-RS or the like) corresponding to the second mode, e.g., based on a DRX cycle length of the first DRX configuration.

In an example embodiment, for the at least one (or each) RS resource of the one or more RS resources, for a duration of time (e.g., a transition/switching period/window/duration), the wireless device may use a fifth evaluation period of the one or more evaluation periods (e.g., TEvaluate_out_SSB and/or TEvaluate_BFD_SSB and/or TEvaluate_CBD_CSI-RS or the like) for performing at least one of the following: RLM procedure, BFD procedure, CBD procedure, L1-RSRP measurement, and/or RLR procedure. For example, the transition period may be equal to the fourth evaluation period. In another example, the transition period may be based on the third offset, e.g., the transition period may be larger than the third offset. In an example, the fifth evaluation period may be no less (or greater) than a minimum of the third evaluation period (e.g., corresponding to the first mode) and the fourth evaluation period (e.g., corresponding the second mode). In some aspects, the transition period may start from an application occasion of the activation command (e.g., 3Nₛₗₒₜ^{subframe,μ}+1 after a slot n of the PUCCH transmission). The transition period may expire/end the fifth evaluation period from the application occasion of the activation command. In some other aspects, the transition period may account for transitioning from the second DRX configuration to the first DRX configuration.

For example, the wireless device may, during the fifth evaluation period after the activation of the first DRX configuration, perform/determine both out-of-sync evaluation and in-sync evaluation of the serving cell (e.g., the monitored cell). The wireless device may, during the transition period and using the fifth evaluation period, perform/determine both out-of-sync evaluation and in-sync evaluation of the serving cell (e.g., the monitored cell). For example, the wireless device may estimate/calculate/measure/monitor downlink radio link quality on at least one RS resource of the one or more RS resources within/during the fifth evaluation period. The wireless device may evaluate/asses/determine (or may be able to evaluate/asses/determine) whether the downlink radio link quality on the at least one RS resource of the one or more RS resources (e.g., estimated over the third evaluation period) becomes worse than the first threshold (e.g., Qout_SSB) within/during the fifth evaluation period. The wireless device may evaluate/asses/determine (or may be able to evaluate/asses/determine) whether the downlink radio link quality on the at least one RS resource of the one or more RS resources (e.g., estimated over the fifth evaluation period) becomes better than the second threshold (e.g., Qin_SSB) within/during the fifth evaluation period. For example, the layer 1 (e.g., physical layer) of/in the wireless device may, during the transition period, send/indicate an out-of-sync indication or an in-sync indication or a beam failure indication to the higher layers (e.g., MAC/RRC layers) of the wireless device.

In response to expiry of the transition period/window (e.g., subsequent to the transition period), the wireless device may use the fourth evaluation period corresponding to the second mode for the at least one (or each) RS resource of the one or more RS resources, e.g., to perform at least one of the following: RLM procedure, BFD procedure, CBD procedure, L1-RSRP measurement, and/or RLR procedure. For example, the wireless device may estimate/calculate/measure/monitor downlink radio link quality on at least one RS resource of the one or more RS resources within/during the fourth evaluation period. The wireless device may evaluate/asses/determine (or may be able to evaluate/asses/determine) whether the downlink radio link quality on the at least one RS resource of the one or more RS resources (e.g., estimated over the third evaluation period) becomes worse than the first threshold (e.g., Qout_SSB) within/during the fourth evaluation period. The wireless device may evaluate/asses/determine (or may be able to evaluate/asses/determine) whether the downlink radio link quality on the at least one RS resource of the one or more RS resources (e.g., estimated over the fourth evaluation period) becomes better than the second threshold (e.g., Qin_SSB) within/during the fifth evaluation period. For example, the layer 1 (e.g., physical layer) of/in the wireless device may, after the expiry of the transition period, send/indicate an out-of-sync indication or an in-sync indication or a beam failure indication to the higher layers (e.g., MAC/RRC layers) of the wireless device.

When the wireless device transitions/transits/switches from the second DRX configuration of the DRX group to the first DRX configuration of the DRX group, for each RLM-RS resource of the one or more RLM-RS resources (e.g., for out-of-sync evaluation and in-sync evaluation of the monitored cell, e.g., the serving cell), for a duration of time equal to the fourth evaluation period corresponding to the second mode after the transition occurs (e.g., after activating the first DRX configuration), the wireless device may use the fifth evaluation period that is no less than the minimum of evaluation period corresponding to the first mode (e.g., the third evaluation period) and the second mode (e.g., the fourth evaluation period). Subsequent to the duration, the wireless device may use the fourth evaluation period corresponding to the second mode for each RLM-RS resource of the one or more RLM-RS resources (e.g., for out-of-sync evaluation and in-sync evaluation of the monitored cell, e.g., the serving cell).

Example embodiments may allow the wireless device to properly determine the evaluation period (e.g., to perform RLM procedure, BFD procedure, CBD procedure, L1-RSRP measurement, and/or RLR procedure) when transiting from one DRX configuration of the at least two DRX configurations to another DRX configuration of the at least two DRX configurations (e.g., based on receiving the activation command).

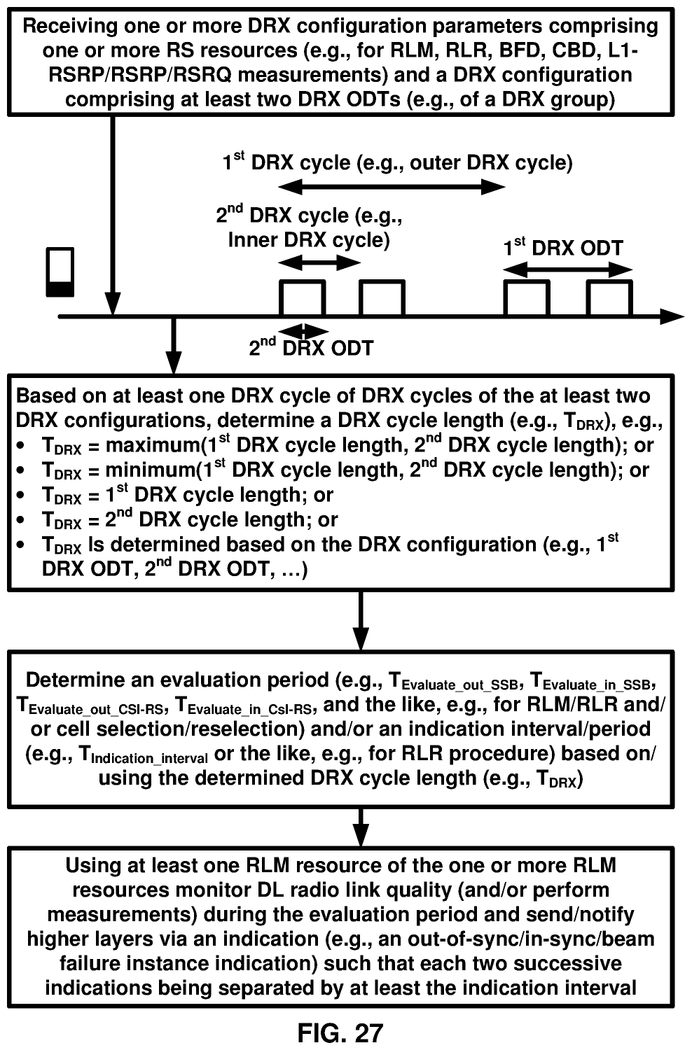

FIG. 27 shows a flowchart of a radio link monitoring/recovery method/procedure during a DRX operation in wireless communication systems per an aspect of the present disclosure. For example, FIG. 27 may show an implementation of a beam failure detection (BFD) procedure and/or candidate beam detection (CBD) and/or a radio link recovery (RLR) procedure at/in a wireless device (e.g., an XR device) and/or the base station. In some scenarios, FIG. 27 may show example embodiments for determining an evaluation period for assessing/measuring/monitoring a downlink radio link quality, e.g., when a DRX configuration comprises two DRX ODTs per a DRX group. In some other scenarios, when a DRX configuration comprises two DRX ODTs per the DRX group, FIG. 27 may show example embodiments for determining an indication interval/period for sending/indicating out-of-sync/in-sync/beam failure indications from the physical layer of the wireless device to the higher layers for radio link monitoring/recovery procedure. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

As shown in FIG. 27, the wireless device may, from the base station, receive the one or more configuration parameters. The one or more configuration parameters may, for example, comprise the one or more serving cell. The one or more configuration parameters may comprise the one or more BWP configuration parameters (e.g., BWP-DownlinkDedicated IE), e.g., of a downlink (DL) BWP (e.g., initial downlink BWP) of a serving cell and/or of an UL BWP of the serving cell. For example, the one or more configuration parameters may comprise the one or more PDCCH configuration parameters (e.g., for PDCCH of the downlink BWP, e.g., in pdcch-Config IE and/or PDCCH-ServingCellConfig IE applicable for all downlink BWPs of the serving cell). As shown in FIG. 27, the one or more configuration parameters may comprise the one or more DRX configurations. For example, the one or more DRX configuration parameters may configure the first DRX configuration (e.g., per the DRX group), e.g., the first DRX operation as discussed in FIG. 21 and/or FIG. 22. As shown in FIG. 27, the first DRX cycle may be an outer DRX cycle of the first DRX operation (or the first DRX configuration). The second DRX cycle may be an inner DRX cycle of the first DRX operation (or the first DRX configuration).

In an example embodiment, as shown in FIG. 27, the wireless device may determine an evaluation period (e.g., the first evaluation period and/or the second evaluation period) based on/using at least the outer DRX cycle and/or the inner DRX cycle of the first DRX operation. The wireless device may determine a length of the evaluation period based on/using the at least the outer DRX cycle and/or the inner DRX cycle of the first DRX operation. For example, the wireless device may, to determining the length of the evaluation period, determine a length of a DRX cycle (e.g., a DRX cycle length, e.g., DRX_cycle_length or TDRX) based on/using the at least the outer DRX cycle and/or the inner DRX cycle. The indication interval (e.g., for BFD and/or RLM) may be based on Max(TDRX, TRLM-RS,M).

In one example, as shown in FIG. 27, TDRX may be a length of the outer DRX cycle of the first DRX configuration (e.g. D1). For example, TDRX may be a maximum/greatest/largest value of D1 and D2, e.g., TDRX=Max(D1, D2).

In another example, as shown in FIG. 27, TDRX may be a length of the inner DRX cycle of the first DRX configuration (e.g., D2). For example, TDRX may be a minimum/smallest value of D1 and D2, e.g., TDRX=Min(D1, D2).

In another example, as shown in FIG. 27, the wireless device may determine the length of the evaluation period based on whether the evaluation period is used for the RLM procedure or for BFD (or the radio link recovery) procedure. For the RLM procedure (or alternatively for the RLR/BFD procedure), TDRX may be D2. In another example, for the RLM procedure (or alternatively for the RLR/BFD procedure), TDRX may be D1. The wireless device may, for example, determine whether the RLM procedure is a relaxed RLM procedure or not (e.g., for the relaxed RLM procedure, TDRX may be D2 and for the RLM procedure TDRX may be D1). The wireless device may, for example, determine whether the RLM procedure and/or BFD procedure is for an FR1 serving cell or an FR2 serving cell. For the FR1 serving cell (or alternatively for the FR2 serving cell), TDRX may be D1.

In some implementations, the wireless device may, to determine the length of the evaluation period, consider at least one of the following: the length of the first DRX ODT of the at least two DRX ODTs (e.g., L1); and/or the length of the second DRX ODT of the at least two DRX ODTs (e.g., L2); and/or the length of the outer DRX cycle of the at least two DRX cycles (e.g., D1); and/or the length of the inner DRX cycle of the at least two DRX cycles (e.g., D2). For example, L1/L2 may be smaller (or alternatively greater) than a pre-configured (e.g., by the one or more configuration parameters) first threshold. For example, L1/D2 may be greater (or alternatively smaller) than a pre-configured (e.g., by the one or more configuration parameters) second threshold. In another example, D1/D2 may be smaller (or alternatively greater) than a pre-configured (e.g., by the one or more configuration parameters) third threshold. In some implementations, L1/D1 may be larger (or alternatively smaller) than a pre-configured (e.g., by the one or more configuration parameters) fourth threshold. In some implementations, L1 (or L2) may be larger (or alternatively smaller) than a pre-configured (e.g., by the one or more configuration parameters) fifth threshold. In some other implementations, D1 (or D2) may be larger (or alternatively smaller) than a pre-configured (e.g., by the one or more configuration parameters) sixth threshold. Although several examples are provided here, other similar examples based on different combinations of L1, L2, D1, and D2 (and/or other DRX parameters) may be applicable.

As shown in FIG. 27, similar to embodiments of FIG. 25, based on the evaluation period, the wireless device may monitor the downlink radio link quality on an RS resource, e.g., the one or more (or all) RS resources, within/during the evaluation period, e.g., against the first threshold (e.g., Qout and/or Qout_LR) and/or the second threshold (e.g., Qin and/or Qin_LR). In an example embodiment, as shown in FIG. 27 and similar to embodiments of FIG. 25, the wireless device may determine a length of the indication interval/period based on the (determined) DRX cycle length, e.g., TDRX or DRX_cycle_length.

Example embodiments may allow the wireless device to properly determine the evaluation period and/or the indication interval, e.g., based on the determined DRX cycle length, for RLM/RLR procedures. Example embodiments may balance consumed power of the wireless device with respect to a performance of the RLM/RLR procedures.

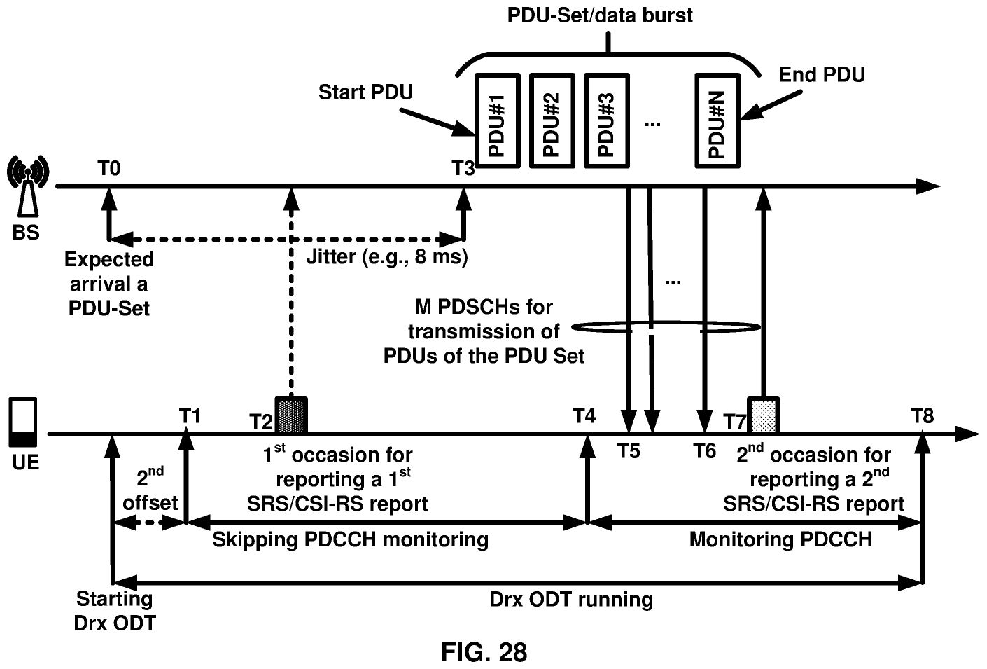

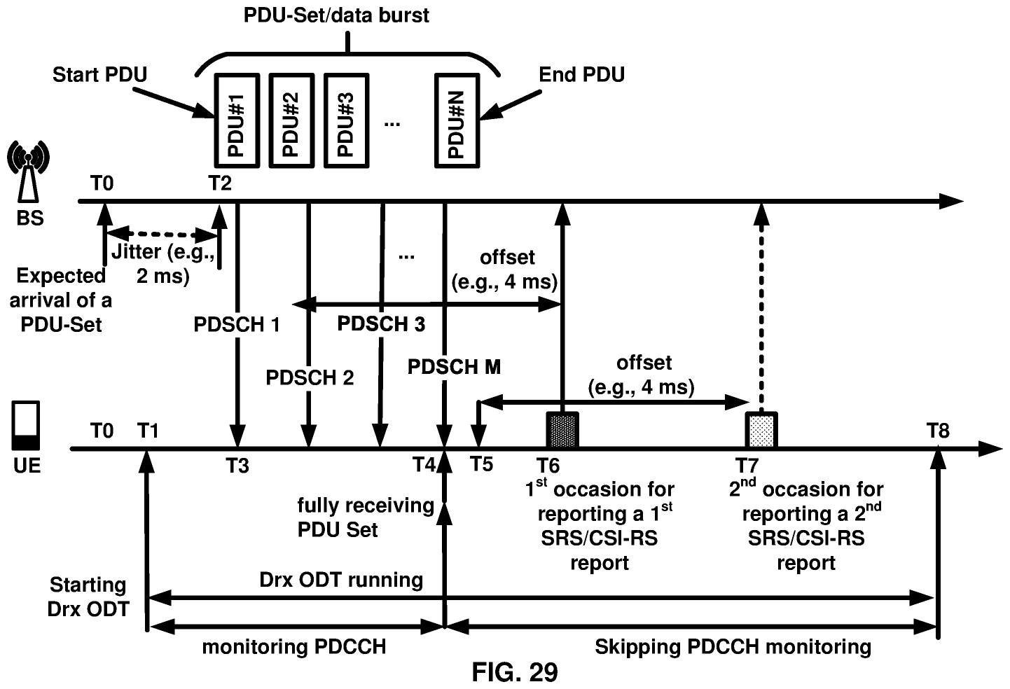

FIG. 28 shows an example embodiment of a DRX operation in wireless communication systems per an aspect of the present disclosure. FIG. 29 shows an example embodiment of a DRX operation in wireless communication systems per an aspect of the present disclosure. For example, FIG. 28 and FIG. 29 may show implementations of the method/procedure for/at/in a wireless device (e.g., an XR device) and/or the base station. In some scenarios, FIG. 28 and FIG. 29 may show example embodiments for determining whether to transmit the report during a DRX active time of the DRX configuration, e.g., when the wireless device skips PDCCH monitoring for a skipping duration within the DRX active time. For example, the wireless device may be in an RRC inactive state/mode (e.g., an RRC_INACTIVE/IDLE state), and/or an RRC idle mode/state (e.g., an RRC_IDLE state), and/or an RRC connected state/mode (e.g., an RRC_CONNECTED state).

The wireless device may, from the base station, receive the one or more configuration parameters (e.g., the one or more RRC configuration parameters). The one or more configuration parameters may, for example, comprise the one or more serving cell (e.g., the one or more Serving Cells or the one or more cells) configuration parameters (e.g., ServingCellConfigCommon, ServingCellConfigCommonSIB, and/or ServingCellConfig) for configuring the one or more cells (e.g., one or more serving cells, e.g., the one or more Serving Cells). The one or more configuration parameters may comprise the one or more DRX configuration parameters configuring (at least) a DRX configuration, e.g., per a DRX group. In an example, the one or more configuration parameters may indicate/comprise configurations for transmitting/sending the report. The one or more configuration parameters may, for example, indicate the at least one occasion/resource for transmission of the report.

The one or more configuration parameters (e.g., the one or more RRC configuration parameters) may comprise the one or more BWP configuration parameters (e.g., BWP-DownlinkDedicated IE), e.g., of a downlink (DL) BWP (e.g., initial downlink BWP) of a serving cell and/or of an UL BWP of the serving cell. The one or more WBP configuration parameters (e.g., of the downlink BWP) may comprise: one or more PDCCH configuration parameters (e.g., for PDCCH of the downlink BWP, e.g., in pdcch-Config IE and/or PDCCH-ServingCellConfig IE applicable for all downlink BWPs of the serving cell), and one or more other parameters.

The one or more PDCCH configuration parameters may comprise a set of skipping durations (e.g., by PDCCHSkippingDurationList) for PDCCH skipping. The set of skipping durations (or skipping windows) may comprise at least one skipping duration (e.g., the first skipping duration). The PDCCHSkippingDurationList may indicate one or more skipping values (e.g., 2 skipping values or 3 skipping values or the like) corresponding to the set of skipping durations in unit of slots (or symbols/slots/subframes or ms). For the 15 kHz SCS, for each value of the one or more skipping values, only a first 26 skipping values may be valid (or applicable/allowable), e.g., corresponding to {1, 2, 3, . . . , 20, 30, 40, 50, 60, 80, 100} slots (or symbols or ms). For the 30 KHz SCS, for each value of the one or more skipping values, only a first 46 skipping values may be valid (or applicable/allowable), e.g., corresponding to {1, 2, 3, . . . , 40, 60, 80, 100, 120, 160, 200} slots (or symbols or ms). For the 60 kHz SCS, for each value of the one or more skipping values, only the first 86 skipping values may be valid (or applicable/allowable), e.g., corresponding to {1, 2, 3, . . . , 80, 120, 160, 200, 240, 320, 400}. For the 120 KHz SCS, for each value of the one or more skipping values, the 166 skipping values correspond to {1, 2, 3, . . . , 160, 240, 320, 400, 480, 640, 800} slots (or symbols or ms). For the 480 kHz SCS, for each value of the one or more skipping values, the 166 skipping values correspond to {4, 8, 12, . . . , 640, 960, 1280, 1600, 1920, 2560, 3200}. For the 960 kHz SCS, for each value of the one or more skipping values, the 166 values correspond to {8, 16, 24, . . . , 1280, 1920, 2560, 3200, 3840, 5120, 6400} slots (or symbols or ms).

As shown in FIG. 28 and FIG. 29, arrival of the XR data/traffic (e.g., the PDU Set), e.g., during a XR traffic/data period or a DRX cycle, at the base station may be late, e.g., due to large jitter (e.g., 8 ms in FIG. 28 or 2 ms in FIG. 29). For example, the PDU Set may arrive at the base station at time/occasion T3 instead of T0 (e.g., expected data arrival occasion/time of the PDU Set). Similar to embodiments of FIG. 19, the wireless device may start the DRX ODT of the first DRX configuration (e.g., of the DRX operation), e.g., based on the expected data arrival occasion/time of the PDU Set, e.g., at time T0 in FIG. 28 or at time/occasion T1 in FIG. 29. For example, the wireless device may, e.g., at/in/on the starting occasion of the DRX ODT, start the DRX ODT of the DRX configuration at time/occasion T0 (e.g., after the expected data arrival occasion/time of the PDU Set). The wireless device may set/initialize the DRX ODT based on/using the first value and start the DRX ODT at the determined starting occasion/time (e.g., T0 in FIG. 28). In the example shown in FIG. 28, during the DRX ODT is running (e.g., between time/occasion T0 and the time/occasion T1), the wireless device may not receive a PDU of the PDU Set. For example, the wireless device may determine (e.g., similar to embodiment of FIG. 19) no PDU of the PDU Set being received during/within a duration with a length of a second offset from the starting of the DRX ODT. Based on at least one PDU of the PDU Set being received during/within a duration with a length of a second offset from the starting of the DRX ODT, the wireless device may not terminate the PDCCH monitoring while the DRX ODT is running (e.g., the wireless device may not start skipping/avoiding the PDCCH monitoring from the time/occasion T1 in FIG. 28).

As shown in FIG. 28, the wireless device may, after starting the DRX ODT (e.g., at time T0 in FIG. 28), start skipping/avoiding the PDCCH monitoring (on the DL active BWP of the serving cell), e.g., for a first skipping duration, at time/occasion T1 in FIG. 28. In one example, in response to starting the DRX ODT of the DRX configuration, the wireless device may (implicitly) start skip the PDCCH monitoring on the DL (active) BWP, e.g., of the serving cell or a set of serving cells of the one or more serving cells, e.g., after the second offset (e.g., a difference between T1 and T0 in FIG. 28). The wireless device may start skipping the PDCCH monitoring at a beginning/starting (or a first/initial/earliest symbol) of a first/earliest/starting/initial slot that is the second offset after the starting the DRX ODT.

For example, the base station may configure the wireless device (e.g., via the one or more configuration parameters) with a parameter and/or the second offset. For example, the parameter may be set with value true (or being enabled/configured). In some examples, based on not receiving DL data (e.g., a PDU of the PDU Set) during the second offset from the starting the DRX ODT, the wireless device may start skipping the PDCCH monitoring (e.g., during the first skipping duration). Based on the parameter being absent in the one or more configuration parameters (or not being configured or being disabled), the wireless device may not terminate the PDCCH monitoring (e.g., may not start the PDCCH skipping) after the second offset from the starting the DRX ODT of the DRX configuration. For example, the wireless device may monitor PDCCH based on/in response to starting the DRX ODT.

The base station may configure the parameter and/or the first offset to properly deal with a (long) jitter, e.g., 8 ms in FIG. 28, (e.g., uncertainty in arriving of the PDU Set at the base station). For example, the consumed power of the wireless device for monitoring the PDCCH during the first skipping duration may be reduced.

In an example, the wireless device may, after starting the DRX ODT (e.g., at time T1 in FIG. 28), receive (e.g., from the base station on a DL (active) BWP of the serving cell) a DCI. For example, the wireless device may, during/within a duration with a length of a second offset from the starting of the DRX ODT, receive the DCI. For example, T1 in FIG. 28 may indicate a last/final/ending/latest symbol of a PDCCH reception (e.g., comprising repetition) time/occasion/resource carrying/with the first DCI. The DCI may indicate skipping PDCCH (e.g., skipping/stopping/avoiding/aborting/cancelling monitoring PDCCH or skipping/stopping/avoiding/aborting/cancelling monitoring control channels, and/or skipping/stopping/avoiding/aborting/cancelling monitoring PDCCH candidates), e.g., within/during/for the first skipping window/duration (e.g., Tskip slots/symbols/milliseconds), e.g., on the DL BWP of the serving cell. In some examples, a time value for (or a length of) the first skipping window may be indicated by the DCI. For example, the DCI may comprise a first filed with a plurality of bits (e.g., with a bit-width of 0, 1, or 2 bits, or greater than 2 bits). The first field may be a PDCCH skipping indication field (e.g., a ‘PDCCH monitoring adaptation indication’ field). The first filed may be a PDCCH skipping/stopping/aborting/avoiding/cancelling filed. The first field may be a SSSG switching field. A codepoint of the PDCCH skipping indication field may indicate a number of slots for the wireless device to skip monitoring the PDCCH (e.g., the length of the first skipping duration). The wireless device may determine the first skipping duration (or the time value) from the ‘PDCCH monitoring adaptation indication’ field of the DCI and/or the one or more configuration parameters (e.g., PDCCHSkippingDurationList). For example, the serving cell may be a SpCell.

In some cases (e.g., when searchSpaceGroupIdList-r17 is not configured by the one or more PDCCH configuration parameters), the set of skipping durations may have cardinality of one (e.g., PDCCHSkippingDurationList may indicate one skipping value). The bit-width of the PDCCH skipping indication field of the DCI may be 1 bit. The wireless device may determine the first skipping duration (e.g., Tskip slots/symbols/milliseconds) being equal to the one skipping value indicated by the PDCCHSkippingDurationList. For example, the set of skipping durations may have cardinality of larger than one (e.g., PDCCHSkippingDurationList may indicate more than one skipping values). The bit-width of the PDCCH skipping indication field of the DCI may be 2 bits. The wireless device may determine the first skipping duration (e.g., Tskip slots/symbols/milliseconds) based on the field value of the PDCCH skipping indication field of the DCI, e.g., by selecting one skipping value from the more than one skipping value indicated by the PDCCHSkippingDurationList.

In some other cases (e.g., when searchSpaceGroupIdList-r17 is configured by the one or more PDCCH configuration parameters), the bit-width of the PDCCH skipping indication field of the DCI may be 2 bits. A ‘10’ value for the bits of the PDCCH skipping indication field of the DCI may indicate skipping the PDCCH monitoring for the first skipping duration provided/indicated by a first skipping value in the set of skipping durations (e.g., initial/starting time duration of the at least one time duration). A ‘11’ value for the bits of the PDCCH skipping indication field of the DCI may indicate skipping the PDCCH monitoring for the first skipping duration provided/indicated by a second skipping value in the set of skipping durations.

In some implementations, the DCI may not schedule/indicate transmission of UL/DL data (e.g., TBs and/or MAC PDUs), e.g., the DCI may be a non-scheduling DCI (e.g., not scheduling transmission of UL/DL data and/or scheduling transmission of dummy data). The DCI may have a DCI format 0_1 and a DCI format 0_2 (e.g., scheduling PUSCH transmissions) or may have a DCI format 1_1 and a DCI format 1_2 (scheduling PDSCH receptions).

In response to/based on/after receiving the DCI, the wireless device may stop/skip/avoid monitoring PDCCH (candidates) on the DL (active) BWP, e.g., of the serving cell or a set of serving cells of the one or more serving cells. For example, in response to the receiving the DCI, the wireless device may start skipping of PDCCH monitoring (e.g., stop/skip/avoid monitoring the PDCCH) at a beginning/starting (or a first/initial/earliest symbol) of a first/earliest/starting/initial slot that is after the reception time/occasion of a PDCCH carrying/with the DCI.

During the first skipping duration (or when a timer associated with the first skipping duration is running), as shown in FIG. 28, the base station may not transmit PDCCH (e.g., for scheduling DL/UL data, e.g., a PDU of the PDU Set) to the wireless device. For example, the base station may wait for an expiry of the first skipping duration (e.g., at time/occasion T4 in FIG. 28) to start transmitting the PDU Set to the wireless device. As shown in FIG. 28, the wireless device may receive the PDU Set via/using the M PDSCHs (e.g., between time/occasion T5 to time/occasion T6). For example, in response to the expiry of the first skipping duration and while the DRX ODT is running (e.g., between time/occasion T4 to time/occasion T8), the wireless device may monitor the PDCCH (e.g., on the DL active BWP of the serving cell) to receive the PDU Set.

As shown in FIG. 29, due to jitter (e.g., 2 ms) the PDU Set may arrive at the base station at time/occasion T2 instead of T0 (e.g., expected data arrival occasion/time of the PDU Set). In some other cases (not shown in FIG. 29), the PDU Set may arrive at time T0 (as expected by the base station). For example, the PDU Set may receive with a jitter smaller than 2 ms or larger than 2 ms. The wireless device may start the DRX ODT of the DRX configuration (e.g., of the DRX operation), e.g., based on the expected data arrival occasion/time of the PDU Set, e.g., at time/occasion T1. For example, following the above discussions of FIG. 18 or similar to embodiments of FIG. 28, the wireless device may start the DRX ODT at time/occasion T1 (e.g., after or in/on the expected data arrival occasion/time of the PDU Set). As shown in FIG. 29, the wireless device may start monitoring PDCCH based on/in response to starting the DRX ODT.

In the example shown in FIG. 29, during the DRX ODT is running (e.g., from time/occasion T1 to T8, the wireless device may receive the plurality of PDUs of the PDU Set (e.g., via M PDSCHs). For example, the wireless device may determine that the PDU Set is fully received at time/occasion T4 in FIG. 29. For example, the wireless device may determine the early stopping condition of the DRX ODT being satisfied. In an example embodiment, the wireless device may, based on or after/upon receiving the PDU Set fully, stop/terminate/skip/avoid the PDCCH monitoring (e.g., on the active DL BWP of the serving cell) while the DRX ODT is running. In an example embodiment, based on the early stopping condition of the DRX ODT of the first DRX configuration being satisfied, the wireless device may not stop the DRX ODT. For example, while the DRX ODT is running and in response to the early stopping condition of the DRX ODT of the DRX configuration being satisfied, the wireless device may skip the PDCCH monitoring on the active DL BWP of the serving cell. For example, as shown in FIG. 29, the wireless device may skip the PDCCH monitoring until an expiry of the DRX ODT. In other cases, the wireless device may skip the PDCCH monitoring for the first skipping duration (e.g., a pre-configured duration). For example, a DCI scheduling the End PDU of the PDU Set (e.g., M-th PDSCH) may, via the first field (e.g., a ‘PDCCH monitoring adaptation indication’ field), indicate the first skipping duration. For example, the wireless device may start skipping the PDCCH monitoring at a beginning/starting (or a first/initial/earliest symbol) of a first/earliest/starting/initial slot that is after the reception time/occasion of a PDCCH carrying/with the DCI. In another example, the wireless device may start skipping the PDCCH monitoring at a beginning/starting (or a first/initial/earliest symbol) of a first/earliest/starting/initial slot that is after the reception time/occasion of the M-th PDSCH or the End PDU.

A first occasion/resource of the at least one resource/occasion may correspond to a first (time) duration/symbol/slot (e.g., time/occasion T2 in FIG. 28 or time/occasion T6 in FIG. 29). For example, a second occasion/resource of the at least one resource/occasion may correspond to a second (time) duration/symbol/slot (e.g., time/occasion T7 in FIG. 28 or time/occasion T7 in FIG. 29). The wireless device may, while the DRX ODT is running and during/withing the first skipping duration (e.g., while skipping the PDCCH monitoring on the DL BWP of the serving cell, e.g., during the DRX active time of the DRX operation), determine whether to transmit the report via/using a resource/occasion of the at least one resource/occasion (e.g., the first resource/occasion of the at least one resource/occasion and/or the second resource/occasion of the at least one resource/occasion) or not.

In an example embodiment, based on the (e.g., first/second) occasion/resource of the at least one occasion/resource being within/during the first skipping duration, the wireless device may drop (e.g., refrain from transmitting) the report. For example, the one or more configuration parameters (e.g., the one or more DRX configuration parameters, or the DRX configuration, or the one or more PDCCH configuration parameters) may comprise a parameter. In response to the parameter being configured (or enabled or set with value true), the wireless device may, while the DRX ODT is running and within/during the first skipping duration, drop the report via the occasion/resource of the at least one occasion/resource based on the occasion/resource of the at least one occasion/resource being within/during the first skipping duration. In response to the parameter not being configured (or being disabled or being absent), the wireless device may, while the DRX ODT is running and within/during the first skipping duration, transmit the report via the occasion/resource of the at least one occasion/resource based on (or despite of or regardless of) the occasion/resource of the at least one occasion/resource being within/during the first skipping duration.

In an example embodiment, as shown in FIG. 28, the wireless device may determine to transmit the report via/using the second resource/occasion of the at least one resource/occasion. For example, the wireless device may determine the PDCCH skipping being terminated/stopped until/at least the offset (e.g., until/at least the predefined gap, e.g., until/at least 4 ms) prior to the second resource/occasion of the at least one resource/occasion. For example, the second occasion/resource of the at least one occasion/resource may be at least the offset (e.g., at least 4 ms) after/from an occasion/time/slot that the PDCCH skipping being stopped/terminated. The wireless device may determine the second resource/occasion of the at least one resource/occasion not being within/during the first skipping duration. In an example, the wireless device may determine the DRX ODT of the DRX configuration is running, e.g., the wireless device is in a DRX active time of the DRX operation.

In an example embodiment, as shown in FIG. 28, the wireless device may determine to avoid/skip transmitting (or not transmit or refrain from transmitting) the report via/using the first resource/occasion of the at least one resource/occasion. The wireless device may determine the first resource/occasion of the at least one resource/occasion not being within/during the first skipping duration. For example, the wireless device may determine the PDCCH skipping being started until the offset prior to the first resource/occasion of the at least one resource/occasion. For example, the wireless device may determine the DCI indicating the PDCCH skipping being received until the offset prior to the first resource/occasion of the at least one resource/occasion. In an example, the wireless device may determine the DRX ODT of the DRX configuration is running.

In an example embodiment, as shown in FIG. 29, the wireless device may determine to transmit the report via/using the first resource/occasion of the at least one resource/occasion. For example, the wireless device may determine the PDCCH skipping not being started until/at least the offset (e.g., until/at least the predefined gap, e.g., until/at least 4 ms) prior to the first resource/occasion of the at least one resource/occasion. For example, the first occasion/resource of the at least one occasion/resource may be less than the offset (e.g., less than 4 ms) after/from an occasion/time/slot that the PDCCH skipping being started. The wireless device may determine the first resource/occasion of the at least one resource/occasion being within/during the first skipping duration. In an example, the wireless device may determine the DRX ODT of the DRX configuration is running, e.g., the wireless device is in a DRX active time of the DRX operation.

In an example embodiment, as shown in FIG. 29, the wireless device may determine to avoid/skip transmitting (or not transmit or refrain from transmitting) the report via/using the second resource/occasion of the at least one resource/occasion. The wireless device may determine the second resource/occasion of the at least one resource/occasion being within/during the first skipping duration. For example, the wireless device may determine the PDCCH skipping being started until the offset prior to the second resource/occasion of the at least one resource/occasion. For example, the wireless device may determine the early stopping condition being satisfied until the offset prior to the second resource/occasion of the at least one resource/occasion. In an example, the wireless device may determine the DCI indicating the PDCCH skipping being received until the offset prior to the second resource/occasion of the at least one resource/occasion. In an example, the wireless device may determine the DRX ODT of the DRX configuration is running.

In an example embodiment, the wireless device may transmit to the base station one or more capability messages. The one or more capability messages may indicate/comprise a capability of the wireless device for refusing/avoiding/refraining from transmitting the report during the first skipping duration (while the DRX ODT is running).

Some example embodiments may improve the DRX operation (e.g., by considering the PDCCH skipping during the DRX active time), e.g., for reducing possibility of unnecessarily transmitting the report. Example embodiments may reduce consumed power of the wireless device.

An example method comprising: receiving, by a wireless device, one or more configuration parameters indicating: a value for a discontinuous reception (DRX) on-duration timer; and at least one occasion/resource for transmission of a report; starting the DRX on-duration timer; receiving, while the DRX on-duration timer is running, a packet data unit (PDU) Set/set comprising a plurality of PDUs; and based on the receiving the PDU Set until an offset prior to a first occasion of the at least one occasion, refraining from transmitting the report via the first occasion.

The above-example method further comprising determining, during the DRX on-duration timer is running, the PDU Set being receiving based on at least one of: all PDUs of the plurality of PDUs of the PDU Set being received; an End PDU of the PDU Set being receiving, where the End PDU of the PDU Set is a last/final PDU of the PDU set; an end of data burst indication of the PDU Set being received; or no hybrid automatic repeat request (HARQ) acknowledgement (ACK) with a negative ACK (NACK), corresponding to the PDU Set, being transmitted.

One or more of the above-example methods, where the end of data burst indication of the PDU Set corresponds to the End PDU of the PDU Set.

One or more of the above-example methods, where a higher layer of the wireless device sends the end of data burst indication to a lower layer of the wireless device.

One or more of the above-example methods, where the higher layer of the wireless device is at least one of: a MAC layer; an RLC layer; a PDCP layer; or an SDAP layer.

One or more of the above-example methods, where the lower layer of the wireless device is at least one of: a physical layer; or an MAC layer.

One or more of the above-example methods further comprising receiving a downlink message indicating the end of data burst, where the downlink message: does not schedule a physical uplink shared channel (PUSCH) or physical downlink shared channel (PDSCH); or schedules the End PDU of the PDU Set.

One or more of the above-example methods further comprising determining an early stopping condition of the DRX on-duration timer being satisfied the offset prior to the first occasion of the at least one occasion, where the early stopping condition of the DRX on-duration timer is satisfied based on at least one of: fully receiving the PDU Set; receiving an end of data burst indication; or an expiry of a DRX inactivity timer.

One or more of the above-example methods further comprising in response to the early stopping condition of the DRX on-duration timer being satisfied stopping the DRX on-duration timer.

One or more of the above-example methods further comprising skipping PDCCH monitoring for a PDCCH skipping duration in response to the early stopping condition of the DRX on-duration timer being satisfied.

One or more of the above-example methods, where the one or more configuration parameters configures the wireless device to drop the report via the first occasion of the at least one occasion when the first occasion of the at least one occasion being within the PDCCH skipping duration.

One or more of the above-example methods, further comprising transmitting the report via a second occasion of the at least one occasion based on determining the second occasion of the at least one occasion being within the DRX active time, where when the DRX on-duration timer is running a second PDU Set is partially received until the offset prior to the second occasion of the at least one occasion.

One or more of the above-example methods, where, during the DRX on-duration timer is running, the second PDU Set is partially received based on at least one of: at least one PDU of the second PDU Set not being received; an End PDU of the second PDU Set not being received, where the End PDU of the PDU Set is a last/final PDU of the second PDU set; or an end of data burst indication not being received.

One or more of the above-example methods further comprising in response to the second PDU Set being partially received performing at least one of: restarting the DRX on-duration timer; extending the DRX on-duration timer during a DRX cycle, where the starting of the DRX on-duration timer is at a beginning of the DRX cycle; or starting a second DRX on-duration timer during the DRX cycle.

One or more of the above-example methods further comprising transmitting the report via a third occasion of the at least one occasion based on determining the third occasion of the at least one occasion being within the DRX active time, where when the DRX on-duration timer is running no PDU of a third PDU Set is received until the offset prior to the third occasion of the at least one occasion.

One or more of the above-example methods further comprising in response to not receiving any PDU of the third PDU Set performing at least one of: restarting the DRX on-duration timer; extending the DRX on-duration timer during a DRX cycle, where the starting of the DRX on-duration timer is at a beginning of the DRX cycle; or starting a second DRX on-duration timer during the DRX cycle.

One or more of the above-example methods, where a PDU of the plurality of PDUs is at least one of: a medium access control (MAC) PDU; a radio link control (RLC) PDU; or a packet data convergence protocol (PDCP) PDU.

One or more of the above-example methods, where a PDU of the plurality of PDUs is at least one of: an MAC service data unit (SDU); an RLC SDU; or a PDCP SDU.

One or more of the above-example methods, where a PDU of the plurality of PDUs comprises one or more transport blocks (TBs).

One or more of the above-example methods, where a PDU of the plurality of PDUs is received via one or more PDSCHs.

One or more of the above-example methods, where the offset is based on a pre-defined gap.

One or more of the above-example methods, where the pre-defined gap is 4 milliseconds.

One or more of the above-example methods, where the offset is larger than the pre-defined gap.

One or more of the above-example methods, where when the DRX on-duration timer is running the wireless device is in a DRX active time of a DRX operation.

One or more of the above-example methods, where the report is at least one of: a periodic sounding reference signal (SRS); a semi-persistent SRS; a channel state information (CSI) report on physical uplink control channel (PUCCH); or a semi-persistent CSI report on physical uplink shared channel (PUSCH).

One or more of the above-example methods, further comprising determining the first occasion of the at least one occasion being outside of a DRX active time.

One or more of the above-example methods, where all PDUs of the plurality of PDUs of the PDU Set being received comprises all PDUs of the plurality of PDUs of the PDU Set being correctly/successfully received.

One or more of the above-example methods, where a PDU Set Integrated Indication (PSII) of the PDU Set has a first mode/state, where the first mode/state indicates an application layer of the wireless device needs all PDUs of the plurality of PDUs of the PDU Set to use the PDU Set.

One or more of the above-example methods, where all PDUs of the plurality of PDUs of the PDU Set being received comprises at least one PDU of the plurality of PDUs of the PDU Set not being correctly/successfully received or at least one PDU of the plurality of PDUs of the PDU Set not being received.

One or more of the above-example methods, where a PDU Set Integrated Indication (PSII) of the PDU Set has a second mode/state, where the second mode/state indicates an application layer of the wireless device does not need all PDUs of the plurality of PDUs of the PDU Set to use the PDU Set.

One or more of the above-example methods, further comprising determining a retransmission mode of the PDU Set being disabled.

One or more of the above-example methods, further comprising determining a HARQ retransmission mode of a PDU of the plurality of PDUs of the PDU Set being disabled.

One or more of the above-example methods, further comprising determining a PDU Set delay budget (PSDB) of the PDU Set not being satisfied.

An example method comprising: receiving, by a wireless device, one or more configuration parameters indicating at least one occasion/resource for transmission of a report; determining a first occasion of the at least one occasion being outside of a discontinuous reception (DRX) active time based on receiving a packet data unit (PDU) Set, comprising a plurality of PDUs, until an offset prior to the first occasion of the at least one occasion; and refraining, in response to the determining, from transmitting the report via the first occasion of the at least one occasion.

An example method comprising: receiving, by a wireless device, one or more configuration parameters indicating: a value for a discontinuous reception (DRX) on-duration timer; and at least one occasion/resource for transmission of a report; starting the DRX on-duration timer; determining a first occasion of the at least one occasion being outside of a DRX active time based on receiving, when the DRX on-duration timer is running, a packet data unit (PDU) Set, comprising a plurality of PDUs, until an offset prior to the first occasion of the at least one occasion; and refraining, in response to the determining, from transmitting the report via the first occasion of the at least one occasion.

An example method comprising: receiving, by a wireless device, one or more configuration parameters indicating: a value for a discontinuous reception (DRX) on-duration timer; and at least one occasion/resource for transmission of a report; starting the DRX on-duration timer for receiving a packet data unit (PDU) Set; determining, until an offset prior to a first occasion of the at least one occasion, at least one PDU of the PDU Set not being received; and transmitting, based on the determining, the report via the first occasion of the at least one occasion.

An example method comprising: receiving, by a wireless device, one or more configuration parameters indicating: a value for a discontinuous reception (DRX) on-duration timer; and at least one occasion/resource for transmission of a report; starting the DRX on-duration timer for receiving a packet data unit (PDU) Set; determining, until an offset prior to a first occasion of the at least one occasion, no PDU of the PDU Set not being received; and transmitting, based on the determining, the report via the first occasion of the at least one occasion.

An example method comprising: receiving, by a wireless device, one or more configuration parameters indicating: a value for a discontinuous reception (DRX) on-duration timer; and at least one occasion for transmission of a report; starting the DRX on-duration timer; skipping, during a time duration and while the DRX on-duration timer is running, the PDCCH monitoring; and based on a first occasion of the at least one occasion being during the time duration, refraining from transmitting the report via the first occasion of the at least one occasion.

The above-example method further comprising receiving a downlink control information (DCI) indicating skipping PDCCH monitoring for the time duration, where the skipping the PDCCH monitoring is based on the receiving the DCI.

One or more of the above-example methods further comprising determining the DCI being received until a first offset prior to the first occasion of the at least one occasion.

One or more of the above-example methods, where the DCI does not indicate an uplink grant or a downlink assignment.

One or more of the above-example methods further comprising starting skipping the PDCCH monitoring a second offset after the starting the DRX on-duration timer.

One or more of the above-example methods further comprising determining no packet data unit (PDU) of a PDU Set being receiving during a duration, with a length of the second offset, from the starting the DRX on-duration timer.

One or more of the above-example methods further comprising monitoring the PDCCH during the duration with the length of the second offset.

One or more of the above-example methods further comprising determining a starting occasion of the skipping the PDCCH monitoring being until a first offset prior to the first occasion of the at least one occasion.

One or more of the above-example methods, where the one or more configuration parameters enabled/configure the wireless device to start skipping the PDCCH in response to no PDU of the PDU Set being receiving during the duration from the starting the DRX on-duration timer.

One or more of the above-example methods, where the one or more configuration parameters configure the wireless device to drop the report via the first occasion of the at least one occasion based on the first occasion of the at least one occasion being during a PDCCH skipping duration.

An example method comprising: transmitting, by a base station to a wireless device, one or more configuration parameters indicating: a value for a discontinuous reception (DRX) on-duration timer; and at least one occasion/resource for transmission of a report; determining a first occasion of the at least one occasion being outside of a DRX active time based on transmitting a packet data unit (PDU) Set, comprising a plurality of PDUs, until an offset prior to the first occasion of the at least one occasion, where the first occasion of the at least one occasion is within a duration corresponding to the DRX on-duration timer of the wireless device; and refraining, in response to the determining, from receiving the report via the first occasion of the at least one occasion.

An example method comprising: transmitting, by a base station to a wireless device, one or more configuration parameters indicating: a value for a discontinuous reception (DRX) on-duration timer; and at least one occasion/resource for transmission of a report; starting transmitting a packet data unit (PDU) Set, comprising a plurality of PDUs, to the wireless device; determining, until an offset prior to a first occasion of the at least one occasion, at least one PDU of the PDU Set not being transmitted to the wireless device, where the first occasion of the at least one occasion is within a duration corresponding to the DRX on-duration timer of the wireless device; and receiving, based on the determining, the report via the first occasion of the at least one occasion.

An example method comprising: transmitting, by a base station to a wireless device, one or more configuration parameters indicating: a value for a discontinuous reception (DRX) on-duration timer; and at least one occasion/resource for transmission of a report; determining, until an offset prior to a first occasion of the at least one occasion, no PDU of a PDU Set being transmitted to the wireless device, where the first occasion of the at least one occasion is within a duration corresponding to the DRX on-duration timer of the wireless device; and receiving, based on the determining, the report via the first occasion of the at least one occasion.

An example method comprising: receiving, by a wireless device, one or more configuration parameters indicating one or more power saving occasions for monitoring downlink control channel based on a power saving radio network temporary identifier (RNTI); receiving, during a discontinuous reception (DRX) active time, a packet data unit (PDU) Sct, comprising a plurality of PDUs; determining a first occasion of the one or more power saving occasions being outside of the DRX active time based on the PDU Set being received until an offset prior to the first occasion of one or more power saving occasions; and monitoring, in response to the determining, downlink control channels during at least one occasion of the one or more power saving occasions.

The above-example method further comprising determining the PDU Set being receiving based on at least one of: all PDUs of the plurality of PDUs of the PDU Set being received; an End PDU of the PDU Set being receiving, where the End PDU of the PDU Set is a last/final PDU of the PDU set; or an end of data burst indication being received.

One or more of the above-example methods, where the end of data burst indication corresponds to the End PDU of the PDU Set.

One or more of the above-example methods, where a higher layer of the wireless device sends the end of data burst indication to a lower layer of the wireless device.

One or more of the above-example methods, where the higher layer of the wireless device is at least one of: a MAC layer; an RLC layer; or a PDCP layer.

One or more of the above-example methods, where the lower layer of the wireless device is at least one of: a physical layer; or an MAC layer.

One or more of the above-example methods further comprising receiving a downlink message comprising/indicating/scheduling the End PDU of the PDU Set, where the downlink signal is a downlink control information (DCI) or a MAC control element (CE).

One or more of the above-example methods further comprising determining, the offset prior to the first occasion of the one or more power saving occasions, an early stopping condition of the DRX on-duration timer being satisfied, where the early stopping condition of the DRX on-duration timer is satisfied based on at least one of: receiving the PDU Set; or an expiry of a DRX inactivity timer.

One or more of the above-example methods further comprising in response to the early stopping condition of the DRX on-duration timer being satisfied stopping the DRX on-duration timer.

One or more of the above-example methods, where the at least one occasion of the one or more power saving occasions comprises the first occasion of the one or more power saving occasions.

One or more of the above-example methods, where the first occasion of the one or more power saving occasions not occurring in an activated measurement gap of one or more measurement gaps.

One or more of the above-example methods, where the first occasion of the one or more power saving occasions occurring in a deactivated measurement gap of the one or more measurement gaps.

One or more of the above-example methods, where the one or more configuration parameters configure the one or more measurement gaps.

One or more of the above-example methods further comprising receiving an activation command activating the measurement gap of the one or more measurement gaps.

One or more of the above-example methods further comprising receiving a deactivation command deactivating the measurement gap of the one or more measurement gaps.

One or more of the above-example methods further comprising avoiding monitoring the downlink control channels during the one or more power saving occasions based on determining a start of a last occasion of the one or more power saving occasions being within the DRX active time, where when a DRX on-duration timer is running a second PDU Set is partially received until the offset prior to the start of the last occasion of the one or more power saving occasions.

One or more of the above-example methods, where, during the DRX on-duration timer is running, the second PDU Set is partially received based on at least one of: at least one PDU of the second PDU Set not being received; an End PDU of the second PDU Set not being received, where the End PDU of the PDU Set is a last/final PDU of the PDU set; or an end of data burst indication not being received.

One or more of the above-example methods further comprising in response to the second PDU Set being partially received performing at least one of: restarting the DRX on-duration timer; extending the DRX on-duration timer during a DRX cycle; or starting a second DRX on-duration timer during the DRX cycle.

One or more of the above-example methods further comprising avoiding monitoring the downlink control channels during the one or more power saving occasions based on determining a start of a last occasion of the one or more power saving occasions being within the DRX active time, where when the DRX on-duration timer is running no PDU of a third PDU Set is received until the offset prior to the start of the last occasion of the one or more power saving occasions.

One or more of the above-example methods further comprising in response to not receiving any PDU of the third PDU Set performing at least one of: restarting the DRX on-duration timer; extending the DRX on-duration timer during a DRX cycle; or starting a second DRX on-duration timer during the DRX cycle.

One or more of the above-example methods, where a PDU of the one or more PDUs is at least one of: a medium access control (MAC) PDU; a radio link control (RLC) PDU; or a packet data convergence protocol (PDCP) PDU.

One or more of the above-example methods, where a PDU of the one or more PDUs is at least one of: an MAC service data unit (SDU); an RLC SDU; or a PDCP SDU.

One or more of the above-example methods, where the offset is based on a pre-defined gap.

One or more of the above-example methods, where the pre-defined gap is 4 milliseconds.

One or more of the above-example methods, where the offset is larger than the pre-defined gap.

One or more of the above-example methods, where when the DRX on-duration timer is running the wireless device is in a DRX active time of a DRX operation.

An example method comprising: receiving, by a wireless device, one or more configuration parameters indicating one or more power saving occasions; determining a first occasion of the one or more power saving occasions being outside of a discontinuous reception (DRX) active time based on receiving a packet data unit (PDU) Set, comprising a plurality of PDUs, until an offset prior to the first occasion of one or more power saving occasions; and monitoring, in response to the determining, downlink control channels during at least one occasion of the one or more power saving occasions.

An example method comprising: receiving, by a wireless device, one or more configuration parameters indicating one or more power saving occasions; determining the one or more power saving occasions being in a discontinuous reception (DRX) active time based on partially receiving a packet data unit (PDU) Set, comprising a plurality of PDUs, until an offset prior to a start of a last power saving occasion of one or more power saving occasions; and not monitoring, in response to the determining, downlink control channels during at least one occasion of the one or more power saving occasions.

The above-example method further comprising starting a DRX on-duration timer after a DRX slot offset from a beginning of a subframe, where the subframe is determined based on one or more DRX configuration parameters and a subframe number.

One or more of the above-example methods further comprising determining the one or more power saving occasions being in an activated measurement gap of one or more measurement gaps, where the one or more configuration parameters configure the one or more measurement gaps.

One or more of the above-example methods, further comprising receiving an activation command activating the measurement gap.

An example method comprising: receiving, by a wireless device, one or more configuration parameters indicating: one or more discontinuous reception (DRX) configuration parameters configuring at least two DRX on-duration timers for/per a DRX group; and one or more channel state information (CSI) configuration parameters configuring one or more CSI measurement/transmission occasions; and based on a first CSI measurement/transmission occasion being within a DRX active time, receiving the first CSI measurement/transmission occasion of the one or more CSI measurement/transmission occasions, where the DRX active time is when at least one DRX on-duration timer of the at least two DRX on-duration timers is running.

The above-example method, where the one or more discontinuous reception (DRX) configuration parameters configures a DRX configuration per the DRX group, where a first DRX on-duration timer of the at least two DRX on-duration timers corresponds to a DRX outer on-duration timer of the DRX configuration; and a second DRX on-duration timer of the at least two DRX on-duration timers corresponds to a DRX inner on-duration timer of the DRX configuration.

One or more of the above-example methods further comprising: starting the second DRX on-duration timer of the at least two DRX on-duration timers based on the first DRX on-duration timer of the at least two DRX on-duration timers is running; and monitoring physical downlink control channel (PDCCH) when the first DRX on-duration timer of the at least two DRX on-duration timers is running and the second DRX on-duration timer of the at least two DRX on-duration timers is running.

One or more of the above-example methods, where the DRX active time, of the DRX configuration, is when both the first DRX on-duration timer of the at least two DRX on-duration timers is running and the second DRX on-duration timer of the at least two DRX on-duration timers is running.

One or more of the above-example methods further comprising determining a first parameter being enabled/configured, where the one or more configuration parameters indicate/enable a first parameter.

One or more of the above-example methods, where the DRX active time is when: the first DRX on-duration timer of the at least two DRX on-duration timers is running; or the second DRX on-duration timer of the at least two DRX on-duration timers is running.

One or more of the above-example methods, where the one or more configuration parameters indicate a second parameter indicating whether the DRX active time is when the first the first DRX on-duration timer of the at least two DRX on-duration timers is running or the second DRX on-duration timer of the at least two DRX on-duration timers is running.

One or more of the above-example methods further comprising determining the DRX active time is when the first the first DRX on-duration timer of the at least two DRX on-duration timers is running based on a first condition being satisfied, where the first condition being satisfied based on at least one of: a length of the first DRX on-duration timer of the at least two DRX on-duration timers; a length of the second DRX on-duration timer of the at least two DRX on-duration timers; a first DRX cycle of the DRX configuration, where the first DRX cycle corresponds to an outer DRX cycle and the first DRX on-duration timer starts at a beginning of the first DRX cycle; or a second DRX cycle of the DRX configuration, where the second DRX cycle corresponds to an inner DRX cycle and the second DRX on-duration timer starts at a beginning of the second DRX cycle.

One or more of the above-example methods further comprising determining the second DRX on-duration timer of the at least two DRX on-duration timers is not running.

One or more of the above-example methods, where the one or more discontinuous reception (DRX) configuration parameters configures at least two DRX configurations per the DRX group.

One or more of the above-example methods, where each DRX on-duration timer of the at least two DRX on-duration timers correspond to each DRX configuration of the at least two DRX configurations.

One or more of the above-example methods, where the DRX active time is when all the DRX on-duration timer at least two DRX on-duration timers are running.

One or more of the above-example methods, where the DRX active time is when a DRX on-duration timer at least of a DRX configuration is running, where the DRX configuration is determined based on at least one of: the DRX configuration corresponding to a minimum DRX on-duration timer length; the DRX configuration corresponding to a maximum DRX on-duration timer length; the DRX configuration corresponding to a minimum DRX cycle length; or the DRX configuration corresponding to a maximum DRX cycle length.

One or more of the above-example methods, where the one or more configuration parameters configures the DRX configuration of the at least two DRX configurations is for CSI measurement.

One or more of the above-example methods, where the DRX configuration is an activated DRX configuration.

One or more of the above-example methods further comprising receiving an activation command activating the DRX configuration.

One or more of the above-example methods, where the one or more CSI configuration parameters comprise one or more CSI reference resource (RS) resource for mobility.

One or more of the above-example methods, where the one or more CSI configuration parameters comprise one or more CSI reference resource (RS) resource for radio link monitoring and/or radio link recovery.

One or more of the above-example methods, where a CSI measurement/transmission occasion of the one or more CSI measurement/transmission occasions is at least one of: a first CSI measurement/transmission occasion for channel measurement; or a second CSI measurement/transmission occasion for interference measurement (IM).

One or more of the above-example methods, where a CSI measurement/transmission occasion of the one or more CSI measurement/transmission occasions is a CSI-RS resource or CSI-IM resource.

An example method comprising: receiving, by a wireless device, one or more configuration parameters indicating: one or more discontinuous reception (DRX) configuration parameters configuring at least two DRX on-duration timers for a DRX group; and one or more channel state information (CSI) configuration parameters configuring/indicating one or more CSI measurement occasions/resources; and based on a first CSI measurement occasion of the one or more CSI measurement occasions being within a DRX active time, transmitting a CSI report of the first CSI measurement occasion, where the DRX active time is when at least one DRX on-duration timer of the at least two DRX on-duration timers is running.

The above-example method, where the transmitting the CSI report is via/using a report occasion of at least one report occasion, where the one or more configuration parameters indicate the at least one report occasion.

One or more of the above-example methods further comprising determining the report occasion being in the DRX active time.

One or more of the above-example methods, where the first CSI measurement occasion is a most recent CSI measurement of the one or more CSI measurement occasions.

One or more of the above-example methods further comprising determining the first CSI measurement occasion being no later than a CSI reference resource.

One or more of the above-example methods, where the one or more DRX configuration parameters configures a DRX configuration, where a first DRX on-duration timer of the at least two DRX on-duration timers corresponds to a DRX outer on-duration timer of the DRX configuration; and a second DRX on-duration timer of the at least two DRX on-duration timers corresponds to a DRX inner on-duration timer of the DRX configuration.

One or more of the above-example methods further comprising: starting the second DRX on-duration timer of the at least two DRX on-duration timers based on the first DRX on-duration timer of the at least two DRX on-duration timers is running; and monitoring physical downlink control channel (PDCCH) when the first DRX on-duration timer of the at least two DRX on-duration timers is running and the second DRX on-duration timer of the at least two DRX on-duration timers is running.

One or more of the above-example methods, where the DRX active time, of the DRX configuration, is when both the first DRX on-duration timer of the at least two DRX on-duration timers is running and the second DRX on-duration timer of the at least two DRX on-duration timers is running.

One or more of the above-example methods further comprising determining a first parameter being enabled/configured, where the one or more configuration parameters indicate/enable a first parameter.

One or more of the above-example methods, where the DRX active time is when: the first DRX on-duration timer of the at least two DRX on-duration timers is running; or the second DRX on-duration timer of the at least two DRX on-duration timers is running.

One or more of the above-example methods, where the one or more configuration parameters indicate a second parameter indicating whether the DRX active time is when the first the first DRX on-duration timer of the at least two DRX on-duration timers is running or the second DRX on-duration timer of the at least two DRX on-duration timers is running.

One or more of the above-example methods further comprising determining the DRX active time is when the first the first DRX on-duration timer of the at least two DRX on-duration timers is running based on a first condition being satisfied, where the first condition being satisfied based on at least one of: a length of the first DRX on-duration timer of the at least two DRX on-duration timers; a length of the second DRX on-duration timer of the at least two DRX on-duration timers; a first DRX cycle of the DRX configuration, where the first DRX cycle corresponds to an outer DRX cycle and the first DRX on-duration timer starts at a beginning of the first DRX cycle; or a second DRX cycle of the DRX configuration, where the second DRX cycle corresponds to an inner DRX cycle and the second DRX on-duration timer starts at a beginning of the second DRX cycle.

One or more of the above-example methods, where the one or more discontinuous reception (DRX) configuration parameters configures at least two DRX configurations.

One or more of the above-example methods, where each DRX on-duration timer of the at least two DRX on-duration timers correspond to each DRX configuration of the at least two DRX configurations.

One or more of the above-example methods, where the DRX active time is when all the DRX on-duration timer at least two DRX on-duration timers are running.

One or more of the above-example methods, where the DRX active time is when a DRX on-duration timer at least of a DRX configuration is running, where the DRX configuration is determined based on at least one of: the DRX configuration corresponding to a minimum DRX on-duration timer length; the DRX configuration corresponding to a maximum DRX on-duration timer length; the DRX configuration corresponding to a minimum DRX cycle length; or the DRX configuration corresponding to a maximum DRX cycle length.

One or more of the above-example methods, where the one or more configuration parameters configures the DRX configuration of the at least two DRX configurations is for CSI measurement and for the transmission of the CSI report.

One or more of the above-example methods, where the DRX configuration is an activated DRX configuration.

One or more of the above-example methods further comprising receiving an activation command activating the DRX configuration.

One or more of the above-example methods, where the one or more CSI configuration parameters comprise one or more CSI reference resource (RS) resource for mobility.

One or more of the above-example methods, where the one or more CSI configuration parameters comprise one or more CSI reference resource (RS) resource for radio link monitoring/failure.

One or more of the above-example methods, where a CSI measurement/transmission occasion of the one or more CSI measurement/transmission occasions is at least one of: a first CSI measurement/transmission occasion for channel measurement; or a second CSI measurement/transmission occasion for interference measurement.

An example method comprising: receiving, by a wireless device, one or more configuration parameters indicating: one or more discontinuous reception (DRX) configuration parameters configuring at least two DRX on-duration timers for a DRX group; at least one occasion for transmission of a channel state information (CSI) report; and one or more CSI transmission/measurement occasions; receiving a first CSI transmission occasion of the one or more CSI transmission occasions when at least one of the at least two DRX on-duration timers is running; and transmitting/reporting, based on the receiving the first CSI transmission not later than a CSI reference report, the CSI report via/using an occasion of the at least one occasion.

The above-example method further comprising: receiving a second CSI transmission occasion of the one or more CSI transmission occasions when at least one of the at least two DRX on-duration timers is running; and refraining from transmitting/reporting, based on the receiving the second CSI transmission later than the CSI reference report, the CSI report via/using a second occasion of the at least one occasion.

One or more of the above-example methods, further comprising determining the occasion of the at least one occasion being in the DRX active time.

An example method comprising: receiving, by a wireless device, one or more configuration parameters comprising: one or more discontinuous reception (DRX) configuration parameters indicating at least two DRX configurations for/per a DRX group, where each DRX configuration of the at least two DRX configurations indicates a respective DRX cycle; and one or more reference signal (RS) resources for monitoring downlink radio link quality for performing a radio link monitoring procedure and/or a radio link recovery procedure; determining an evaluation period based on at least one DRX cycle of the at least two DRX configurations; and monitoring, within/during the determined evaluation period, downlink radio link quality using at least one RS of the one or more RS resources to determine whether the downlink radio link quality satisfying the threshold.

One or more of the above-example methods further determining the downlink radio link quality satisfying the threshold based on at least one of: the downlink radio link quality being worse than a first threshold, where the first threshold is based on an out-of-sync block error rate; or the downlink radio link quality being better than a second threshold, where the second threshold is based on an in-sync block error rate.

One or more of the above-example methods, where each DRX configuration of the at least two DRX configuration comprises a corresponding DRX cycle.

One or more of the above-example methods, where the evaluation period is based on a minimum/smallest DRX cycle length of the at least two DRX configurations.

One or more of the above-example methods, where the evaluation period is based on a maximum/largest DRX cycle length of the at least two DRX configurations.

One or more of the above-example methods, where the evaluation period is based on a DRX cycle length of a first DRX configuration of the at least two DRX configuration.

One or more of the above-example methods, where the one or more configuration parameters enabled/configure the first DRX configuration of the at least two DRX configuration for the radio link monitoring procedure and/or the radio link recovery procedure.

One or more of the above-example methods, where the first DRX configuration is an activated DRX configuration.

One or more of the above-example methods further comprising receiving an activation command indicating an activation of the first DRX configuration, where the activation command is a medium access control (MAC) control element or a downlink control information (DCI) or a radio resource control (RRC) signaling.

One or more of the above-example methods further comprising determining an indication interval based on the at least one DRX cycle of the at least two DRX configurations.

One or more of the above-example methods further comprising: determining the downlink radio link quality being worse than the first threshold; sending a first out-of-sync indication to a higher layer of the wireless device; and sending a second out-of-sync indication, at least the indication interval after sending the first out-of-sync indication to the higher layer of the wireless device, to the higher layer of the wireless device.

One or more of the above-example methods further comprising: determining the downlink radio link quality being better than the second threshold; sending a first in-sync indication to a higher layer of the wireless device; and sending a second in-sync indication, at least the indication interval after sending the first in-sync indication to the higher layer of the wireless device, to the higher layer of the wireless device.

One or more of the above-example methods further comprising: determining the downlink radio link quality being worse than the first threshold; sending a first beam failure indication to a higher layer of the wireless device; and sending a second beam failure indication, at least the indication interval after sending the first beam failure indication to the higher layer of the wireless device, to the higher layer of the wireless device.

An example method comprising: receiving, by a wireless device, one or more configuration parameters indicating: one or more discontinuous reception (DRX) configuration parameters configuring at least two DRX configurations for a DRX group; and one or more reference signal (RS) resources for monitoring downlink radio link quality for performing a radio link monitoring procedure and/or a radio link recovery procedure; and activating a first DRX configuration of the at least two DRX configurations; monitoring, within/during a first evaluation period, downlink radio link quality using at least one RS of the one or more RS resources, where the first evaluation period is determined based on a first DRX cycle of the first DRX configuration; and receiving an activation command indicating a second DRX configuration of the at least two DRX configurations; determining: a second evaluation period based on a second DRX cycle of the second DRX configuration; and a third evaluation period based on a minimum of the first evaluation period and the second evaluation period; in response to activating the second DRX configuration, monitoring the downlink radio link quality during a duration equal to the third evaluation period; and after the third duration from activating the second DRX configuration, monitoring the downlink radio link quality during the second evaluation period.

Clause 1. A method comprising: receiving, by a wireless device, one or more radio resource control (RRC) configuration parameters indicating: a discontinuous reception (DRX) on-duration timer; and at least one occasion for transmission of a report, wherein the report is at least one of a channel state information (CSI) report or a sounding reference signal (SRS) report; starting the DRX on-duration timer; receiving, while the DRX on-duration timer is running, a packet data unit (PDU) set comprising a plurality of PDUs; and based on the receiving the PDU set before an offset prior to a first occasion of the at least one occasion, dropping transmission of the report via the first occasion.

Clause 2. The method of clause 1, wherein the receiving the PDU set comprises at least one of: all PDUs of the plurality of PDUs of the PDU set are received; an end PDU of the PDU set is received, wherein the end PDU of the PDU set is a last PDU of the plurality of PDUs; an end of data burst indication is received, wherein the data burst indication corresponds to the PDU set; or no hybrid automatic repeat request (HARQ) acknowledgement (ACK) with a negative ACK (NACK) information, corresponding to at least one PDU of the plurality of PDUs, is generated.

Clause 3. The method of clause 2, wherein a higher layer of the wireless device sends the end of data burst indication to a lower layer of the wireless device, wherein the higher layer of the wireless device is at least one of a radio link control (RLC) layer or a packet data convergence protocol (PDCP) layer; and the lower layer of the wireless device is at least one of a physical layer or medium access control (MAC) layer.

Clause 4. The method of clause 1, further comprising: determining, while the DRX on-duration timer is running: at least one PDU of a second PDU set not being received until the offset prior to a second occasion of the at least one occasion; and based on the at least one PDU of the second PDU set not being received until the offset prior to the second occasion, transmitting the report via the second occasion.

Clause 5. The method of clause 1, further comprising: determining, while the DRX on-duration timer is running an end PDU of a second PDU set not being received until the offset prior to a second occasion of the at least one occasion; and based on the end PDU of the second PDU set not being received until the offset prior to the second occasion, transmitting the report via the second occasion.

Clause 6. The method of clause 1, further comprising: determining, while the DRX on-duration timer is running no PDU of a second PDU set not being received until the offset prior to a second occasion of the at least one occasion; and based on no PDU of the second PDU set not being received until the offset prior to the second occasion, transmitting the report via the second occasion.

Clause 7. The method of clause 1, wherein a PDU of the plurality of PDUs is at least one of: a medium access control (MAC) PDU; a radio link control (RLC) PDU; a packet data convergence protocol (PDCP) PDU; an MAC service data unit (SDU); an RLC SDU; or a PDCP SDU.

Clause 8. The method of clause 1, wherein a PDU of the plurality of PDUs: comprises one or more transport blocks (TBs); or is received via one or more physical downlink shared channels (PDSCH)s.

Clause 9. The method of clause 1, wherein the offset is based on a pre-defined gap.

Clause 10. The method of clause 1, wherein the report is at least one of: a periodic sounding reference signal (SRS); a semi-persistent SRS; a channel state information (CSI) report on physical uplink control channel (PUCCH); or a semi-persistent CSI report on physical uplink shared channel (PUSCH). Invention 1-1 (for cont. US-based)

Clause 11. A method comprising: based on receiving a PDU set, comprising a plurality of PDUs, before an offset prior to a first occasion of a report, dropping, by a wireless device, transmission of the report via the first occasion, wherein the report is at least one of a channel state information (CSI) report or a sounding reference signal (SRS) report. Invention 2 (reviewed-not for the US-based)

Clause 12. A method comprising: receiving, by a wireless device, one or more radio resource control (RRC) configuration parameters indicating: at least two DRX configurations for a DRX group, wherein each DRX configuration of the at least two DRX configurations indicates a respective DRX cycle; and one or more reference signal (RS) resources for a radio link monitoring procedure or a radio link recovery procedure; determining an evaluation period based on at least one DRX cycle of the at least two DRX configurations of the DRX group; and assessing, during the determined evaluation period, downlink radio link quality using the one or more RS resources.

Clause 13. The method of clause 12, wherein the at least one DRX cycle of at least two DRX cycles is of the at least two DRX configurations of the DRX group.

Clause 14. The method of clause 13, wherein the evaluation period is based on at least one of: a minimum DRX cycle of the at least two DRX cycles; or a maximum DRX cycle of the at least two DRX cycle.

Clause 15. The method of clause 12, wherein the at least two DRX configurations comprises a first DRX configuration of the DRX group and a second DRX configuration of the DRX group, wherein the first DRX configuration comprises a first DRX cycle and the second DRX configuration comprises a second DRX cycle.

Clause 16. The method of clause 15, wherein the at least one DRX cycle of at least two DRX cycles is: the first DRX cycle; or the second DRX cycle.

Clause 17. The method of clause 15, wherein the at least one DRX cycle of at least two DRX cycles is the first DRX cycle and the second DRX cycle.

Clause 18. The method of clause 15, wherein the determining the evaluation period is based on both the first DRX cycle and the second DRX cycle.

Clause 19. The method of clause 15, wherein the evaluation period is based on the first DRX cycle in response to the one or more configuration parameters indicating the first DRX configuration for determining the evaluation period.

Clause 20. The method of clause 15, wherein the evaluation period is based on the first DRX cycle in response to the first DRX configuration being an active DRX configuration.

Clause 21. The method of clause 18, further comprising receiving an activation command indicating an activation of the first DRX configuration, wherein the activation command is a medium access control (MAC) control element or a downlink control information (DCI) or a radio resource control (RRC) signaling.

Clause 22. The method of clause 12, wherein the assessing the downlink radio link quality comprises at least one of: determining whether the downlink radio link quality satisfying a threshold, wherein the downlink radio link quality satisfies a threshold based on at least one of: the downlink radio link quality being worse than a first threshold, wherein the first threshold is based on an out-of-sync block error rate; or the downlink radio link quality being better than a second threshold, wherein the second threshold is based on an in-sync block error rate; evaluating whether the downlink radio link quality satisfy the threshold; measuring the downlink radio link quality using the one or more RS resources; or monitoring the downlink radio link quality using the one or more RS resources.

Clause 23. The method of clause 20, wherein the evaluation period is an indication period.

Clause 24. The method of clause 20, further comprising: determining the downlink radio link quality being worse than the first threshold; sending a first out-of-sync indication to a higher layer of the wireless device; and sending a second out-of-sync indication, at least the indication period after sending the first out-of-sync indication to the higher layer of the wireless device, to the higher layer of the wireless device.

Clause 25. The method of clause 20, further comprising: determining the downlink radio link quality being better than the second threshold; sending a first in-sync indication to a higher layer of the wireless device; and sending a second in-sync indication, at least the indication period after sending the first in-sync indication to the higher layer of the wireless device, to the higher layer of the wireless device.

Clause 26. The method of clause 20, further comprising: determining the downlink radio link quality being worse than the first threshold; sending a first beam failure indication to a higher layer of the wireless device; and sending a second beam failure indication, at least the indication period after sending the first beam failure indication to the higher layer of the wireless device, to the higher layer of the wireless device.

What is claimed is:

1. An apparatus comprising one or more processors and memory storing instructions that, when executed by the one or more processors, cause the apparatus at least to perform a process comprising:
receiving, by a wireless device, one or more radio resource control (RRC) configuration parameters indicating:
a discontinuous reception (DRX) on-duration timer; and
at least one occasion for transmission of a report, wherein the report is at least one of a channel state information (CSI) report or a sounding reference signal (SRS) report;
starting the DRX on-duration timer;
receiving, while the DRX on-duration timer is running, a packet data unit (PDU) set comprising a plurality of PDUs; and
based on the receiving the PDU set before an offset prior to a first occasion of the at least one occasion, dropping transmission of the report via the first occasion.

2. The apparatus of claim 1, wherein the receiving the PDU set comprises at least one of:
all PDUs of the plurality of PDUs of the PDU set are received;
an end PDU of the PDU set is received, wherein the end PDU of the PDU set is a last PDU of the plurality of PDUs;
an end of data burst indication is received, wherein the data burst indication corresponds to the PDU set; or
no hybrid automatic repeat request (HARQ) acknowledgement (ACK) with a negative ACK (NACK) information, corresponding to at least one PDU of the plurality of PDUs, is generated.

3. The apparatus of claim 2, wherein a higher layer of the wireless device sends the end of data burst indication to a lower layer of the wireless device, wherein
the higher layer of the wireless device is at least one of a radio link control (RLC) layer or a packet data convergence protocol (PDCP) layer; and
the lower layer of the wireless device is at least one of a physical layer or medium access control (MAC) layer.

4. The apparatus of claim 1, the process further comprising:
determining, while the DRX on-duration timer is running:
at least one PDU of a second PDU set not being received until the offset prior to a second occasion of the at least one occasion; and
based on the at least one PDU of the second PDU set not being received until the offset prior to the second occasion, transmitting the report via the second occasion.

5. The apparatus of claim 1, the process further comprising:
determining, while the DRX on-duration timer is running an end PDU of a second PDU set not being received until the offset prior to a second occasion of the at least one occasion; and
based on the end PDU of the second PDU set not being received until the offset prior to the second occasion, transmitting the report via the second occasion.

6. The apparatus of claim 1, the process further comprising:
determining, while the DRX on-duration timer is running no PDU of a second PDU set not being received until the offset prior to a second occasion of the at least one occasion; and
based on no PDU of the second PDU set not being received until the offset prior to the second occasion, transmitting the report via the second occasion.

7. The apparatus of claim 1, wherein a PDU of the plurality of PDUs is at least one of:
a medium access control (MAC) PDU;
a radio link control (RLC) PDU;
a packet data convergence protocol (PDCP) PDU;
an MAC service data unit (SDU);
an RLC SDU; or
a PDCP SDU.

8. The apparatus of claim 1, wherein a PDU of the plurality of PDUs:
comprises one or more transport blocks (TBs); or
is received via one or more physical downlink shared channels (PDSCH)s.

9. The apparatus of claim 1, wherein the offset is based on a pre-defined gap.

10. The apparatus of claim 1, wherein the report is at least one of:
a periodic sounding reference signal (SRS);
a semi-persistent SRS;
a channel state information (CSI) report on physical uplink control channel (PUCCH); or
a semi-persistent CSI report on physical uplink shared channel (PUSCH).

11. An apparatus comprising one or more processors and memory storing instructions that, when executed by the one or more processors, cause the apparatus at least to perform a process comprising:
transmit, to a wireless device, one or more radio resource control (RRC) configuration parameters indicating:
a discontinuous reception (DRX) on-duration timer; and
at least one occasion for transmission of a report, wherein the report is at least one of a channel state information (CSI) report or a sounding reference signal (SRS) report;
starting the DRX on-duration timer;
wherein the wireless device is configured to, based on receiving, while the DRX on-duration timer is running and before an offset prior to a first occasion of the at least one occasion, a packet data unit (PDU) set comprising a plurality of PDUs the receiving the PDU set, drop transmission of the report via the first occasion.

12. A non-transitory computer-readable medium comprising instructions that, when executed by one or more processors of a device, cause the device to perform a process, the process comprising:
receiving, by a wireless device, one or more radio resource control (RRC) configuration parameters indicating:
a discontinuous reception (DRX) on-duration timer; and
at least one occasion for transmission of a report, wherein the report is at least one of a channel state information (CSI) report or a sounding reference signal (SRS) report;
starting the DRX on-duration timer;
receiving, while the DRX on-duration timer is running, a packet data unit (PDU) set comprising a plurality of PDUs; and
based on the receiving the PDU set before an offset prior to a first occasion of the at least one occasion, dropping transmission of the report via the first occasion.

13. The non-transitory computer-readable medium of claim 12, wherein the receiving the PDU set comprises at least one of:
all PDUs of the plurality of PDUs of the PDU set are received;
an end PDU of the PDU set is received, wherein the end PDU of the PDU set is a last PDU of the plurality of PDUs;
an end of data burst indication is received, wherein the data burst indication corresponds to the PDU set; or
no hybrid automatic repeat request (HARQ) acknowledgement (ACK) with a negative ACK (NACK) information, corresponding to at least one PDU of the plurality of PDUs, is generated.

14. The non-transitory computer-readable medium of claim 13, wherein a higher layer of the wireless device sends the end of data burst indication to a lower layer of the wireless device, wherein
the higher layer of the wireless device is at least one of a radio link control (RLC) layer or a packet data convergence protocol (PDCP) layer; and
the lower layer of the wireless device is at least one of a physical layer or medium access control (MAC) layer.

15. The non-transitory computer-readable medium of claim 12, the process further comprising:
determining, while the DRX on-duration timer is running:
at least one PDU of a second PDU set not being received until the offset prior to a second occasion of the at least one occasion; and
based on the at least one PDU of the second PDU set not being received until the offset prior to the second occasion, transmitting the report via the second occasion.

16. The non-transitory computer-readable medium of claim 12, the process further comprising:
determining, while the DRX on-duration timer is running an end PDU of a second PDU set not being received until the offset prior to a second occasion of the at least one occasion; and
based on the end PDU of the second PDU set not being received until the offset prior to the second occasion, transmitting the report via the second occasion.

17. The non-transitory computer-readable medium of claim 12, the process further comprising:
determining, while the DRX on-duration timer is running no PDU of a second PDU set not being received until the offset prior to a second occasion of the at least one occasion; and
based on no PDU of the second PDU set not being received until the offset prior to the second occasion, transmitting the report via the second occasion.

18. The non-transitory computer-readable medium of claim 12, wherein a PDU of the plurality of PDUs is at least one of:
a medium access control (MAC) PDU;
a radio link control (RLC) PDU;
a packet data convergence protocol (PDCP) PDU;
an MAC service data unit (SDU);
an RLC SDU; or
a PDCP SDU.

19. The non-transitory computer-readable medium of claim 12, wherein a PDU of the plurality of PDUs:
comprises one or more transport blocks (TBs); or
is received via one or more physical downlink shared channels (PDSCH)s.

20. The non-transitory computer-readable medium of claim 12, wherein the report is at least one of:
a periodic sounding reference signal (SRS);
a semi-persistent SRS;
a channel state information (CSI) report on physical uplink control channel (PUCCH); or
a semi-persistent CSI report on physical uplink shared channel (PUSCH).
